(19) United States
(12) Patent Application Publication
(10) Pub. No.: US 2024/0378683 A1
(43) Pub. Date: Nov. 14, 2024

(54) A SYSTEM AND METHOD FOR COLLECTING, EVALUATING, AND TRANSFORMING ANIMAL DATA FOR USE AS A DIGITAL CURRENCY OR COLLATERAL TO ACQUIRE CONSIDERATION

(71) Applicant: SPORTS DATA LABS, INC., Royal Oak, MI (US)

(72) Inventors: Mark GORSKI, Royal Oak, MI (US); Vivek KHARE, Cupertino, CA (US); Stanley MIMOTO, Bethel Island, CA (US)

(73) Assignee: SPORTS DATA LABS, INC., Royal Oak, MI (US)

(21) Appl. No.: 18/690,223

(22) PCT Filed: Sep. 12, 2022
(86) PCT No.: PCT/US2022/043220

§ 371 Date: Mar. 7, 2024

Related U.S. Application Data
(60) Provisional application No. 63/331,030, filed on Apr. 14, 2022.
(60) Provisional application No. 63/242,708, filed on Sep. 10, 2021.

(51) Int. Cl. G06Q 50/02; G06Q 20/36; G06Q 30/0241; G06Q 30/06; G06Q 40/03; G06Q 40/04; G06Q 50/18

(52) U.S. Cl. CPC G06Q 50/02; G06Q 20/36; G06Q 30/0241; G06Q 30/06; G06Q 40/03; G06Q 40/04; G06Q 50/18; G06Q 2220/00

(57) ABSTRACT

A system and method for collecting, evaluating, and transforming animal data as a form of digital currency or collateral to acquire other consideration includes a source of animal data. Biological data sensors gather animal data from a targeted individual that is transmitted electronically. An intermediary server gathers at least a portion of the animal data and associated metadata. The intermediary server generates one or more terms for using the at least a portion of animal data as collateral to enable the targeted individual to secure consideration. Upon acceptance of the one or more terms by the targeted individual, the intermediary server provides consideration based upon the assigned monetary value, at least in part, to another computing device in exchange for the collateral, the collateral including the at least a portion of animal data.

### CROSS-REFERENCE TO RELATED APPLICATIONS

This application claims the benefit of U.S. provisional application Ser. No. 63/331,030 filed Apr. 14, 2022 and U.S. provisional application Ser. No. 63/242,708 filed Sep. 10, 2021, the disclosures of which are hereby incorporated in their entirety by reference herein.

### TECHNICAL FIELD

In at least one aspect, the present invention is related to systems and methods for collecting, evaluating, and transforming animal data as a form of digital currency or collateral to acquire other consideration.

In at least another aspect, the present invention is related to systems and methods for data structuring, packaging, and pricing.

### BACKGROUND

The continuing advances in the availability of information over the internet have substantially changed the way that business is conducted. Simultaneous with this information explosion, sensor technology, and in particular, biosensor technology has also progressed. With various types of health data being collected, digital health records featuring health information are being created for individuals through a combination of biological sensor data, medical records, and other related information. While an individual's digital health record can have an associated value, there is no system or method for an individual or groups of individuals to leverage their collected health data as a form of collateral to receive consideration (e.g., a loan), or as a form of digital currency to acquire other consideration (e.g., goods, services).

Accordingly, there is a need for a system and method that collects, evaluates, and attributes a monetary value to animal data in order to be used as collateral by an individual to receive consideration, or as a form of digital currency to acquire other consideration.

### SUMMARY

In at least one aspect, a system for collecting, evaluating, and transforming animal data for use as a digital currency or collateral to acquire consideration is described. The system includes a source of animal data which includes information derived from at least one biological data sensor that gathers animal data from a targeted individual wherein the source of animal data is transmitted electronically. An intermediary server gathers at least a portion of the animal data from the source of animal data such that the animal data has metadata associated thereto. The metadata includes at least one characteristic of the at least one biological data sensor and at least one characteristic of the targeted individual from which the animal data originated. The intermediary server takes one or more actions with the at least a portion of the animal data and the associated metadata, the one or more actions including (1) one or more evaluations, verifications, validations, or a combination thereof, and (2) a transformation of the at least a portion of the animal data and associated metadata, or its one or more derivatives, into a collateral asset. The intermediary server is further configured to gather reference data, the intermediary server utilizing the reference data to create or modify, and assign, one or more monetary values, or modify one or more assigned monetary values, for the collateral asset based upon the one or more evaluations, verifications, validations, or a combination thereof. The intermediary server further generates one or more terms related to (and associated with) the use of the at least a portion of animal data and the associated metadata as a collateral asset to enable the targeted individual to secure consideration, the one or more terms including information derived from, related to, or associated with, either directly or indirectly, the one or more evaluations, verifications, validations, or a combination thereof, and an assigned monetary value selected by the intermediary server for the collateral asset derived from the one or more assigned monetary values, at least in part, associated with the collateral asset. Upon acceptance of the one or more terms by the targeted individual electronically, the intermediary server provides (e.g., sends, distributes, makes available, provides access to) consideration based upon the assigned monetary value for the collateral asset, at least in part, to another computing device (e.g., accessible by the targeted individual or their assignees) in exchange for the collateral asset. In a refinement, the consideration includes at least one of or any combination of: a loan, a physical product, a digital product, a physical asset, a digital asset, a service (or access to a service), other form of currency, or a benefit.

In at least another aspect, a system for collecting, evaluating, and transforming animal data for use as a digital currency or collateral to acquire consideration is described. The system includes a source of animal data which includes information derived from at least one biological data sensor that gathers animal data from a targeted individual wherein the source of animal data is transmitted electronically. An intermediary server gathers at least a portion of the animal data from the source of animal data such that the animal data has metadata associated thereto. The metadata includes at least one characteristic of the at least one biological data sensor and at least one characteristic of the targeted individual from which the animal data originated. The intermediary server is further configured to gather reference data. The intermediary server takes one or more actions with the at least a portion of the animal data and the associated metadata, the one or more actions including one or more evaluations, verifications, validations, or a combination thereof. The intermediary server uses the reference data and information derived from the one or more evaluations, verifications, validations, or a combination thereof, to create or modify, and assign, one or more monetary values, or modify one or more assigned monetary values, for the at least a portion of animal data (e.g., which includes its associated metadata) based upon the one or more evaluations, verifications, validations, or a combination thereof. The intermediary server further generates one or more terms related to the use of the at least a portion of animal data as a form of digital currency or collateral, at least in part, to enable the targeted individual to acquire consideration, the one or more terms including information derived from or related to, either directly or indirectly, the one or more evaluations, verifications, validations, or a combination thereof, the one or more assigned monetary values to the at least a portion of animal data, one or more preferences (e.g., including one or more rights, conditions, permissions, restrictions) related to the use of the animal data created either directly or indirectly from the targeted individual or a data acquirer, one or more terms previously associated with at least a portion of the animal data (e.g., current or future restrictions placed on the use of the at least a portion of animal data or its one or more derivatives based upon previously granted rights, conditions, or restrictions), or combinations thereof. Upon acceptance of the one or more terms electronically by the targeted individual, the intermediary server includes the one or more terms as part of the metadata associated with the animal data and transforms the at least a portion of the animal data and the associated metadata, or its one or more derivatives, into a digital asset (e.g., digital currency asset), the digital asset including the at least a portion of animal data and the associated metadata, or its one or more derivatives (e.g., a summary of the animal data and the associated metadata including the one or more terms comprising the digital asset which represents the legal rights to the animal data based upon the one or more terms). The intermediary server then provides access to the consideration based upon an assigned monetary value derived from the one or more assigned monetary values, at least in part, of the digital asset, at least in part, to another computing device (e.g., accessible by the targeted individual or their assignees) in exchange for the digital asset.

In another aspect, a method for collecting, evaluating, and transforming animal data for use as a digital currency or collateral to receive consideration is described. The method includes a step of electronically transmitting information from a source of animal data and a source of reference data to an intermediary server, the source of animal data including at least one biological data sensor that gathers animal data from a targeted individual. The intermediary server communicates electronically with the source of animal data to gather at least a portion of the animal data such that the animal data has metadata associated thereto. The metadata includes at least one characteristic of the at least one biological data sensor and at least one characteristic of the targeted individual from which the animal data originated. The intermediary server takes one or more actions with the at least a portion of the animal data and the associated metadata. Characteristically, the one or more actions includes one or more evaluations, verifications, validations, or a combination thereof. In a refinement, the one or more actions include one or more steps that transform the at least a portion of the animal data and associated metadata, or its one or more derivatives, into a collateral asset. The intermediary server further communicates with the source of reference data to gather at least a portion of reference data either directly or indirectly related to the gathered animal data and associated metadata. The intermediary server creates or modifies one or more monetary values for the at least a portion of animal data based upon the one or more evaluations, verifications, validations, or a combination thereof, utilizing at least a portion of the reference data. The intermediary server assigns a monetary value derived from the one or more created or modified monetary values to the at least a portion of animal data. The intermediary server generates one or more terms for using the at least a portion of animal data as collateral, at least in part, to enable the targeted individual to secure consideration. The one or more terms include information derived from or related to, either directly or indirectly, the one or more evaluations, verifications, validations, or a combination thereof, and the assigned monetary value to the at least a portion of animal data. In a refinement, the one or more terms are included as part of the metadata associated with the at least a portion of animal data or its one or more derivatives. Lastly, the intermediary server provides consideration based upon the assigned monetary value, at least in part, to another computing device upon acceptance of the one or more terms electronically by the targeted individual via one or more computing devices in exchange for the animal data-based collateral (e.g., the collateral asset, which can include one or more rights to the collateral or related to the collateral). Characteristically, the animal data-based collateral includes the at least a portion of animal data.

In another aspect, a method for collecting, evaluating, and transforming animal data for use as a digital currency or collateral to receive consideration is described. The method includes a step of electronically transmitting information from a source of animal data and a source of reference data to an intermediary server, the source of animal data including at least one biological data sensor that gathers animal data from a targeted individual. The intermediary server communicates electronically with the source of animal data to gather at least a portion of the animal data such that the animal data has metadata associated thereto. The metadata includes at least one characteristic of the at least one biological data sensor and at least one characteristic of the targeted individual from which the animal data originated. The intermediary server takes one or more actions with the at least a portion of the animal data and the associated metadata. Characteristically, the one or more actions includes one or more evaluations, verifications, validations, or a combination thereof. The intermediary server further communicates with the source of reference data to gather at least a portion of reference data either directly or indirectly related to the at least a portion of animal data and associated metadata. The intermediary server creates or modifies one or more monetary values for the at least a portion of animal data (e.g., including its metadata) based upon the one or more evaluations, verifications, validations, or a combination thereof, utilizing the at least a portion of the reference data. The intermediary server assigns a monetary value derived from the one or more created or modified monetary values to the at least a portion of animal data. The intermediary further server generates one or more terms for using the at least a portion of animal data as a form of digital or collateral, at least in part, to enable the targeted individual to acquire consideration. The one or more terms include information derived from or related to, either directly or indirectly, the one or more evaluations, verifications, validations, or a combination thereof, the assigned monetary value associated with the at least a portion of animal data (e.g., including one or more rights granted based upon the assigned monetary value), one or more preferences (e.g., one or more rights, conditions, permissions, restrictions) related to the use of the at least a portion of animal data created (e.g., generated) either directly or indirectly from the targeted individual or a data acquirer, one or more terms previously attached to or associated with the at least a portion of animal data, or combinations thereof. Upon acceptance of the one or more terms electronically by the targeted individual, the intermediary server includes the one or more terms as part of the metadata associated with the at least a portion of animal data and transforms the at least a portion of animal data and the associated metadata, or its one or more derivatives, into a digital asset (e.g., digital currency asset, collateral asset), the digital asset including the at least a portion of animal data and the associated metadata, or its one or more derivatives. Lastly, the intermediary server provides access to the consideration based upon the assigned monetary value to the at least a portion of animal data, at least in part, to another computing device upon acceptance of the one or more terms by the targeted individual in exchange for the digital asset.

The foregoing summaries are illustrative only and are not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1 provides a schematic illustration of a system that (1) collects animal data, (2) provides one or more evaluations, verifications, validations, or a combination thereof, (3) creates or modifies, and assigns, one or more monetary values, or modifies one or more assigned monetary values, for the at least a portion of animal data, (4) generates of the one or more terms, and (5) provides consideration in exchange for the at least a portion of animal data (or one or more rights related to the animal data) which is used as collateral or as a form of digital currency, at least in part, to acquire the consideration.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that can be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described herein, as specific components, parameters, and/or conditions may, of course, vary. Furthermore, the terminology used herein is used only for the purpose of describing particular embodiments of the present invention and is not intended to be limiting in any way.

All features disclosed in the specification, including the claims, abstract, and drawings, and all the steps in any method or process disclosed, may be combined in any combination (including one or more steps or actions taken by any computing device), except combinations where at least some of such features and/or steps are mutually exclusive. For example, in some variations, the intermediary server or another computing device in communication with the intermediary server can transform the animal data and the associated metadata into a collateral asset or digital asset after it creates or modifies and assigns one or more monetary values to the animal data and the associated metadata is transformed into the collateral asset. In other variations, the intermediary server or another computing device in communication with the intermediary server can transform the animal data and the associated metadata into a collateral asset prior to the system creating or modifying and assigning one or more monetary values, with the one or more monetary values being created or modified for the collateral asset based upon the animal data and the associated metadata which comprise the collateral asset. Each feature disclosed in the specification, including the claims, abstract, and drawings, can be replaced by alternative features serving the same, equivalent, or similar purpose, unless expressly stated otherwise. Additionally, the sequential series (e.g., order) in which the one or more steps, methods, or processes occur in the one or more embodiments can be modified depending on the one or more configurations of the system while producing the same or similar output or end result, unless expressly stated otherwise.

It must also be noted that, as used in the specification and the appended claims, the singular form “a,” “an,” and “the” comprise plural referents unless the context clearly indicates otherwise. For example, reference to a component in the singular is intended to comprise a plurality of components.

The phrase “data is” is meant to include both “datum is” and “data are,” as well as all other possible meanings, and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.” In another refinement, “at least one of” means any combination including all of the components indicated.

When a computing device is described as performing an action or method step, it is understood that the one or more computing devices are operable to and/or configured to perform the action or method step typically by executing one or more lines of source code. The actions or method steps can be encoded onto non-transitory memory (e.g., hard drives, optical drive, flash drives, and the like).

The term “derivative” wherein referring to data means that the data is mathematically transformed to produce the derivative as an output. In a refinement, a mathematic function receives the data as input and outputs the derivative as an output.

The term “or its one or more derivatives” can be interchangeable with “and its one or more derivatives” depending on the use case and is not intended to be limiting in any way.

Throughout this application, where publications are referenced, the disclosures of these publications in their entireties are hereby incorporated by reference into this application to more fully describe the state of the art to which this invention pertains.

The term “server” refers to any computer or computing device (including, but not limited to, desktop computer, notebook computer, laptop computer, mainframe, mobile phone, smart watch, smart contact lens, head-mountable unit such as smart-glasses, headsets such as augmented reality headsets, virtual reality headsets, mixed reality headsets, and the like, hearables, augmented reality devices, virtual reality devices, mixed reality devices, and the like), distributed system, blade, gateway, switch, processing device, or a combination thereof adapted to perform the methods and functions set forth herein.

The term “computing device” refers generally to any device that can perform at least one function, including communicating with another computing device. In a refinement, a computing device includes a central processing unit that can execute program steps and memory for storing data and a program code.

When a computing device is described as performing an action or method step, it is understood that the one or more computing devices are operable to or configured to perform the action or method step typically by executing one or more lines of source code. The actions or method steps can be encoded onto non-transitory memory (e.g., hard drives, optical drive, flash drives, and the like).

The term “configured to or operable to” means that the processing circuitry (e.g., a computer or computing device) is configured or adapted to perform one or more of the actions set forth herein, by software configuration and/or hardware configuration. The terms “configured to” and “operable to” can be used interchangeably.

The term “electronic communication” means that an electrical signal is either directly or indirectly sent from an originating electronic device to a receiving electronic device. Indirect electronic communication can involve processing of the electrical signal, including but not limited to, filtering of the signal, amplification of the signal, rectification of the signal, modulation of the signal, attenuation of the signal, adding of the signal with another signal, subtracting the signal from another signal, subtracting another signal from the signal, and the like. Electronic communication can be accomplished with wired components, wirelessly connected components, or a combination thereof.

With respect to electrical devices, the term “connected to” means that the electrical components referred to as connected to are in electrical communication. In a refinement, “connected to” means that the electrical components referred to as connected to are directly wired to each other. In another refinement, “connected to” means that the electrical components communicate wirelessly or by a combination of wired and wirelessly connected components. In another refinement, “connected to” means that one or more additional electrical components are interposed between the electrical components referred to as connected to with an electrical signal from an originating component being processed (e.g., filtered, amplified, modulated, rectified, attenuated, summed, subtracted, etc.) before being received to the component connected thereto.

The processes, methods, or algorithms disclosed herein can be deliverable to or implemented by a computer, controller, or other computing device, which can include any existing programmable electronic control unit or dedicated electronic control unit. Similarly, the processes, methods, or algorithms can be stored as data and instructions executable by a computer, controller, or other computing device in many forms including, but not limited to, information permanently stored on non-writable storage media such as ROM devices and information alterably stored on writeable storage media such as floppy disks, magnetic tapes, CDs, RAM devices, other magnetic and optical media, shared or dedicated cloud computing resources, and the like. The processes, methods, or algorithms can also be implemented in an executable software object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software, and firmware components.

The terms “subject” and “individual” are synonymous, interchangeable, and refer to a human or other animal, including birds, reptiles, amphibians, and fish, as well as all mammals including, but not limited to, primates (particularly higher primates), horses, sheep, dogs, rodents, pigs, cats, rabbits, bulls, and cows. The one or more subjects or individuals can be, for example, humans participating in athletic training or competition, horses racing on a race track, humans playing a video game, humans monitoring their personal health or having their personal health monitored, humans providing their animal data to a third party (e.g., insurance system, health system, animal data-based monetization system), humans participating in a research or clinical study, humans participating in a fitness class, and the like. A subject or individual can also be a derivative of a human or other animal (e.g., lab-generated organism derived at least in part from a human or other animal), one or more individual components, elements, or processes of a human or other animal (e.g., cells, proteins, biological fluids, amino acid sequences, tissues, hairs, limbs) that make up the human or other animal, one or more digital representations that share at least one characteristic with a human or other animal (e.g., data set representing a human that shares at least one characteristic with a human representation in digital form—such as sex, age, biological function as examples—but is not generated from any human that exists in the physical world; a simulated individual or digital individual that is based on, at least in part, a real-world human or other animal, such as a digital representation of an individual or avatar in a virtual environment or simulation such as a video game or metaverse), or one or more artificial creations that share one or more characteristics with a human or other animal (e.g., lab-grown human brain cells that produce an electrical signal similar to that of human brain cells). In a refinement, the subject or individual can be one or more programmable computing devices such as a machine (e.g., robot, autonomous vehicle, mechanical arm) or network of machines that share at least one biological function with a human or other animal and from which one or more types of biological data can be derived, which can be, at least in part, artificial in nature (e.g., data from Artificial Intelligence-derived activity that mimics biological brain activity; biomechanical movement data derived a programmable machine that mimics, at least in part, biomechanical movement of an animal).

The term “animal data” refers to any data obtainable from, or generated directly or indirectly by, a subject that can be transformed into a form that can be transmitted to a server or other computing device. Typically, the animal data is electronically transmitted via a wired or wireless connection, or a combination thereof. Animal data includes, but is not limited to, any subject-derived data, including any signals or readings (e.g., metrics), that can be obtained from one or more sensors (e.g., which can include sensing equipment and/or other sensing systems), and in particular, biological sensors (i.e., biosensors) that capture biological data, as well as its one or more derivatives. Animal data also includes any biological phenomena capable of being captured from a subject and converted to electrical signals that can be captured by one or more sensors, descriptive data related to a subject (e.g., name, age, height, gender, anatomical information), auditory data related to a subject, visually-captured data related to a subject (e.g., image, likeness, video featuring the subject, observable information related to the subject), neurologically-generated data (e.g., brain signals from neurons), evaluative data related to a subject (e.g., skills of a subject), data that can be manually entered or gathered related to a subject (e.g., medical history, social habits, feelings of a subject, mental health data, financial information, subjective data), and the like (e.g., attributes/characteristics of the individual). The term “animal data” can be meant to include one or more types of animal data. It can include animal data in both its raw and/or processed form. In a refinement, the term “animal data” is inclusive of any derivative of animal data, including one or more computed assets, insights, predictive indicators, evaluation assets, collateral assets, digital assets, or artificial data (e.g., simulated animal data in or derived from a virtual environment, video game, or other simulation derived from the digital representation of the subject). In another refinement, animal data includes one or more inputs (e.g., signals, readings, other data) from one or more non-animal data sources. In another refinement, animal data includes one or more attributes related to the subject or the animal data. In another refinement, animal data includes at least a portion of non-animal data that provides contextual information related to the animal data. In another refinement, animal data includes any metadata gathered or associated with the animal data. In another refinement, animal data includes at least a portion of simulated data. In yet another refinement, animal data is inclusive of simulated data.

The term “reference data” is data used as a reference or baseline to classify, categorize, compare, evaluate, analyze, and/or value other data, as well as to derive information from other data. The term “reference data” is inclusive of the term “reference animal data,” which is animal data used as a reference or baseline (e.g., a base for measurement) to classify, categorize, compare, evaluate, analyze, and/or value other animal data, as well as to derive information from other data. In this context, reference data includes other animal data (e.g., which can include one or more sets of animal data) with one or more assigned monetary values or associated monetary information (e.g., associated interest rate information, associated loan repayment information, and the like) based upon one or more characteristics of the data, either individually or collectively, that enable the system to assign one or more monetary values or associated monetary information to, or create/modify one or more monetary values or associated monetary information for, other animal data (e.g., the animal data of the targeted individual or a derivative such a collateral asset or digital asset) based upon previously determined values or associated monetary information. In a refinement, one or more Artificial Intelligence techniques are utilized to create or modify one or more monetary values or associated monetary information for animal data or its one or more derivatives. Reference data can include any available, accessible, or gathered data, including any type of animal data and/or non-animal data (e.g., including any metadata, terms/conditions/permissions associated with the animal data, historical monetary values such as pricing information for any given set or group of animal data, historical predicted pricing information for any given set or group of animal data), either directly or indirectly related to (or derived from) the one or more targeted subjects or events associated with the one or more targeted subjects that enables one or more forecasts, predictions, probabilities, assessments, possibilities, projections, determinations, or recommendations related to one or more outcomes for one or more current or future events or sub-events (e.g., one or more predictions related to future monetary considerations such as predicted pricing information, predicted interest rate information, predicted terms & conditions, predicted loan repayment information, and the like; one or more predictions related to the future health status of an individual which can impact the current value of their data; the likelihood of an individual experiencing a medical episode; and the like) to be calculated, computed, derived, extracted, extrapolated, quantified, simulated, created, modified, assigned, enhanced, estimated, evaluated, inferred, established, determined, converted, deduced, observed, communicated, or actioned upon. Reference data can be gathered from any number of subjects (e.g., one, tens, hundreds, thousands, millions, billions, and the like) and data sources (e.g., it can be gathered from sensors or computing devices, manually inputted, artificially created, derived from one or more actions, and the like). It can be structured (e.g., created, curated) in a way to facilitate one or more evaluations (e.g., comparisons) of (or between) data sets and/or derivatives of data sets. Reference data can also be categorized and associated with one or more profiles (e.g., type of individual, type of biological response; type of risk profile associated with the data) in order to make the datasets searchable and accessible. Reference data also includes any previously collected animal data (e.g., historical animal data), including derivatives from animal data (e.g., including collateral assets or other digital assets that include at least a portion of animal data or represent or are associated with at least a portion of animal data) and previously-collected animal data derived from one or more sensors, as well as created derivatives from animal data. In some variations, it can also include associated contextual data, which can include other animal data, non-animal data (e.g., including non-animal data directly or indirectly related to or associated with the previously-collected animal data), or a combination thereof. In a refinement, reference data includes at least a portion of the previously collected animal data derived from one or more sensors. In another refinement, reference data includes at least a portion of non-animal data (e.g., including non-animal contextual data to provide additional context to the animal data). In some variations, non-animal contextual data for reference animal data can include monetary information associated with the reference animal data. In another refinement, reference animal data is stored, categorized, and accessed by the system with associated contextual data. In another refinement, reference animal data has associated contextual data which comprises, at least in part, the reference animal data. In another refinement, reference data includes at least a portion of simulated animal data (e.g., the system may generate artificial animal data as reference animal data; the system may run one or more simulations, the output of which can be reference animal data; one or more animal data sets may include simulated data; and the like). In another refinement, reference data includes the output of one or more simulations (e.g., predicted monetary information such as predicted predicting information based upon an existing or pre-defined animal data set). In another refinement, reference data includes metadata gathered or associated with the animal data. The metadata associated with the animal data can include sensor type, placement of sensor, body composition of the subject, one or more medical conditions of the subject, health information of or related to the subject, activity (e.g., activity in which the animal data is collected) the subject is engaged in while collecting the animal data, environmental conditions (e.g. if the data was collected in a dangerous condition, rare or desired condition, and the like), quality of data (e.g., a rating or other indices applied to the data, completeness of a data set, noise levels within a data set, whether data is missing), size of the data set (e.g., size of the required data set; size of the data set as to not exceed certain storage thresholds), terms related to the use of the data (e.g., any permissions or restrictions related of the data based upon one or more pre-existing agreements or preferences established by the data owner/administrator or data acquirer), one or more characteristics of the data, monetary information associated with the animal data, and the like. In another refinement, reference data can include previously collected animal data for a targeted individual. In another refinement, reference data can include data that is not derived directly or indirectly from the targeted individual but shares at least one attribute (e.g., characteristic) with the one or more targeted individuals, biological responses (e.g., the activity the subject is undertaking, bodily response or biological phenomenon capable of being converted to electrical signals that can be captured by one or more sensors including a biological state; a medical event such as a heart attack or stroke), or medical conditions. In another refinement, reference data can include identifiable, de-identified (e.g., pseudonymized), semi-anonymous, or anonymous data tagged with metadata (e.g., that has associated metadata) related either directly or indirectly to the targeted individual, one or more biological responses or medical conditions. In another refinement, reference data includes animal data and its associated contextual data categorized to identify one or more biological responses, medical conditions, or health issues. In a variation, reference data can be categorized, or grouped together, to form one or more units of such data. In another refinement, reference data can be dynamically created, modified, or enhanced with one or more additions, changes, or removal of non-functioning data (e.g., data that the system will remove or stop using). In another refinement, at least a portion of the reference data can be weighted based upon one or more characteristics of (or related to) the one or more sensors (e.g., reference animal data from sensors that produce average quality data may have a lower weighted score than reference animal data from sensors that produce high quality data), the one or more individuals or groups of individuals, the metadata (e.g., contextual data) associated with the animal data (e.g., other animal data, non-animal data), or a combination thereof. In another refinement, the system can be operable to conduct one or more data audits on reference data. For example, the system may recall reference data originating from one or more sensors based upon one or more sensor characteristics (e.g., a faulty data gathering functionality within the one or more sensors could cause the system to recall and remove the data from the reference animal data database), or may change the value of reference data (e.g., the monetary value associated with the reference data) based upon new information (e.g., a new disease identified based upon people with certain characteristics, potentially increasing the value of their existing data sets). Reference data also includes one or more biological-based signatures (e.g., unique digital signatures, non-unique digital signatures), identifiers (e.g., non-unique identifiers, unique identifiers), patterns (e.g., any type of pattern including time slice, spatial, spatiotemporal, temporospatial, and the like), rhythms, trends, features, measurements, outliers, abnormalities, anomalies, readings, signals, data sets, characteristics/attributes (e.g., unique characteristics), or a combination thereof, derived from one or more calculations, computations, derivations, extractions, extrapolations, simulations, creations, combinations, modifications, enhancements, estimations, evaluations, inferences, establishments, determinations, conversions, deductions, or observations from (or of) animal data, at least in part, that enable one or more identifications of one or more characteristics related to the quality, completeness, uniqueness, relatedness, usability, and/or value of the animal data. In some variations, such signatures, identifiers, patterns, rhythms, trends, features, measurements, outliers, abnormalities, anomalies, readings, signals, data sets, characteristics/attributes, or a combination thereof, enables identification of an individual based upon their animal data, one or more characteristics associated with the individual, medical conditions, biological responses, or one or more other characteristics related to creating, modifying, or enhancing one or more monetary values for the animal data. In other variations, such signatures, identifiers, patterns, rhythms, trends, features, measurements, outliers, anomalies, or characteristics may include at least a portion of non-animal data, artificial data, or a combination thereof. In another refinement, reference data includes reference valuation data (e.g., pricing data) from one or more sources (e.g., historical values of data sales of any given data set or related data sets or similar assets or asset classes derived from the system; third party sources that have valued similar data, similar attributes related to data, similar assets or similar asset classes; dissimilar data, dissimilar attributes, dissimilar assets, or dissimilar asset classes from which one or more monetary values can be inferred or extracted; and the like). The reference valuation data can be included in one or more models created and/or utilized by the system that establish one or more monetary values for one or more data sets that are acquired by the system in exchange for consideration. In another refinement, reference data can include one or more legal agreements and other language that can be used to generate one or more terms (and in some variations, one or more agreements that enables the exchange of the animal data for consideration). In another refinement, some reference data (e.g., pricing data for animal data) can be modified based on one or more variables, which may be inputted by a user, collected by one or more computing devices based upon any given scenario, or adjusted via one or more Artificial Intelligence techniques. For example, the value of data may change over time (e.g., data be more or less today than in the future), or a user may want to know the value of reference data based upon the changing of the one or more variables. In another refinement, reference data includes any data that enables the one or more evaluations, verifications, or validations to occur with the animal data (e.g., evaluation, verification, or validation of the data or targeted individual; identification of a medical condition or biological response such as a stroke or heart attack based upon the data identification of a future heart attack or future stoke based upon the animal data and the reference data, and the like). In another refinement, reference data can include one or more evaluation assets. In another refinement, the reference animal data includes previously collected animal data that are typically analyzed and characterized. In another refinement, reference data is accessed by the system via one or more digital records directly or indirectly with the one or more targeted individuals, their associated animal data, or a combination thereof. In another refinement, reference data can also include values and other information related to other currencies (including other digital currencies, historical pricing information, predicted or projected pricing information, and the like)

In a refinement, the term “reference animal data” can be synonymous and used interchangeably with the term “reference data,” and a reference to any one of the terms should not be interpreted as limiting but rather as encompassing all possible meanings of all the terms. In another refinement, the term “reference data” includes reference animal data, its associated contextual data, or a combination thereof.

The term “artificial data” refers to artificially-created data that is derived from, based on, or generated using, at least in part, animal data or one or more derivatives thereof. It can be created by running one or more simulations utilizing one or more Artificial Intelligence (“AI”) techniques or statistical models, and can include one or more inputs (e.g., signals, readings, other data) from one or more non-animal data sources. In a refinement, artificial data includes any artificially-created data that shares at least one biological function with a human or another animal (e.g., artificially-created vision data, artificially-created movement data). The term “artificial data” is inclusive of “synthetic data,” which can be any production data applicable to a given situation that is not obtained by direct measurement. Synthetic data can be created by statistically modeling original data and then using the one or more models to generate new data values that reproduce at least one of the original data's statistical properties. In another refinement, the term “artificial data” is inclusive of any derivative of artificial data. In another refinement, artificial data is generated utilizing at least a portion of reference animal data. For the purposes of the presently disclosed and claimed subject matter, the terms “simulated data” and “synthetic data” are synonymous and used interchangeably with “artificial data” (and vice versa), and a reference to any one of the terms should not be interpreted as limiting but rather as encompassing all possible meanings of all the terms. In another refinement, the term “artificial data” is inclusive of the term “artificial animal data.”

The term “insight” refers to one or more descriptions or indicators that can be assigned to a targeted individual or data associated with the targeted individual or their animal data that describes a condition or status of, or related to, the targeted individual or the animal data utilizing at least a portion of the animal data. An insight can also provide information related the animal data itself or its one or more derivatives (e.g., a summary of the animal data and the associated metadata; the output of the one or more evaluations, verifications, or validations; information related to the one or more terms; pricing information related to the collateral asset or digital asset, and the like), which may be included (at least in part) as part of the collateral asset or digital asset in some variations, or used by the system in the creation or modification of the collateral asset or digital asset (e.g., the insight may be utilized by the system to create and assign a monetary value to the animal data). Examples include descriptions or other characterizations related to an individual's stress levels (e.g., high stress, low stress), energy levels, fatigue levels, bodily responses, medical conditions, and the like, or related to the animal data (e.g., information related to the pricing/valuation of any particular animal data set; information that enables the one or more evaluations, verifications, validations, or a combination thereof; information that enables the pricing of the animal data or its one or more derivatives; information that enables the creation or modification and assignment of one or more terms). An insight may be quantified by one or more numbers (e.g., including a plurality of one or more numbers) in a machine-readable format, and/or may be represented as a probability or similar odds-based indicator. An insight may also be quantified, communicated, or characterized by one or other metrics or indices of performance that are predetermined (e.g., codes, graphs, charts, plots, colors or other visual representations, plots, readings, numerical representations, descriptions, text, physical responses such as a vibration, auditory responses, visual responses, kinesthetic responses, or verbal descriptions). An insight can also include one or more visual representations related to a condition or status of the of one or more targeted subjects (e.g., an avatar or virtual depiction of a targeted subject visualizing future weight loss goals on the avatar or depiction of the targeted subject) or status related to their animal data. In a refinement, an insight is a personal score or other indicator related to one or more targeted individuals or groups of targeted individuals (e.g., including related to their animal data) that utilizes at least a portion of animal data to (1) evaluate, assess, prevent, or mitigate animal data-based risk; (2) to evaluate, assess, or optimize animal data-based performance (e.g. biological performance, monetary performance); or a combination thereof. The personal score or other indicator can be utilized by the one or more targeted subjects from which the animal data or one or more derivatives thereof are derived from, as well as one or more third parties (e.g., insurance organizations, financial lenders, goods/services providers, healthcare providers or professionals, sports performance coaches, medical billing organizations, fitness trainers, employers, virtual environment operators, sports betting companies, data monetization companies, and the like). In a variation, the personal score can be attributed to the one or more sets of animal data or its one or more derivatives (e.g., reputational score, data quality score, value score, and the like). In another refinement, an insight is derived from one or more computed assets. In another refinement, an insight is derived from one or more predictive indicators. In another refinement, an insight is derived from two or more types of animal data. In another refinement, an insight is derived related to a targeted subject or group of targeted subjects using at least a portion of animal data not derived from the targeted subject or group of targeted subjects. In another refinement, an insight includes one or more inputs (e.g., signals, readings, other data) from one or more non-animal data sources in one or more computations, calculations, measurements, derivations, incorporations, simulations, extractions, extrapolations, modifications, enhancements, creations, combinations, conversions, estimations, deductions, inferences, determinations, processes, communications, and the like. In another refinement, an insight is comprised of a plurality of insights. In another refinement, an insight is assigned to a collection of animal data or multiple collections of animal data (e.g., collections that include at least a portion of the same animal data). In another refinement, an insight is assigned to multiple targeted individuals. In yet another refinement, an insight is assigned to one or more groups of targeted individuals. In another refinement, an insight is derived utilizing at least a portion of reference animal data.

The term “computed asset” refers to one or more numbers, a plurality of numbers, values, metrics, readings, insights, graphs, charts, or plots that are derived from at least a portion of the animal data or one or more derivatives thereof (e.g., which can be inclusive of simulated data). For example, in the context of sensor-derived animal data, the one or more sensors used herein initially provide an electronic signal. The computed asset is extracted or derived, at least in part, from the one or more electronic signals or one or more derivatives thereof. The computed asset can describe or quantify an interpretable property of the one or more targeted individuals or groups of targeted individuals. For example, a computed asset such as electrocardiogram readings can be derived from analog front end signals (e.g., the electronic signal from the sensor), heart rate data (e.g., heart rate beats per minute) can be derived from electrocardiogram or PPG sensors, body temperature data can be derived from temperature sensors, perspiration data can be derived or extracted from perspiration sensors, glucose information can be derived from biological fluid sensors, DNA and RNA sequencing information can be derived from sensors that obtain genomic and genetic data, brain activity data can be derived from neurological sensors, hydration data can be derived from in-mouth saliva or sweat analysis sensors, location data can be derived from GPS/optical/RFID-based sensors, biomechanical data can be derived from optical or translation sensors, and breathing rate data can be derived from respiration sensors. In a refinement, a computed asset includes one or more inputs (e.g., signals, readings, other data) from one or more non-animal data sources in one or more computations, calculations, measurements, derivations, incorporations, simulations, extractions, extrapolations, modifications, enhancements, creations, combinations, estimations, deductions, inferences, conversions, determinations, processes, communications, and the like. In another refinement, a computed asset is derived from two or more types of animal data. In another refinement, a computed asset is comprised of a plurality of computed assets. In another refinement, a computed asset may be derived utilizing at least a portion of simulated data.

In some variations, the system may create an “evaluation asset” with the gathered or accessed animal data and/or reference data to make the one or more evaluations, verifications, and/or validations related to the gathered or accessed animal data, as well as to create and/or assign one or more monetary values or modify one or more monetary values assigned to the gathered or accessed animal data (e.g., including its one or more derivatives, such as the collateral asset or digital asset). The term “evaluation asset” refers to one or more digital signatures (e.g., unique digital signatures, non-unique digital signatures), identifiers (e.g., non-unique identifiers, unique identifiers), patterns (e.g., any type of pattern including time slice, spatial, spatiotemporal, temporospatial, and the like), rhythms, trends, summaries, scores (e.g., data score based on quality completeness, terms/permissions/conditions associated with the animal data, and/or other characteristics), features, measurements, outliers, anomalies, or characteristics (e.g., unique characteristics; consistencies; inconsistencies) derived from one or more calculations, computations, derivations, extractions, extrapolations, simulations, creations, modifications, enhancements, estimations, evaluations, inferences, establishments, determinations, conversions, deductions, or observations from animal data, at least in part, and/or reference data that enable the evaluation (e.g., including identification), verification, and/or validation of the animal data (e.g., including origin of the animal data) and/or one or more characteristics associated with or related to the animal data, as well as the creation, modification, or verification of one or more monetary values associated with the animal data for the purposes of using the animal data as collateral (with “as collateral” including “as a digital currency” in some variations) or as consideration to receive or acquire other consideration (e.g., verifying the value of the animal data and its associated with terms to be used as a digital asset—such as an animal data-based digital token or coin—for acquiring consideration). In many variations, the at least one evaluation asset enables the identification of an individual, one or more characteristics associated with their animal data, or a combination thereof to enable one or more monetary values to be created, modified, or verified for the animal data (e.g., inclusive of its one or more derivatives). In a refinement, the at least one evaluation asset uses animal data derived from two or more source sensors to create, modify, or enhance the at least one evaluation asset. In another refinement, the at least one evaluation asset uses two or more types of animal data to create, modify, or enhance the at least one evaluation asset. In another refinement, the at least one evaluation asset uses two or more types of animal data derived from the same source sensor to create, modify, or enhance the at least one evaluation asset. In another refinement, the at least one evaluation asset uses two or more types of animal data derived from two or more source sensors to create, modify, or enhance the at least one evaluation asset. In another refinement, the at least one evaluation asset can be applied as an identification, evaluation, verification, or validation asset for one or more characteristics directly or indirectly related to the animal data (e.g., including an evaluation of its associated monetary value(s) and the one or more terms such as the one or more rights, conditions, permissions, preferences, and the like associated with the animal data) the targeted subject, medical condition, or biological response. In another refinement, the one or more evaluation assets can be utilized by the system upon receiving one or more collateral or digital assets from one or more other computing devices to evaluate, verify, and/or validate the received collateral or digital asset. In another refinement, the term “evaluation” is inclusive of the term “identification.” In another refinement, the at least one evaluation asset includes at least a portion of non-animal data. In another refinement, the creation, modification, or enhancement of the at least one evaluation asset utilizes at least a portion of artificial data. In another refinement, the at least one evaluation asset enables authentication of one or more source sensors (e.g., authenticating that the one or more sensors are, in fact, being used to collect animal data from the targeted subject) and the associated animal data. In another refinement, the act of “authenticating” is included in the one or more actions taken to “validate,” “verify,” or a combination thereof. In another refinement, the at least one evaluation asset is created, modified, or enhanced from two or more types of animal data that are captured across one or more time periods and one or more activities. For example, an evaluation asset such as a unique biological signature may be created for an individual based upon multiple computed assets or insights, captured across multiple time periods and multiple activities. In another refinement, the at least one evaluation asset is created, modified, or enhanced using two or more types of animal data, collected across two or more time periods, collected when the targeted subject is engaged in one or more activities, or a combination thereof. In another refinement, the at least one evaluation asset can be unique to a targeted individual, the animal data, medical condition, biological response, or other characteristic related to creating, modifying, or verifying one or more monetary values for the animal data, or a subset of targeted individuals, medical conditions, and other characteristics related to creating, modifying, or verifying one or more monetary values for the animal data. In another refinement, the at least one evaluation asset is not unique to a targeted individual, the animal data, medical condition, biological response, or other characteristic related to creating, modifying, or verifying one or more monetary values for the animal data, or subset and can be applied to multiple targeted individuals, medical conditions, or characteristics related to creating, modifying, or verifying one or more monetary values for the animal data. In another refinement, the at least one evaluation asset is created, modified, or enhanced using one or more Artificial Intelligence techniques. In another refinement, the at least one evaluation asset is created, modified, or enhanced using one or more Artificial Intelligence techniques that produce one or more biological representations of the targeted individual for the purposes of understanding one or more biological functions or processes of the targeted individual based upon their animal data (e.g., a personalized biological baseline for that individual, such as a digital map of biological responses for each individual associated with contextual data and one or more outcomes that enables the system to learn and understand about that individual's body on a granular level) to create, modify, or enhance the at least one evaluation asset and/or one or more monetary values for the animal data. In another refinement, an evaluation asset is comprised of a plurality of evaluation assets. In another refinement, the evaluation asset can be utilized to evaluate, verify, and/or validate at least one of the one or more assets of an asset-backed digital currency (e.g., digital token or coin). In another refinement, the at least one of the assets backing the digital currency is an individual's animal data or animal data from a group of individuals. For example, the evaluation asset may be utilized to verify the source (e.g., origin) of an animal data-based (e.g., backed) token or coin. In another refinement, at least a portion of information derived from evaluation asset is included as part of the collateral asset or digital asset provided. In another refinement, the at least one evaluation asset is utilized to evaluate the one or more collateral assets or digital assets.

In a refinement, the act of “evaluating” refers to the identification and assessment of one or more data sets, including animal and non-animal data sets, and/or its one or more derivatives, including one or more digital signatures, identifiers, patterns (e.g., any type of pattern including time slice, spatial, spatiotemporal, temporospatial, and the like), rhythms, trends, summaries, scores (e.g., data score based on data quality completeness, terms/permissions/conditions associated with the animal data, and/or other characteristics), features, measurements, outliers, anomalies, or characteristics (e.g., unique characteristics) derived from one or more calculations, computations, derivations, extractions, extrapolations, simulations, creations, modifications, enhancements, estimations, evaluations, inferences, establishments, determinations, conversions, deductions, or observations from animal data, at least in part, and/or reference data that enable the evaluation (e.g., including identification), verification, and/or validation of the animal data (e.g., including origin of the animal data) and/or one or more characteristics associated with or related to the animal data, as well as the creation, modification, or verification of one or more monetary values, terms, or a combination thereof, associated with the animal data for the purposes of using the animal data as collateral (with “as collateral” including “as a digital currency” in some variations) or as a digital asset to receive or acquire consideration. In a refinement, the act of evaluating includes the use of at least one evaluation asset. In another refinement, the system creates two or more evaluation assets, at least one of which is derived from the animal data and at least one of which is derived from the reference data, to make the one or more evaluations related to the animal data. In a refinement, the system may create or modify and assign an insight or other indicator associated with the evaluated animal data or its one or more derivatives (e.g., the collateral asset or digital asset) to provide context to the evaluation (e.g., data quality score). In some variations, the indicator (e.g., a notification that an evaluation has occurred) can provide verification that an evaluation has occurred.

The term “predictive indicator” refers to a metric or other indicator (e.g., one or more colors, codes, numbers, values, graphs, charts, plots, readings, numerical representations, descriptions, text, physical responses, auditory responses, visual responses, kinesthetic responses) derived from at least a portion of animal data, its associated characteristics (e.g., terms/conditions/permissions, associated monetary information), or a combination thereof, from which one or more forecasts, predictions, probabilities, assessments, possibilities, projections, or recommendations related to one or more outcomes for one or more future events or sub-events that includes one or more targeted individuals, or one or more groups of targeted individuals, can be calculated, computed, derived, extracted, extrapolated, quantified, simulated, created, modified, assigned, enhanced, estimated, evaluated, inferred, established, determined, converted, deduced, observed, communicated, or actioned upon. In a refinement, a predictive indicator is a calculated computed asset. In another refinement, a predictive indicator includes one or more inputs (e.g., signals, readings, other data) from one or more non-animal data sources as one or more inputs in the one or more calculations, computations, combinations, measurements, derivations, extractions, extrapolations, simulations, creations, modifications, assignments, enhancements, estimations, evaluations, inferences, establishments, determinations, conversions, deductions, observations, or communications of its one or more forecasts, predictions, probabilities, possibilities, assessments, projections, or recommendations. In another refinement, a predictive indicator includes at least a portion of simulated data as one or more inputs in the one or more calculations, computations, combinations, measurements, derivations, extractions, extrapolations, simulations, creations, modifications, assignments, enhancements, estimations, evaluations, inferences, establishments, determinations, conversions, deductions, observations, or communications of its one or more forecasts, predictions, probabilities, possibilities, assessments, projections, or recommendations. In another refinement, a predictive indicator is derived from two or more types of animal data. In another refinement, a predictive indicator is comprised of a plurality of predictive indicators. In yet another refinement, a created, modified, or enhanced predictive indicator is used as training data for one or more Artificial Intelligence-based techniques to create, modify, or enhance of one or more subsequent predictive indicators.

A “collateral asset” or “digital asset” is a unit of information with an associated value (e.g., monetary value, non-monetary value) or multiple associated values comprised of at least a portion of data. In a refinement, the at least a portion of data includes or is comprised of animal data, its one or more derivatives, or a combination thereof. In another refinement, the unit of information includes or is comprised of at least a portion of data (e.g., animal data, its one or more derivatives, or a combination thereof), its associated metadata, one or more terms, one or more monetary values associated with the unit of information, or a combination thereof. In another refinement, the unit of information includes or is comprised of multiple units of information from one or more targeted individuals (e.g., including groups of data from a single individual, and groups/subsets of individuals) that comprise the unit of information. In another refinement, the unit of information is used to acquire (e.g., obtain) consideration (e.g., goods, services, forms of currency, and the like) in the real world, virtual/simulated world, or a combination thereof. In another refinement, a collateral asset or digital asset is a unit of information transformed and packaged (e.g., as a digital coin, digital token, digital trading card, digital identity card, digital avatar, or similar digital asset that can be exchanged for other consideration) to enable the unit of information to be used to acquire other consideration.

The terms “collateral asset” and “digital asset” can be used interchangeably, and a reference to any one of the terms should not be interpreted as limiting but rather as encompassing all possible meanings of all the terms. In a refinement, the collateral asset is a digital asset used by a targeted individual or one or more other users as a form of digital currency to acquire consideration (e.g., in the real world and/or virtual/simulated/augmented/digital world). In another refinement, the digital currency is a digital coin, digital token, digital ticket, digital trading card, digital identity card, digital avatar, digital certificate, or other form of digital asset that includes at least a portion of animal data, its associated metadata, and the associated one or more terms (e.g., at least one or more of which are inputted by the data provider/owner). In another refinement, the digital asset is a collateral asset used by the targeted individual or one or more other users as a form of collateral to acquire consideration.

In a refinement, a “transformation” related to data can consist of a conversion of at least a portion of data (e.g., animal data, its one or more derivatives, or a combination thereof), its associated metadata (e.g., which can include other data related to the data), one or more terms, one or more monetary values associated with the unit of information, or a combination thereof, into one or more units of information packaged as one or more assets (e.g., collateral assets, digital assets) that can be distributed to one or more computing devices for consideration. Examples of such transformations can involve a step in which the data is converted to a cyptocurrency (e.g., Bitcoin, Blockchain, and the like). Moreover, transformation can involve steps in which the data is de-noised, compressed, downsized, and the like.

For the purposes of this invention, any reference to the collection or gathering of animal data from one or more source sensors from a subject includes gathering the animal data from one or more computing devices associated with the one or more source sensors (e.g., a cloud server or other computing device associated with the one or more source sensors where the data is stored or accessible). Additionally, the terms “gathering” and “collecting” can be used interchangeably, and reference to any one of the terms should not be interpreted as limiting but rather as encompassing all possible meanings of both terms. In a refinement, the terms “gathering” and “collecting” can be used interchangeably with the term “receiving” (and vice versa), and reference to any one of the terms should not be interpreted as limiting but rather as encompassing all possible meanings of all the terms.

The term “modify” can be inclusive of “revise,” “amend,” “update,” “adjust,” “change,” and “refine” (and vice versa). Additionally, the term “create” can be inclusive of “derive” and vice versa. Similarly, “create” can be inclusive of “generate” and vice versa. In a refinement, “create” can also include an action that is calculated, computed, derived, extracted, extrapolated, simulated, modified, enhanced, estimated, evaluated, inferred, established, determined, converted, or deduced. The term “enhance” refers to an improvement of quality or value in (or of) data and in particular the animal data or one or more derivatives thereof (e.g., computed asset, predictive indicator, insight).

A modification or enhancement of data, including one or more characteristics/attributes related to the data (e.g., including its monetary value), can occur: (1) as new data (e.g., animal data, non-animal data) is gathered by the system; (2) based upon one or more evaluations of newly-gathered or existing data (e.g., one or more new patterns, trends, features, measurements, outliers, abnormalities, anomalies, readings, signals, data sets, characteristics/attributes, and the like that are identified in newly-gathered or existing data sets by the system); (3) as existing data is removed or replaced in the system; (4) as the system learns one or more new methods of transforming newly-gathered or existing data into new data sets or deriving new data sets from existing data (e.g., the system learns to derive respiration rate data from raw sensor data that is traditionally used to extrapolate ECG data); (5) as new data is generated artificially; and/or (6) as a result of one or more simulations; and the like. For example, new data entering the system may enhance the accuracy of the system's predictive indicator (e.g., as the system will have more information to train the prediction models with to predict more accurately outcomes) or enhance the value of a data set which includes the newly-gathered data. In another example, a data set or animal data derivative can be modified if data is removed from, or replaced in, the system (e.g., the system's removal of data from the reference animal data database may enable a more accurate identification of a targeted individual). In some variations, modification may result in a decrease in quality or value of the animal data or its one or more derivatives (e.g., a decrease in prediction accuracy; decrease in monetary value; and the like).

The term “or a combination thereof” can mean any subset of possibilities or all possibilities. In a refinement, “or a combination thereof” includes both “or combinations thereof” and “and combinations thereof” and vice versa.

The term “neural network” refers to a Machine Learning model that can be trained with training input to approximate unknown functions. In a refinement, neural networks include a model of interconnected digital neurons that communicate and learn to approximate complex functions and generate outputs based on a plurality of inputs provided to the model.

The terms “use”, “uses”, or “used” when referring to actions taken by a computing system mean that the item being “used” is received as an input for a calculation performed by the computing system to provide an indicated output.

In a refinement, one or more evaluations (e.g., which can include comparisons) or a step of evaluating (e.g., which can include one or more steps of comparing) can occur when the system utilizes one or more programs, which may incorporate one or more techniques (e.g., Artificial Intelligence techniques which can include, but are not limited to, Machine Learning techniques, Deep Learning techniques, Statistical Learning techniques, or other statistical techniques), to measure, observe, calculate, derive, extract, extrapolate, simulate, create, combine, modify, enhance, estimate, evaluate, infer, establish, determine, convert, or deduce one or more similarities, dissimilarities, or a combination thereof, between two or more animal data sets (e.g., which can include one or more derivatives of animal data and its associated metadata), at least one of which is derived from reference animal data and at least one of which is derived—at least in part—from one or more source sensors. In another refinement, at least one of the two or more animal data sets incorporates at least one evaluation asset to compare data sets and enable one or more evaluations, verifications, and/or validations related to the creation, modification, assignment, or a combination thereof, of one or more monetary values related to at least one of the two or more data sets. In another refinement, two or more of the animal data sets each incorporate at least one evaluation asset to compare data sets and enable one or more evaluations, verifications, and/or validations related to the creation, modification, assignment, or a combination thereof, of one or more monetary values related to at least one of the two or more data sets. In one scenario, a comparison occurs when the system utilizes a sophisticated ensemble clustering algorithm that uses a combination of clustering algorithms that can include Density-Based Spatial Clustering Of Applications With Noise (DBSCAN), BIRCH, Gaussian Mixture Model (GMM), Hierarchical Clustering Algorithm (HCA) and Spectral-based clustering while using metrics of similarity grouping that can include inertia and silhouette scoring, as well as information criteria scores to identify the group or cluster. The output of the above methodology map gives data to a cluster or group. Within the identified group, one or more additional Machine Learning algorithms can be used that measure the nearness of data to similar sub-groups to identify, at least in part, the potential target the given data belongs to. Such methodologies can be utilized to identify or evaluate other information, such as similarities in data sets to create, modify, and/or assign one or more monetary values for one or more data sets (e.g., animal data sets) or its one or more derivatives (e.g., collateral or digital assets) based upon the one or more characteristics of similar or dissimilar data sets (or derivatives) and the associated monetary values (e.g., previously-priced or valued data). In another refinement, an act of evaluating occurs via the creation or modification and use of one or more evaluation assets for at least one animal data set.

In another refinement, “compare” can mean “evaluate” and/or “analyze,” and vice versa. For example, a step of comparing two or more evaluation assets, or comparing a data set to a reference data set, to create a monetary value for a given data set can involve forming insights from the target individual's one or more data sets being valued. Monetary values can be created or assigned from predetermined ranges of values that are associated with predefined insights derived from the one or more reference data sets based upon one or more characteristics of the data (e.g., data type, quality, the source sensor(s), the individual the data was derived from, volume of the data set, associated metadata, and the like). Therefore, in this context, “compare” means to select the appropriate one or more reference data sets, evaluation assets, or a combination thereof, based upon one or more characteristics of the data set (or derivative) being assigned a value (e.g., monetarily, non-monetarily) in order to enable identification of the appropriate range of monetary or non-monetary values, or the one or more values itself, that the system may assign to an individual's one or more data sets.

In a refinement, the phrase “as collateral” is inclusive of the phrase “as a form of digital currency” including variations thereof, and vice versa.

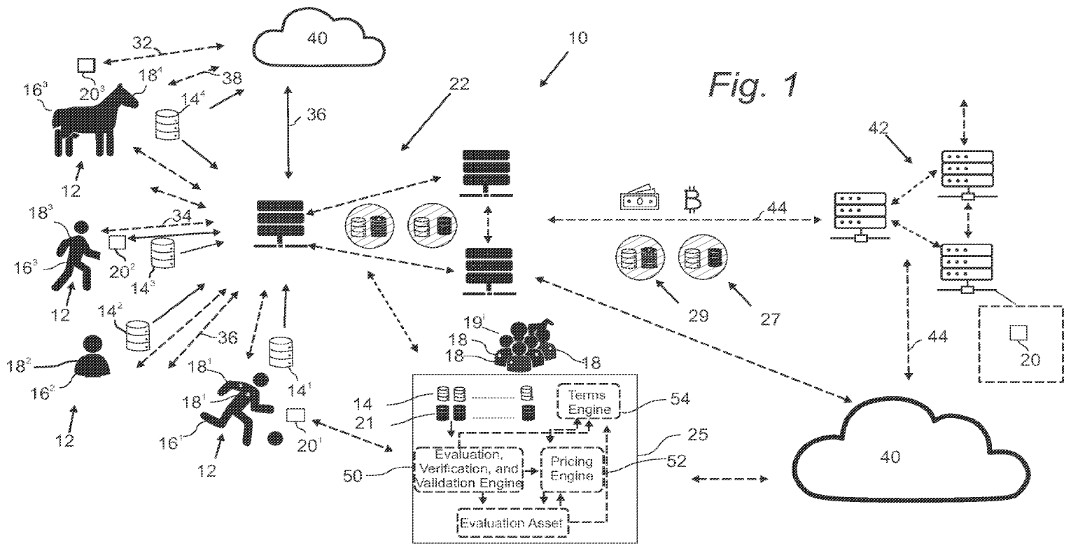

With reference to FIG. 1, a schematic of a system for collecting, evaluating, and utilizing animal data as collateral for consideration is provided. Animal data-based collateral and consideration system 10 includes source 12 of animal data 14 that can be transmitted electronically. In this context, transmitted electronically includes being provided in an electronic form. In some variations, source 12 of animal data 14 refers to data related to targeted individual 16ⁱ. Targeted individual 16ⁱ is the subject from which corresponding animal data 14 is collected. Label i is merely an integer label from 1 to iₘₐₓ associated with each targeted individual, where iₘₐₓ is the total number of individuals, which can be 1 to several thousand to several million or more. In this context, animal data can refer to any data related to a subject. In some embodiments, animal data refers to data related to a subject's body derived, at least in part, from one or more sensors and, in particular, biological sensors (also referred to as biosensors). Therefore, in these embodiments the one or more sources 12 of animal data 14 includes one or more sensors. In many useful applications, targeted individual 16ⁱ is a human (e.g., an athlete, a soldier, a healthcare patient, an insurance customer, a research subject, a participant in a fitness class, a video or virtual gamer) and the animal data 14 is human data.

Animal data can be derived from (e.g., collected from) a targeted individual or multiple targeted individuals (e.g., including a targeted group of multiple targeted individuals, multiple targeted groups of multiple targeted individuals). Animal data can be derived from a variety of sources, including sensors and other computing devices. In the case of sensors, the animal data can be obtained from a single sensor gathering information from each targeted individual or from multiple sensors gathering information from each targeted individual. Each sensor 18 gathering animal data from source 12 of animal data 14 from targeted individual 16ⁱ can be classified as a source sensor. In some cases, a single sensor can capture data from multiple targeted individuals, a targeted group of multiple targeted individuals, or multiple targeted groups of multiple targeted individuals (e.g., an optical-based camera sensor that can locate and measure distance run or respiratory data for a targeted group of targeted individuals). Each sensor can provide a single type of animal data or multiple types of animal data. In a variation, sensor 18 can include multiple sensing elements to measure one or more parameters within a single sensor (e.g., heart rate and accelerometer data). One or more sensors 18 can collect data from a targeted individual engaged in a variety of activities, including strenuous activities that can change one or more biological signals or readings in a targeted individual such as blood pressure, heart rate, or biological fluid levels. Activities may also include sedentary activities such as sleeping or sitting where changes in biological signals or readings may have less variance. One or more sensors 18 can also collect data before or after one or more other activities (e.g., after a run, after waking up, after ingesting one or more substances or medications, and any other activity suitable for data collection from one or more sensors). In a refinement, one or more sensors 18 can be classified as a computing device with one or more computing capabilities (e.g., enabling the automated or manual input of one or more types of animal data and/or its associated contextual data). In a variation, animal data-based collateral and consideration system 10 can also gather (e.g., receive, collect) animal data not obtained from sensors (e.g., animal data that is inputted or gathered via a computing device; animal data sets that include artificial data values not generated directly from a sensor; animal data received from another computing device). This can occur via computing device 20 or via one or more other computing devices in communication with computing device 20 that gather animal data. In a refinement, one or more sensors 18 are operable to collect at least a portion of non-animal data. In another refinement, at least one sensor of the one or more source sensors captures two or more types of animal data. In another refinement, at least one sensor of the one or more source sensors is comprised of two or more sensors. In another refinement, the one or more sensors can collect data over a continuous period of time or at regular or irregular intervals (e.g., intermittently). In many variations, one or more sensors 18 are operable for real-time or near real-time communication. In another refinement, at least one of the one or more sensors 18 are operable to provide streaming animal data. In a variation, one or more sensor functionalities, parameters, or properties are operable to be configured either directly or indirectly (e.g., via another one or more other computing devices) by the system. In another refinement, at least one of the one or more sensors 18 are operable to store at least a portion of the animal data gathered from the one or more targeted individuals on the device prior to sending to one or more computing devices operated by the system to gather such data.

One or more sensors 18 can include one or more biological sensors (also referred to as biosensors). Biosensors collect biosignals, which in the context of the present embodiment are any signals or properties in, or derived from, animals that can be continually or intermittently measured, monitored, observed, calculated, computed, or interpreted, including both electrical and non-electrical signals, measurements, and artificially-generated information. A biosensor can gather biological data (including readings and signals, both in raw or manipulated/processed form) such as physiological data, biometric data, chemical data, biomechanical data, genetic data, genomic data, glycomic data, location data or other biological data from one or more targeted individuals. For example, some biosensors may measure, or provide information that can be converted into or derived from, biological data such as eye tracking & recognition data (e.g., pupillary response, movement, pupil diameter, iris recognition, retina scan, eye vein recognition, EOG-related data), blood flow data and/or blood volume data (e.g., photoplethysmogram (PPG) data, pulse transit time, pulse arrival time), biological fluid data (e.g., analysis derived from blood, urine, saliva, sweat, cerebrospinal fluid), body composition data (e.g., bioelectrical impedance analysis, weight-based data including weight, body mass index, body fat data, bone mass data, protein data, basal metabolic rate, fat-free body weight, subcutaneous fat data, visceral fat data, body water data, metabolic age, skeletal muscle data, muscle mass data), pulse data, oxygenation data (e.g., SpO2), core body temperature data, galvanic skin response data, skin temperature data, perspiration data (e.g., rate, composition), blood pressure data (e.g., systolic, diastolic, MAP), glucose data (e.g., fluid balance I/O, glycogen usage), hydration data (e.g., fluid balance I/O), heart-based data (e.g., heart rate, average HR, HR range, heart rate variability, HRV time domain, HRV frequency domain, autonomic tone, ECG-related data including PR, QRS, QT, R-R intervals, echocardiogram data, thoracic electrical bioimpedance data, transthoracic electrical bioimpedance data), neurological data and other neurological-related data (e.g., EEG-related data), genetic-related data (e.g., performance enhancing polymorphisms (PEPs) such as ACTN3, ACE, ADRB2, AMPD1, BDKRB2, APOE, and others), genomic-related data, skeletal data, muscle data (e.g., EMG-related data including surface EMG, amplitude, adenosine triphosphate (ATP) data, muscle fiber types, muscle contraction velocity, muscle elasticity, soft-tissue strength), respiratory data (e.g., respiratory rate, respiratory pattern, inspiration/expiration ratio, tidal volume, spirometry data), and the like. Some biosensors may detect biological data such as biomechanical data which may include, for example, angular velocity, joint paths, kinetic or kinematic loads, gait description, step count, reaction time, or position or accelerations in various directions from which a subject's movements can be characterized. Some biosensors may gather biological data such as location and positional data (e.g., GPS, ultra-wideband RFID-based data; posture data), facial recognition data, posterior profiling data, audio data, kinesthetic data (e.g., physical pressure captured from a sensor located at the bottom of a shoe), other biometric authentication data (e.g., fingerprint data, hand geometry data, voice recognition data, keystroke dynamics data—including usage patterns on computing devices such as mobile phones, signature recognition data, ear acoustic authentication data, eye vein recognition data, finger vein recognition data, footprint and foot dynamics data, body odor recognition data, palm print recognition data, palm vein recognition data, skin reflection data, thermography recognition data, speaker recognition data, gait recognition data, lip motion data), or auditory data (e.g., speech/voice data, sounds made by the subject, emotion captured derived from verbal tone or words used) related to the one or more targeted individuals. Some biological sensors may be image or video-based and collect, provide and/or analyze video or other visual data (e.g., still or moving images, including video, MRIs, computed tomography scans, ultrasounds, echocardiograms, X-rays) upon which biological data can be detected, measured, monitored, observed, extrapolated, calculated, or computed (e.g., biomechanical movements or location-based information derived from video data, a fracture detected based on an X-Ray, or stress or a disease of a subject observed based on video or image-based visual analysis of a subject; observable animal data such as facial movements, bodily movements or a wince which can indicate pain or fatigue). Some biosensors may derive information from biological fluids such as blood (e.g., venous, capillary), saliva, urine, sweat, and the like including (but not limited to) triglyceride levels, red blood cell count, white blood cell count, adrenocorticotropic hormone levels, hematocrit levels, platelet count, ABO/Rh blood typing, blood urea nitrogen levels, calcium levels, carbon dioxide levels, chloride levels, creatinine levels, glucose levels, hemoglobin A1c levels, lactate levels, sodium levels, potassium levels, bilirubin levels, alkaline phosphatase (ALP) levels, alanine transaminase (ALT) levels, and aspartate aminotransferase (AST) levels, albumin levels, total protein levels, prostate-specific antigen (PSA) levels, microalbuminuria levels, immunoglobulin A levels, folate levels, cortisol levels, amylase levels, lipase levels, gastrin levels, bicarbonate levels, iron levels, magnesium levels, uric acid levels, folic acid levels, vitamin B-12 levels, and the like. In a variation, some biosensors may collect biochemical data including acetylcholine data, dopamine data, norepinephrine data, serotonin data, GABA data, glutamate data, hormonal data, and the like. In addition to biological data related to one or more targeted individuals, some biosensors may measure non-biological data (e.g., ambient temperature data, humidity data, elevation data, barometric pressure data, and the like). In a refinement, one or more sensors provide biological data that include one or more calculations, computations, predictions, probabilities, possibilities, combinations, estimations, evaluations, inferences, determinations, deductions, observations, or forecasts that are derived, at least in part, from animal data. In another refinement, the one or more biosensors are capable of providing at least a portion of artificial data. In another refinement, the one or more biosensors are capable of providing two or more types of data, at least one of which is biological data (e.g., heart rate data and VO2 data, muscle activity data and accelerometer data, VO2 data and elevation data, or the like). In a refinement, the one or more sensors is a biosensor that gathers physiological, biometric, chemical, biomechanical, location, environmental, genetic, genomic, glycomic, or other biological data from one or more targeted individuals. In another refinement, one or more biosensors collect image data and/or video data (e.g., one or more images of the subject, one or more videos of the subject, or a combination thereof) via one or more image sensors, video sensors, or a combination thereof.

In another refinement, the at least one sensor 18 and/or its one or more appendices thereof can be affixed to, are in contact with, or send one or more electronic communications in relation to or derived from, one or more targeted subjects including the one or more targeted subjects' body, skin, eyeball, vital organ, muscle, hair, veins, biological fluid, blood vessels, tissue, or skeletal system, embedded in one or more targeted subjects, lodged or implanted in one or more targeted subjects, ingested by one or more targeted subjects, or integrated to include at least a subset of one or more targeted subjects. For example, a saliva sensor affixed to a tooth, a set of teeth, or an apparatus that is in contact with one or more teeth, a sensor that extracts DNA information derived from a targeted subject's biological fluid or hair, sensor that is wearable (e.g., on a human or other animal body), a sensor in a computing device (e.g., phone) that is tracking a targeted individual's location information or collecting other biometric information (e.g., facial recognition, voice, fingerprint), one or more sensors integrated within a head-mountable unit such as smart glasses or a virtual/augmented/mixed reality headset that track eye movements and provide eye tracking data and recognition data, one or more sensors that are integrated into one or more computing devices that analyze biological fluid data, a sensor affixed to or implanted in the targeted subject's brain that may detect brain signals from neurons, a sensor that is ingested by a targeted subject to track one or more biological functions, a sensor attached to, or integrated with, a machine (e.g., robot) that shares at least one characteristic with an animal (e.g., a robotic arm with an ability to perform one or more tasks similar to that of a human; a robot with an ability to process information similar to that of a human), and the like. Advantageously, the machine itself can include of one or more sensors and can be classified as both a sensor and a subject. In another refinement, the one or more sensors 18 are integrated into or as part of, affixed to, or embedded within, a textile, fabric, cloth, material, fixture, object, or apparatus that contacts or is in communication with a targeted individual either directly or via one or more intermediaries or interstitial items. Examples include, but are not limited to, a sensor attached to the skin via an adhesive, a sensor integrated into a watch or head-mountable or wearable unit (e.g., augmented reality or virtual reality headset, smart glasses, hat, headband, and the like), a sensor integrated or embedded into clothing (e.g., a shirt, jersey, shorts, wristband, socks, compression gear), a sensor integrated into a steering wheel, a sensor integrated into a computing device controller (e.g., a video game or virtual environment controller, augmented reality headset controller, remote control for media), a sensor integrated into a ball that is in contact with an extremity of a targeted subject's body such as their hands (e.g. basketball) or feet (e.g., soccer), a sensor integrated into a ball that is in contact with an intermediary being held by the targeted subject (e.g., bat), a sensor integrated into a hockey stick or a hockey puck that is in intermittent contact with an intermediary being held by the targeted subject (e.g., hockey stick), a sensor integrated or embedded into the one or more handles or grips of fitness equipment (e.g., treadmill, bicycle, row machine, bench press, dumbbells), a toilet or other object with one or more sensors that can analyze one or more biological fluids, stool, or other animal excretions, a sensor that is integrated within a robot (e.g., robotic arm) that is being controlled by the targeted individual, a sensor integrated or embedded into a shoe that may contact the targeted individual through the intermediary sock and adhesive tape wrapped around the targeted individual's ankle, and the like. In another refinement, one or more sensors can be interwoven into, embedded into, integrated with, or affixed to, a flooring or ground (e.g., artificial turf, grass, basketball floor, soccer field, a manufacturing/assembly-line floor, yoga mat, modular flooring), a seat/chair, helmet, a bed, an object that is in contact with the targeted subject either directly or via one or more intermediaries (e.g., a subject that is in contact with a sensor in a seat via a clothing intermediary), and the like. In another refinement, one or more sensors can be integrated with or affixed to one or more aerial apparatus such as an unmanned aerial vehicle (e.g., drone, high-altitude long-endurance aircraft, a high-altitude pseudo satellite (HAPS), an atmospheric satellite, a high-altitude balloon, a multirotor drone, an airship, a fixed-wing aircraft, or other altitude systems) or other aerial computing device that utilizes one or more sensors (e.g., optical, infrared) to collect animal data (e.g., skin temperature, body temperature, heart rate, heart rate variability, respiratory rate, facial recognition, gait recognition, location data, image data, one or more subject characteristics or attributes, and the like) from one or more targeted subjects or groups of targeted subjects. In another refinement, the sensor and/or its one or more appendices can be in contact with one or more particles or objects derived from the targeted subject's body (e.g., tissue from an organ, hair from the subject) from which the one or more sensors derive, or provide information that can be converted into, biological data. In yet another refinement, one or more sensors can be optically-based (e.g., camera-based) and provide an output from which biological data can be detected, measured, monitored, observed, extracted, extrapolated, inferred, deducted, estimated, determined, combined, calculated, or computed. In yet another refinement, one or more sensors can be light-based and use infrared technology (e.g., temperature sensor or heat sensor) to gather or calculate biological data (e.g., skin or body temperature) from an individual or the relative heat of different parts of an individual. In yet another refinement, the one or more sensors gather animal data related to one or more attributes/characteristics or states of being of an individual (e.g., an optical sensor that gathers animal data such as skin color, facial hair, eye color, conditions of the skin, and the like; an optical sensor that detects pain, fatigue, injury, a medical event/episode/condition; an optical sensor such an camera that captures video images and audio of the one or more subjects such as in a live sporting event; and the like).

Still referring to FIG. 1, at least one sensor 18 gathers animal data 14 from each targeted individual 16. The at least one sensor 18 is operable to communicate either directly or indirectly, via wired or wireless connection (of a combination thereof), with one or more computing devices. In FIG. 1, the at least one sensor 18 provides the gathered animal data to one or more computing devices 20 or another computing device (e.g., intermediary server 22, cloud server 40). In another variation, computing device 20, intermediary server 22, cloud 40, or a combination thereof, can operate one or more programs to gather animal data 14 (e.g., import animal data, input animal data, communicate with at least one sensor 18 to gather animal data, and the like), attributes related to the animal data (e.g., characteristics of the animal data, sensor information from which the animal data is derived), or other attributes related to the one or more targeted individuals 16 (e.g., attributes such as age, weight, height, birthdate, race, nationality, habits, medical history, family history, medication history, or financial history; and the like). In some variations, computing device 20, intermediary server 22, cloud 40, or a combination thereof, can be operable to gather information from a single targeted individual or multiple targeted individuals (e.g., including one or more groups of targeted individuals), as in the case of a hospital that uses a computing device to manage multiple patients, an insurance company or fitness organization that uses a computing device to manage multiple individuals, a sports team utilizing a computing device to manage its players, a holding company utilizing a computing device to manage groups of employees across one or more portfolio companies, and the like.

In a refinement, computing device 20 mediates the sending of animal data 14 to intermediary server 22 or cloud server 40 (i.e., it collects the animal data from one or more sensors 18, as well as from any programs operating on computing device 20 that gathers animal data, and transmits it to intermediary server 22, cloud server 40, or a combination thereof). For example, computing device 20 can be a mobile phone, smartwatch, smart glasses, a desktop computer, a laptop computer, tablet, or any other type of computing device that provides animal data and other information related to the targeted individual that can be used as part of the animal data-based collateral or digital currency utilized in exchange for consideration. In some cases, computing device 20 is local to the targeted individual, although not required. In another refinement, one or more sensors 18 may be housed within, attached to, affixed to, or integrated with, computing device 20 (e.g., as in the case of a computing device such as a mobile phone, smart watch, smart glasses, smart clothing, any other bodily-mountable unit, and the like which include one or more sensors 18 that collects animal data). In this variation, computing device 20 may also be categorized as sensor 18. In some variations, the functionality of computing device 20 can be deployed across multiple computing devices (e.g., multiple computing devices execute the one or more actions of computing device 20). In a refinement, computing device 20 can be comprised of multiple computing devices 20. In another refinement, intermediary server 22 operates as computing device 20. In another refinement, intermediary server 22 is computing device 20.

In a variation, intermediary server 22 or cloud server 40 can operate one or more programs to gather animal data 14 related to the one or more targeted individuals 16. One or more intermediary servers 22 or cloud servers 40 can be operable to gather information from a single targeted individual or multiple targeted individuals (e.g., including one or more groups of targeted individuals). It should be appreciated that both cloud server 40 and intermediary server 22 can include a single computer server or a plurality of interacting computer servers. In this regard, intermediary server 22 and cloud server 40 can communicate with one or more other computing devices and systems—including each other—to monitor, evaluate, receive, and record the one or more transactions related to the use of animal data as collateral or as a form of digital currency. In this case, the other computing devices may include computing device 25, third-party computing device 42, computing device 20, or another computing device. Moreover, intermediary server 22 and cloud server 40 can be operable to communicate with one or more other computing devices and systems—including each other—to monitor, evaluate, receive, and record the one or more monetary-related collections (e.g., collecting a type of currency digitally, collecting a service or goods digitally) and distributions related to the use of animal data as collateral or a digital currency in exchange for consideration.

In a variation, intermediary server 22 (e.g., local server or other type of server) communicates directly with the source of animal data 14, as shown by one or more communication links 34 with one or more sensors 18 or by one or more communication links 36 with one or more computing devices 20, cloud server 40, or other computing devices. This may include wired connections, wireless connections, or a combination thereof. In another variation, cloud server 40 communicates directly with the source of animal data 14, as shown by one or more communication links 38 with one or more sensors 18 or by one or more communication links 32 with one or more computing devices 20. In a refinement, intermediary server 22 communicates with the source 12 of animal data 14 through a cloud server 40 or other local servers. Cloud server 40 can be one or more servers that are accessible via the internet or other network. Cloud server 40 can be a public cloud, a hybrid cloud, a private cloud utilized by the organization operating intermediary server 22, a localized or networked server/storage, localized storage device (e.g., n terabyte external hard drive or media storage card), or distributed network of computing devices. In a refinement, cloud server 40 includes multiple cloud servers. In another refinement, intermediary server 22 includes multiple intermediary servers. In another refinement, intermediary server 22 operates as cloud server 40. In another refinement, cloud server 40 operates as intermediary server 22. In another refinement, both cloud server 40 and intermediary server 22 are utilized in animal data-based collateral and digital currency consideration system 10. In another refinement, at least one cloud server 40 or intermediary server 22 is utilized in animal data-based collateral and digital currency consideration system 10. In another refinement, cloud server 40 includes a plurality of cloud servers 40, and vice versa (e.g., in FIG. 1, multiple cloud servers 40 can be a single cloud server 40).

Still referring to FIG. 1, one or more intermediary servers 22 or cloud servers 40 receive and collect animal data 14 from one or more sensors 18, one or more computing devices 20, or a combination thereof. Collected animal data 14 can include attached thereto individualized metadata, which may include one or more characteristics related to the animal data, including characteristics related to the one or more sensors, (e.g., sensor type, sensing type, sensor model, firmware information, sensor positioning on or related to a subject, operating parameters, sensor properties, sampling rate, mode of operation, data range, gain, etc.), characteristics of the one or more targeted individuals, origination of the animal data, type of animal data, source computing device of the animal data, data format, algorithms used to derive the one or more readings, any actions taken on the data (e.g., cleaning, processing de-noising), quality of the animal data, speed at which the animal data is provided, and the like. Metadata can also be attached to or associated with the animal data after it is collected. Metadata can also include any set of data that describes and provides information about other data, including data that provides context for other data (e.g., the activity a targeted individual is engaged in while the animal data is collected, animal data to provide context for other animal data, such as the cadence at which a subject was pedaling their stationary bicycle for an acquirer who wants heart rate data for stationary-based cycling activities), rules/terms related to the data (e.g., how the data can be used, terms and conditions associated with the data, information related to previous agreements that highlight restrictions or uses related to the data), liens on any animal data (e.g., if uses or the value related to animal data are encumbered or restricted by other agreements), and the like. It can also include information such as how the animal data has been previously used, previous acquirers of the animal data, where and when the animal data has been previously sent, previous acquisition costs of (or related to) the animal data, previous value(s) of the animal data, and the like. In a refinement, metadata for animal data—particularly animal data that is part of reference data 21—can include the number of digital assets that are utilized as a form of digital currency (e.g., such as coins or tokens) that feature at least a portion of the animal data, monetary value information related to the animal data, the value of the one or more digital assets that feature at least a portion of the animal data, and the like. In a refinement, the metadata for animal data—particularly animal data that is part of reference data 21—can include the number of digital assets that are utilized as a form of digital currency (e.g., such as coins or tokens) that feature at least a portion of the animal data, monetary value information related to the animal data, the value of the one or more digital assets that feature at least a portion of the animal data, and the like.

Other animal data and information, including one or more attributes of one or more targeted individuals from which the animal data originated or other attributes related to the sensor or animal data, can be added to the metadata (e.g., included as part of the metadata) or associated with the animal data upon collection of the animal data, or at a later time (e.g., upon identification and/or verification of the one or more individuals). It can also be gathered by one or more programs operated by computing device 20, intermediary server 22, cloud 40, or another computing device in communication with computing device 20, intermediary server 22, or cloud 40 (e.g., computing device 25), with the gathered attributes being associated either directly or indirectly with the targeted individual. In a refinement, animal data 14, its associated metadata, and non-animal data either directly or indirectly associated with animal data 14 and/or its metadata can be gathered by computing device 25 via computing device 20, intermediary server 22, cloud 40, or another computing device in communication with computing device 20, intermediary server 22, or cloud 40.

In a refinement, computing device 20 can be operable to gather contextual data from one or more sensors, one or more programs operating via computing device 20 (e.g., if the contextual data is manually entered or gathered), one or more other computing devices which operate one or more programs that gather data, or a combination thereof. Contextual data can include any set of data that describes and provides information about other data, including data that provides context for other data (e.g., the activity or event that a targeted individual is engaged in while the animal data is collected, the outcome of the activity the targeted individual is engaged in, the one or more characteristics/attributes of the targeted individual, animal data that provides context for other animal data, and the like). Contextual data can also include the one or more variables that can affect the one or more animal data readings (e.g., cause one or more changes or variations in the animal data, including animal data, non-animal data, or a combination thereof), the one or more event outcomes, or a combination thereof. Contextual data can be animal data, non-animal data, or a combination thereof. In many variations, animal data 14 collected by computing device 20 can include or have attached thereto at least a portion of the contextual data as metadata, which may include one or more characteristics directly or indirectly related to the animal data, including characteristics related to the one or more sensors, (e.g., identity of the sensor, sensor type, sensor brand, sensing type, sensor model, firmware information, sensor positioning on or related to a subject, sensor operating parameters, sensor configurations, sensor properties, sampling rate, mode of operation, data range, gain, battery life, shelf life/number of times the sensor has been used, timestamps, and the like), characteristics/attributes of the one or more targeted individuals, origination of the animal data (e.g., event, activity, or situation in which the animal data was collected, duration of data collection period, quality of data, when the data was collected), type of animal data, source computing device of the animal data, location, data format, algorithms used, quality of the animal data, quality of data, size/volume/quantity of the data, latency information, speed at which the animal data is provided, environmental condition, bodily condition, and the like. Metadata can also be associated with the animal data after it is collected. Metadata can include non-animal data, animal data, or a combination thereof. Metadata can also include one or more characteristics/attributes directly or indirectly related to the one or more targeted individuals. Contextual data can be metadata associated with the animal data, the one or more targeted subjects, the one or more sensors, the one or more events associated with the one or more targeted subjects, or a combination thereof. In a refinement, contextual data is metadata associated with animal data. In another refinement, contextual data is inclusive of metadata associated with animal data. In another refinement, contextual data can be other information gathered that that provides context to the gathered animal data but not classified as metadata. In another refinement, contextual data is data derived from one or more Artificial Intelligence techniques that provides context to other data. Upon being collected by computing device 20 or a computing device in communication with computing device 20 (e.g., cloud server 40), contextual data can be included in the reference animal database associated with the animal data it is providing context to.

In a variation, the system can be configured to create, modify, or enhance one or more tags based upon the metadata associated with or the contextual data related to (if different) the animal data (e.g., including contextual information and other metadata), the one or more targeted subjects, the one or more sensors, the one or more events associated with the one or more targeted subjects, or a combination thereof. Tags (e.g., including classifications or groups that a targeted subject can be assigned to such as basketball team, individuals with a specific type of disease or blood type, and the like, or classifications or groups that medical conditions associated with the targeted individual can be assigned to) can be identifiers for data, can support the indexing and search process for one or more computing devices or data acquirers (e.g., tags can simplify the search process as one or more searchable tags), can support the monetary valuation process for one or more data sets, and can be based on data collection processes, practices, quality, or associations, as well as targeted individual characteristics. A characteristic may include specific personal attributes or characteristics of the one or more subjects or groups of subjects from which the animal data is derived (e.g., name, weight, height, corresponding identification or reference number, medical history, personal history, health history, medical condition, biological response, and the like), as well as information related to the animal data, its associated metadata, and the one or more sources of the animal data such as sensor type, sensor model, sensor brand, firmware information, sensor positioning, timestamps, sensor properties, classifications, specific sensor configurations, operating parameters (e.g., sampling rate, mode, gain, sensing type), mode of operation, data range, location, data format, type of data, algorithms used, quality of the data, size/volume/quantity of the data, analytics applied to the animal data, data value (e.g., actual, perceived, future, expected), when the data was collected, associated organization, associated activity, associated event (e.g., simulated, real world), latency information (e.g., speed at which the data is provided), environmental condition (e.g. if the data was collected in a dangerous condition/environment, rare or desired condition/environment, and the like), bodily condition (e.g., if a person has stage 4 pancreatic cancer or other bodily condition), context (e.g., data includes a monumental moment/occasion, such as achievement of a threshold or milestone within the data collection period may make the data more valuable; time of day in which the data set is collected), duration of data collection period, quality of data (e.g., a rating or other indices applied to the data, completeness of a data set, noise levels within a data set, data format), missing data, monetary considerations (e.g., cost to create or acquire, clean, and/or structure the animal data; value assigned to the data), non-monetary considerations (e.g., how much effort and time it took to create or acquire the data), and the like. It should be appreciated that any single characteristic related to animal data (e.g., including any characteristic related to the data, the one or more sensors, the metadata, the one or more targeted subjects, the one or more medical conditions, the one or more biological responses, and the like) can be assigned or associated with one or more tags as contextual data. Characteristically, the one or more tags associated with the animal data can contribute to creating, modifying, or enhancing an associated value (e.g., monetary, non-monetary) for the animal data. In a refinement, one or more Artificial Intelligence techniques (e.g., Machine Learning, one or more neural networks, Statistical Learning) are utilized to assign, create, modify, remove, or a combination thereof, one or more tags related to the animal data (e.g., including its metadata), the one or more targeted subjects, the one or more source sensors, the one or more events associated with the one or more targeted subjects, or a combination thereof. In another refinement, the one or more computing devices verify the one or more tags associated with the targeted individual, the one or more source sensors, the animal data (e.g., including its metadata), the one or more events associated with the one or more targeted subjects, or a combination thereof. In another refinement, one or more tags are created, modified, or enhanced for reference animal data based upon reference contextual data.

Examples of contextual data derived from or related to a targeted individual's one or more characteristics/attributes can include but are not limited to, name, age, weight, height, birth date, race, eye color, skin color, hair color (if any), country of origin, country of birth (if different), area of origin, ethnicity, current residence, addresses, phone number, reference identification (e.g., social security number, national ID number, digital identification), gender of the targeted individual from which the animal data originated, data quality assessment, and the like. In a refinement, the targeted individual's characteristics/attributes can also include information (e.g., animal data) gathered from medication history, medical history, medical records, health records, genetic-derived data, genomic-derived data, (e.g., including information related to one or more medical conditions, traits, health risks, inherited conditions, drug responses, DNA sequences, protein sequences, and structures), biological fluid-derived data (e.g., blood type), drug/prescription records, allergies, family history, health history (including mental health history), manually-inputted personal data, physical shape (e.g. body shape), historical personal data, training regimen, nutritional history/nutrition regime such as what foods are ingested and timing/quantity of ingestion, and the like. The targeted individual's one or more attributes can also include one or more activities the targeted individual is engaged in while the animal data is collected, one or more associated groups (e.g., if the individual is part of a sports team, or assigned to a classification based on one or more medical conditions), one or more habits (e.g., tobacco use, alcohol consumption, exercise habits, nutritional diet, the like), education records, criminal records, financial information (e.g., bank records, such as bank account instructions, checking account numbers, savings account numbers, credit score, net worth, transactional data), social data (e.g., social media accounts, social media history, records, internet search data, social media profiles, metaverse profiles, metaverse activities/history), employment history, marital history, relatives or kin history (in the case the targeted subject has one or more children parents, siblings, and the like), relatives or kin medical history, relatives or kin health history, manually inputted personal data (e.g., one or more locations where a targeted individual has lived, emotional feelings, mental health data, preferences), historical personal data, and/or any other individual-generated data (e.g., including data about or related to the individual). In a refinement, one or more characteristics/attributes associated with another one or more subjects can be associated with one or more targeted individuals as metadata. For example, in the event the targeted individual has children, the subject's (i.e., child's) health condition can be associated with the one or more targeted individuals as a characteristic associated with the one or more targeted individuals' data (e.g., if the child is sick, the parent can be under considerable stress or have deteriorating mental health which may impact their animal data). In another example, the one or more characteristics/attributes of the targeted individual's avatar or representation in a virtual environment, video game, or other simulation (e.g., including their actions, experiences, conditions, preferences, habits, and the like) can be associated with the targeted individual as metadata and can be included as part of the targeted individual's animal data. In another refinement, animal data is inclusive of the targeted individual's one or more characteristics/attributes (i.e., the one or more characteristics/attributes can be categorized as animal data). In another refinement, at least a portion of gathered data can be classified as both animal data and metadata. In another refinement, the system may associate metadata with one or more types of animal data prior to its collection (e.g., the system may collect one or more attributes related to the targeted individual prior to the system collecting animal data and associate the one or more attributes in the targeted individual's profile to the one or more types of animal data prior to its collection).

Examples of contextual data in the context of a sporting event can also include, but are not limited to, event data such as traditional sports statistics collected during an event (e.g., any given outcome data, including game score, set score, match score, individual quarter score, halftime score, final score, points, rebounds, assists, shots, goals, pass accuracy, touchdowns, minutes played, and other similar traditional statistics), in-game data (e.g., whether the player is on-court vs off-court, whether the player is playing offense vs defense, whether the player has the ball vs not having the ball, the player's location on the court/field at any given time, specific on-court/field movements at any given time, who the player is guarding on defense, who is guarding the player on offense, ball speed, ball location, exit velocity, spin rate, launch angle), streaks (e.g., consecutive points won vs lost; consecutive matches won vs lost; consecutive shots made vs missed), competition (e.g., men, women, other), round of competition (e.g., quarterfinal, finals), matchup (e.g., player A vs. player B; team A vs team B), opponent information, type of event (e.g., exhibition vs real competition), date, time, location (e.g., specific court, arena, field, and the like), crowd size, crowd noise levels, prize money amount, number of years associated with the event (e.g., number of years a player has been playing within a specific league or with a specific team), ranking or standing/seeding, the type of sport, level of sport (professional vs amateur), career statistics (e.g., in the case of individual athletes in racquet sports as an example, number of: tournaments played, titles, matches played, matches won, matches lost, games played, games won, games lost, sets, sets won, sets lost, points played, points won, points lost, retirements, and the like), points won vs. points played, games (e.g., sets) won vs. games played, matches won vs. matches played, any given round rate (e.g., finals win/loss rate or semi-finals win/loss rate; number of times a player makes any given round in any given tournament (e.g., number of times a player makes the semifinals in any given tournament, which may on a yearly or career basis), title win rate (e.g., how many times the player has won this year or any given year or over a career; how many times a player has won that particular tournament), match retirement history, court surface (e.g., hard court vs clay court), and the like. Contextual data can also include information such as historical animal data/reference animal data (e.g., outcomes that happened which are cross referenced with what was happening with the athlete's body and factors surrounding it such as their heart rate and HRV data, body temperature data, distance covered/run data for a given point/game/match, positional data, biological fluid readings, hydration levels, muscle fatigue data, respiration rate data, any relevant baseline data, an athlete's biological data sets against any given team, who the player guarded in any given game, who guarded the player in any given game, the player's biological readings guarding any given player, the player's biological readings being guarded by any given player, minutes played, court/ground surface, the player's biological readings playing against any given offense or defense, minutes played, on-court locations and movements for any given game, other in-game data), comparative data to similar and dissimilar players in similar and dissimilar situations (e.g., other player stats when guarding or being guarded by a specific player, playing against a specific team) injury data (e.g., including injury history), recovery data (e.g., sleep data, rehabilitation data), training data (e.g., how the player performed in training in the days or weeks leading up to a game), nutrition data, a player's self-assessment data (e.g., how they're feeling physically, mentally, or emotionally), nutritional data, mental health data, and the like. It can also include information such as country of origin, height, weight, dominant hand or handedness (e.g., right hand dominant vs left hand dominant), residence, equipment manufacturer, coach, race, nationality, habits, activities, genomic information, genetic information, medical history, family history, medication history, and the like. Contextual information can also be scenario-specific. For example, in the sport of tennis, contextual information can be related to when a player is winning 2-0 or 2-1 in sets or losing 1-2 or 0-2 in sets, or time of day the player is playing, or the specific weather conditions the game is played in. Contextual information can also be related to head-to-head match ups. In the sport of squash for example, head-to-head information can be related to the number of head-to-head matches, games, number of times a player has been in a specific scenario vs the other player (e.g., in terms of game score: 3-0, 3-1, 3-2, 2-3, 1-3, 0-3, 2-0, 2-1, 1-2, 0-2, or retired). Contextual information can also include how that player has performed in that particular tournament (e.g., matches played, matches won, games played, games won/lost, sets played, sets won/lost, court time per match, total court time, previous scores and opponents, and the like). Characteristically, the system can be configured to evaluate a single type of data or a plurality of data (e.g., data types, data sets) simultaneously. For example, in the context of a sport like tennis, the system may evaluate multiple sources of data and data types simultaneously utilizing one or more Artificial Intelligence techniques such as sensor-based animal data readings (e.g., positional data, location data, distance run, physiological data readings, biological fluid data readings, biomechanical movement data), non-animal data sensor data (e.g., humidity, elevation, and temperature for current conditions; humidity, elevation, and temperature for previous match conditions), length of points, player positioning on court, opponent, opponent's performance in specific environmental conditions, winning percentage against opponent, winning % against opponent in similar environmental conditions, current match statistics, historical match statistics based on performance trends in the match, head-to-head win/loss ratio, previous win/loss record, ranking, a player's performance in the tournament in previous years, a player's performance on court surface (e.g., grass, hard court, clay), length of a player's previous matches, current match status of a tennis player (e.g., athlete A is in Game 3 of Set 1 and is losing 5-2) and their historical data in the context of the current match status (e.g., all of athlete A match results when athlete A is in Game 3 of Set 1 and is losing 5-2, first serve percentage in second sets after playing n number of minutes, unforced errors percentage on the backhand side after hitting three n topspin backhands), and the like, which can occur in conjunction with contextual data such as video data (e.g., one or more optical cameras generating one or more video feeds of the event which feature the one or more individuals) and other information (e.g., contextual data such as timing & scoring data and other statistical information). In a refinement, any contextual data related to an event (either directly or indirectly) can be categorized as event data for (or associated with) the event. In another refinement, contextual data is inclusive of event data. In another refinement, event data is comprised of any contextual data associated either directly or indirectly with the event. In another refinement, event data includes at least a portion of contextual data.

It should be appreciated that such examples of contextual data, including contextual data in the context of a sports competition/event, are merely exemplary and not exhaustive, and similar types of information can be collected for all sports and events. In the context of non-sporting events, similar types of contextual data and methodologies can be utilized. In another refinement, contextual data in the context of non-sports related events can also include outcome-related information that may or may not provide context to other data.

It should also be appreciated that the animal data, various elements of the animal data, or its one or more derivatives (e.g., including collateral assets or digital assets) can be anonymized or de-identified (e.g., pseudonymized) by the system. De-identification involves the removal or alteration of personal identifying information in order to protect personal privacy. In the context of the present invention, a reference to one of the terms (i.e., anonymized or de-identified) should include reference to both terms and similar terms (e.g., semi-anonymized, partially-anonymized) where applicable, and a reference to one of the terms should not be interpreted as limiting but rather as encompassing all possible meanings of the terms where applicable.

Still referring to FIG. 1, one or more individuals 191 are the one or more subjects from which at least a portion of reference data 21 (e.g., reference animal data) corresponds with. One or more individuals 191 can include one or more targeted individuals 161, as well as other individuals with associated animal data. Reference data 21 can be any reference data that is directly or indirectly related to one or more individuals 19ⁱ and their corresponding animal data 14 (e.g., including the value or pricing information of or related to their animal data). Reference data can include any collected animal data 14, any other animal data and non-animal data, as well as any associated contextual data (e.g., metadata), which may be animal data, non-animal data, or a combination thereof. In a refinement, the totality of the reference data comprises a reference database. In many variations, data from the one or more individuals 19ⁱ comprise at least a portion of the reference database from which one or more monetary values of the data or its one or more derivatives (e.g., digital asset, collateral asset) will be determined, at least in part. In other variations, the system may utilize a combination of information derived from the reference database and one or more Artificial Intelligence techniques to identify, create, modify, verify, and/or validate one or more monetary values for at least a portion the targeted individual's animal data, its associated metadata, and/or its one or more derivatives. In the case of populating the reference database, computing device 25 can gather reference data from a variety of sources, including sensors and other computing devices (e.g., via any number of communication mechanisms including one or more application programming interfaces). For example, once animal data 14 is collected (or accessed) and identified and/or verified by the system as being derived from (or associated with) an individual, animal data 14 derived—and its associated metadata—can become reference data 21. In a variation, animal data 14 from one or more individuals 16 and one or more sensors 18 can be collected by one or more computing devices 20, intermediary servers 22, or clouds 40 and provided to one or more computing devices 25 as reference data 21 once the animal data is associated with the one or more individuals 16. Reference animal data 21 can also include other data related to one or more individuals 19ⁱ (e.g., contextual data) provided by one or more computing devices (e.g., computing device 20, intermediary server 22, cloud 40, another computing device).

Reference data 21 can be gathered (e.g., inputted, imported, collected) from one or more individuals 19ⁱ by one or more computing devices 25. One or more computing devices 25 can be the one or more computing devices from which the reference data 21 is gathered, stored, transformed, or made available (e.g., distributed). One or more computing devices 25 can also gather animal data 14 in order for one or more calculations, computations, derivations, extractions, extrapolations, simulations, creations, enhancements, estimations, evaluations, inferences, establishments, determinations, conversions, deductions, observations, identifications, evaluations, verifications, validations, creations, modifications, assignments, or a combination thereof, to occur using at least a portion of reference data 21. One or more computing devices 25 can operate as a separate one or more computing devices with different functionalities as one or more computing devices 20, clouds 40, or intermediary servers 22, or it can operate as separate computing device with one or more shared functionalities as one or more computing devices 20, clouds 40, or intermediary servers 22. In a refinement, the one or more computing devices 25 can operate as part of one or more computing devices 20, clouds 40, or intermediary servers 22 (e.g., extensions of each computing device, such that computing device 25 can be another computing device operating as part of intermediary server 22). In another refinement, the one or more computing devices 25 are one or more computing devices 20, clouds 40, or intermediary servers 22. In another refinement, intermediary server 22 takes on one or more actions of computing device 25. In another refinement, cloud server 40 takes on one or more actions of computing device 25. In another refinement, computing device 20 takes on one or more actions of computing device 25. In another refinement, computing device 20, intermediary server 22, cloud 40, or a combination thereof, operate as computing device 25.

The gathered reference data 21 can be derived from one or more sensors 18 and/or gathered by one or more computing device 25 via one or more other computing devices (e.g., one or more computing devices 20, clouds 40, or intermediary servers 22, or other computing devices that provide access to animal data or other data associated with animal data). Reference animal data 21 can be accessed by a single computing device or multiple computing devices. In a refinement, one or more computing devices 20, intermediary servers 22, and/or clouds 40 can access reference animal data 21 in order to evaluate, verify, and/or validate the animal data, generate one or more terms associated with the use of the animal data as collateral or as a digital currency for consideration (e.g., the one or more terms can be legal terms or legal language generated by a computing device operating on behalf of or in conjunction with the data acquirer; in some variations, the one or more terms can be preferences established by the data acquirer, the data owner, or a combination thereof), generate (e.g., create, modify) one or more monetary values associated with the animal data (e.g., including its associated terms, if applicable), verify and/or validate one or more monetary values associated with the animal data (e.g., assigned to animal data), or a combination thereof. In another refinement, the reference data gathered from one or more sensors, computing devices (e.g., including other external systems), or a combination thereof has attached metadata that enables the reference data to be associated with one or more subjects, sensors, events, medical or health conditions, data characteristics, monetary values, associated digital assets (e.g., coins/or tokens that feature the animal data), or other contextual data that can be used as one or more searchable parameters (e.g., via one or more tags) by an acquirer of data or the provider of data for consideration.

In a variation, reference animal data 21 can be gathered by one or more computing devices 25 from one or more other computing devices, one or more sensors, or a combination thereof. Reference animal data 21 can be gathered, stored, and/or made available by a single computing device 25 or across multiple computing devices 25. In some variations, the one or more computing devices that gather reference animal data 21 may be different from the one or more computing devices that store the reference animal data or make available the reference animal data (e.g., to create, modify, or enhance the at least one evaluation asset). In other variations, the one or more computing devices that gather the reference animal data 21 may be same as the one or more computing devices that store and make available the reference animal data.

Computing device 25 can include evaluation, verification, and validation engine 50, pricing engine 52, and terms engine 54. The one or more engines can include one or more Artificial Intelligence or statistical-based models that enable the system to identify the one or more targeted individuals, make one or more evaluations related to the targeted individual and/or their animal data being utilized as collateral or as a digital currency for consideration (e.g., including identifying complimentary data sets—which may include animal data and/or non-animal data—that can increase the value of the animal data, which may be contextual data; evaluating the utility of the digital asset that features the animal data), verify the animal data (e.g., verify the origin of the data; verify the terms such as the rights associated with or conditions imposed upon the animal data based upon one or more previous agreements; verify the metadata associated with the animal data is in fact correctly associated; and the like), validate the animal data (e.g., validate the usefulness of the data—including the associated metadata—in conjunction with other data sets; validate its value to other acquirers; validate its value as data for one or more AI-based modeling to examine one or more outcomes; and the like), create or modify one or more monetary values for the animal data (e.g., based upon the one or more evaluations, verifications, and validations, as well as the one or more preferences selected by the targeted individual or data owner, the stakeholder such as a company providing a loan by using the animal data as collateral or the individual or entity acquiring a digital asset that incorporates the animal data in exchange for consideration; validate or verify the monetary value associated with the digital asset that incorporates the animal data; and the like), assign one or more terms to the animal data being utilized as collateral or as a digital asset based upon the one or more outputs from engine 50 and 52, or combinations thereof. Characteristically, each of the one or more engines can be configured to ingest information (e.g., the terms engine can be configured to collect/receive information related to one or more preferences from the targeted individual or data acquirer; the pricing engine can be configured to collect/receive information related to pricing preferences from the targeted individual or data acquirer, or receive information from another engine to create or modify and assign the appropriate value for the animal data; the evaluation, verification, and validation engine can ingest information related to what animal data being evaluated, which can be provided by one or more users such as the targeted individual or the data acquirer; and the like). All or a subset of the one or more engines can be configured to communicate with each other in order to provide relevant information that enables each of the engines to perform its task. For example, in some variations, terms engine 54 and evaluation, verification, and validation engine 50 communicate the one or more terms and the output(s) of the one or more evaluations, verifications, and validations to pricing engine 52 to enable pricing engine 52 to create or modify and assign one or more monetary values to the animal data or its one or more derivatives (e.g., collateral or digital asset) based upon the information provided. In a refinement, each of the one or more engines can be accessed via one or more displays. For example, the evaluation, verification, and validation engine may be accessed via a display for a user to input what animal data and associated metadata is being evaluated; the terms engine may be accessed via a display to provide the one or more preferences; and the pricing engine may be accessed via a display to provide one or more inputs related to creation or modification of one or more values. Characteristically, the sequential series (e.g., order) in which the animal data or its one or more derivatives are used by the one or more engines to create or modify a collateral or digital asset can vary. For example, in some variations one or more terms may be assigned to the animal data or its derivative (e.g., the collateral or digital asset) prior to one or more monetary values being created or modified and assigned.

In another refinement, terms engine 54 is operable to enable the targeted individual/data owner, the stakeholder, computing device, or a combination thereof, to create (e.g., select) and assign one or more terms related to the use of the animal data. In this instance, multiple terms engines can exist (e.g., one terms engine to enable a targeted individual to select preferences related to their animal data, which may be housed via cloud server 40, which can be accessed by a user via computing device 20; and other terms engine via computing device 25 which stores the one or more terms of the data acquirer, which may be legal boilerplate language or other terms and conditions established by the data acquirer). In some variations, terms for both the targeted individual and acquirer may be implemented by the same terms engine 54, which may be implemented across one or more computing devices). The selection of the one or more terms informs pricing engine 52 of the one or more selections, enabling pricing engine 52 to create a new monetary value for the selected animal data set, or modify an existing value for the selected animal data set. The one or more engines may be housed and/or operated via intermediary server 22, cloud server 40, computing device 25, or a combination thereof. Characteristically, the pricing engine can incorporate information derived from one or more data acquirers (e.g., pricing preferences established by a data acquirer), information derived from reference data (e.g., previous monetary values assigned to animal data based upon the contextual data and other metadata that can provide a baseline for determining current and future value for other similar and dissimilar animal data), information derived from the targeted individual or data owner (e.g., in the event the system offers the targeted individual to input one or more minimum monetary values for their data), or a combination thereof. In some variations, the pricing engine can gather real-time or near-real time inputs to create real-time or near real-time outputs.

In a refinement, the system operates pricing engine 52 which creates or modifies and assigns the one or more monetary values, or modifies the one or more assigned monetary values, for the animal data or its one or more derivatives (e.g., collateral asset 27, digital asset 29). In another refinement, pricing engine 52 can create or modify and assign one or more values (e.g., monetary values, non-monetary values) for one or more derivatives of the animal data. For example, pricing engine 52 may create or modify and assign one or more monetary values to one or more collateral assets or digital assets. The one or more collateral assets or digital assets can include the animal data and its associated metadata, including the one or more terms. Pricing engine 52 can use one or more pricing models to derive (e.g., create, modify) the one or more values (e.g., monetary values, non-monetary values) for the collateral or digital asset. In a variation, the one or more collateral assets or digital assets can be utilized as one or more instruments that represent one or more rights (e.g., ownership, license) to the animal data and its associated metadata based upon the one or more terms. In this variation, the animal data and its associated metadata may or may not be included as part of the asset (e.g., while the asset may include a description of the animal data and the one or terms associated with the animal data that is being used as a collateral or digital asset, it may not include the animal data itself or only included in part). In another refinement, pricing engine 52 can create or modify and assign one or more monetary or non-monetary values dynamically for the animal data (e.g., including its associated metadata) or its one or more derivatives based upon new data (e.g., animal data) and/or information gathered by the system. For example, the system can create a new value for a digital asset dynamically as new animal data is gathered from the targeted individual and grouped as part of the digital asset (which may comprise a new digital asset). In another example, new information gathered or derived by the system—such as the value of other similar or dissimilar digital assets being acquired by data acquirers—can dynamically modify the value assigned by the system (e.g., assigned price) to the digital asset. In another refinement, pricing engine 52 can be characterized as value creation and assignment engine 52 (creating and assigning both monetary and non-monetary values to the animal data (e.g., including its one or more derivatives).

In a refinement, terms engine 54 is operable to enable an administrator to select and associate one or more terms across a one or more user profiles (e.g., which includes one or more terms associated with the user animal data sets, user collateral or digital assets, and the like). The administrator's implementation of one or more terms can be in conjunction with one or more terms established by the targeted individual. For example, the administrator may want one or more terms attached to all user profiles (e.g., attached to all animal data sets or all derivatives including one or more collateral or digital assets) to enable one or more uses of animal data across all individuals and only allow for a subset of preferences to be selectable (e.g., opt in or opt out mechanics) for the animal data by a targeted individual. In another refinement, the system is operable to enable multiple users or administrators to select and associate one or more terms for the same animal data or its one or more derivatives. In another refinement, the creation or modification of the collateral or digital asset is based upon the one or more inputs of the one or more data acquirers (e.g., inputs such as terms to buy or license the animal data). The one or more inputs by the one or more data acquirers induces the system to create or modify the one or more collateral or digital assets.

Characteristically, the system enables different levels of permissions and preferences (e.g. including sub-levels) for any given animal data set (e.g., including the one or more collateral or digital assets derived from it) and any given user. For example, the system can be configured to enable a n-tier permissions and preferences system (e.g., which can include preference, permissions, conditions, rights, restrictions, and the like) where at each level an administrator or user with a higher level of permissioning (as enabled by the system, such as a super user) can set permissions and preferences that are used as a default and optionally overridden by users down the chain. In a variation, the system can be configured to enable an administration function that allows for an administrator to select/input system-wide defaults for the one or more preferences for the animal data associated with the one or more targeted individuals (e.g., including groups of users). In some variations, the one or more default preferences can be overridden by the one or more targeted individuals. In other variations, the one or more default preferences cannot be overridden by the one or more targeted individuals. For example, a sports league or healthcare organization (e.g., which may be at the highest level) may want to set standard of terms across all animal data and all users (e.g., athletes, patients) while enabling the users (e.g., a second or sub-level) to select preferences for a subset of the terms. In another example, an organization in a hierarchal structure (e.g., national organization vs state/local organization) may want to enable their sub-organizations only a subset of selectable permissioning/preferences. In another example, a family may want their family's animal data to comprise a single digital asset or for each family member to have their own digital asset (e.g., a plurality of digital assets) within a single digital asset. In this example, the one or more parents can have control to set the one or more terms associated with the digital asset(s) for their children.

In one variation, intermediary server 22 can be operable to transform the at least a portion of the animal data and its associated metadata into collateral asset 27 or digital asset 29 (e.g., digital coins, tokens, or other type of consideration medium). In another variation, computing device 25 can be operable to transform the at least a portion of the animal data and its associated metadata into collateral asset 27 or digital asset 29. In a refinement, based upon the one or more outputs from evaluation, verification, and validation engine 50 (e.g., completed evaluation, verification, and validation by the system of the animal data), pricing engine 52 (e.g., creation or modification of one or more monetary values associated with the animal data), terms engine 54 (creation or modification of one or more terms associated with the animal data), or a combination thereof, intermediary server 22 or computing device 25 transforms the at least a portion of the animal data and the associated metadata into collateral asset 27 or digital asset 29. In another refinement, intermediary server 22, computing device 25, or a combination thereof, are operable to generate (e.g., create, modify) the one or more collateral assets 27 or digital assets 29 based upon the animal data, its associated metadata, and its associated one or more terms to acquire consideration. In another refinement, the animal data, its associated metadata, and the one or more terms are transformed into collateral asset 27 or digital asset 29 by intermediary server 22, computing device 25, or other computing device in communication with (either directly or indirectly) intermediary server 22. In another refinement, the act of evaluating, verifying, and validating the animal data, creating or modifying and assigning one or more monetary values to the animal data, generating terms associated with the animal data, and transforming the animal data and its associated metadata into a collateral or digital asset occurs across two or more computing devices.

In a refinement, collateral asset 27 or digital asset 29 can be modified after the collateral asset or digital asset has been created. For example, metadata may be modified (e.g., enhanced) and assigned to the collateral asset after the collateral asset has been created (e.g., one or more new terms may be assigned to the collateral asset after the collateral asset has been created or existing terms may be modified; new contextual data may be added as metadata; one or more monetary values may be modified after the collateral asset has been created and an initial monetary value had been assigned based upon the creation of new terms or modification of existing terms or new metadata being added; and the like).

In a refinement, the one or more terms generated by the intermediary server via terms engine 54 include one or more preferences (e.g., rights, conditions, permissions, restrictions) related to the use of the animal data created either directly or indirectly the targeted individual or the data acquirer. For example, the one or more preferences may be directly established by the targeted individual or data acquirer, via an intermediary (e.g., lawyer of the data acquirer), via one or more Artificial Intelligence techniques (e.g., preferences are inferred based upon a selection of one or more other preferences established by the targeted individual or data owner), and the like. In a refinement, the one or more preferences are included as part of the metadata associated with the animal data as one or more terms associated with the acquisition of the animal data or its one or more derivatives. The one or more types of preferences can be a tunable parameter. The one or more terms are then associated with the collateral asset or digital asset used as collateral or a digital currency for consideration. In some variations, the system can be configured to enable the data owner, the data acquirer, or both, to accept or reject all or a subset of the one or more preferences prior to an exchange of consideration. In another refinement, at least a portion of the targeted individual's animal data can be combined with one or more assets (e.g., other digital assets/products including other data, physical assets/products, and the like) to represent the collateral asset or digital asset.

Still referring to FIG. 1, at least one evaluation asset 23 is created, modified, or enhanced from reference data 21, animal data 14, or a combination thereof, via evaluation, verification, and validation engine 50, pricing engine 52, terms engine 54, or a combination thereof. The at least one evaluation asset 23 can be created, modified, or enhanced from reference data 21, animal data 14, or a combination thereof, by one or more computing devices 25. One or more computing devices 25 are operable to create, modify, or enhance the at least one evaluation asset 23 from one or more calculations, computations, derivations, extractions, extrapolations, simulations, creations, modifications, enhancements, estimations, evaluations, inferences, establishments, determinations, conversions, deductions, observations, identifications, evaluations, verifications, validations, creations, modifications, or a combination thereof, that enable the identification of one or more characteristics related to the animal data 14 being leveraged as collateral or as a digital currency for consideration—including characteristics related to the one or more sensors, individuals, and the like—that provide information in order to put a monetary value on the animal data. In a refinement, one or more computing devices 20, intermediary servers 22, and/or clouds 40 can access reference animal data 21 in order to create, modify, or enhance one or more evaluation assets.

In a refinement, the at least one evaluation asset 23 is created, modified, or enhanced from reference data 21, animal data 14, or a combination thereof, via computing device 25. In another refinement, the at least one evaluation asset 23 is created, modified, or enhanced from reference data 21, animal data 14, or a combination thereof, on two or more computing devices. In another refinement, the at least one evaluation asset 23 is created, modified, or enhanced, at least in part, via one or more sensors (e.g., one or more unmanned aerial vehicles or other computing apparatus with one or more sensors integrated or attached and computing capabilities to create, modify, or enhance the at least one evaluation asset). In another refinement, one or more evaluation assets 23 are included as part of reference data 21. In a variation, the one or more evaluation assets 23 included as part of reference data 21 can be modified, enhanced, or removed by the system. In another refinement, the one or more computing devices 25 take one or more of the following actions on the collected reference data 21, animal data 14, or a combination thereof, to transform data into at least one evaluation asset 23 by any combination of: normalize, timestamp, aggregate, tag, store, manipulate, denoise, process, enhance, organize, visualize, simulate, anonymize, synthesize, summarize, replicate, productize, compare, price, or synchronize the data. This features also represent improvements to raw or manipulated collected data.

In another refinement, the at least one evaluation asset 23 can be created, modified, or enhanced from reference data 21, animal data 14, or a combination thereof, by one or more computing devices 20, intermediary servers 22, or clouds 40 via one or more calculations, computations, derivations, extractions, extrapolations, simulations, creations, modifications, enhancements, estimations, evaluations, inferences, establishments, determinations, conversions, deductions, observations, identifications, evaluations, verifications, validations, creations, modifications, or a combination thereof. In a refinement, the at least one evaluation asset 23 can be created, modified, or enhanced from reference data 21, animal data 14, or a combination thereof, via one or more sensors. In a refinement, the at least one evaluation asset 23 is created, modified, or enhanced from reference data 21, animal data 14, or a combination thereof, on via one or more computing devices (e.g., computing device 20, cloud 40, intermediary server 22). In another refinement, the at least one evaluation asset 23 is created, modified, or enhanced from reference data 21, animal data 14, or a combination thereof, on two or more computing devices. In another refinement, the at least one evaluation asset 23 is created, modified, or enhanced using at least a portion of animal data 14 and reference data 21. In another refinement, the one or more computing devices (e.g., intermediary server 22, computing device 25, cloud 40, computing device 20, other computing devices, or combinations thereof) take one or more of the following actions on the collected animal data 14 to transform the data into at least one evaluation asset 23: normalize, timestamp, aggregate, tag, store, manipulate, denoise, process, enhance, organize, visualize, simulate, anonymize, synthesize, summarize, replicate, productize, compare, price, or synchronize the data.

Still referring to FIG. 1, one or more intermediary servers 22, cloud servers 40, or a combination thereof can communicate either directly or indirectly with one or more third-party computing devices 42 via one or more communication links 44. Third-party computing device 42 can be any computing device (e.g., which includes systems/programs operating on that computing device) that is operable to receive consideration from intermediary server 22 as part of a transaction that provides animal data as collateral or as a form of digital currency. Animal data or its one or more derivatives (e.g., a digital asset that represents the animal data or rights to the animal data such as a token or coin) may be provided to intermediary server 22 by computing device 20, cloud server 40, third party computing device 42, or other computing device. Third-party computing device 42 may be a banking system or have an application in communication with a banking or finance system to receive such consideration (e.g., including forms of a digital wallet). In a refinement, third-party computing system may be computing device 20 (e.g., the targeted individual is able to provide their animal data to intermediary server 22, select one or more preferences, agree to one or more terms, and receive consideration in exchange for using the animal data as collateral from computing device 20).

Still referring to FIG. 1, computing device 20 can gather animal data 14 from source 12 either wirelessly, via one or more wired connections, or a combination thereof. Computing device 20 may also include a transmission subsystem that includes one or more hardware and software components that enable electronic communication with one or more sources 12 of animal data 14. In this regard, computing device 20 receives and collects the animal data 14 through the transmission subsystem. Typically, the transmission subsystem includes a transmitter and a receiver, or a combination thereof (e.g., transceiver). The transmission subsystem can include one or more receivers, transmitters and/or transceivers having a single antenna or multiple antennas (e.g., which can be configured as part of a mesh network). In some variations, the transmission subsystem can include one or more receivers, transmitters, transceivers, and/or supporting components (e.g., dongle) that utilize a single antenna or multiple antennas, which may be configured as part of a mesh network and/or utilized as part of an antenna array. The transmission subsystem and/or its one or more components may be housed within the one or more computing devices or may be external to the computing device (e.g., a dongle connected to the computing device which includes one or more hardware and/or software components that facilitates wireless communication and is part of the transmission subsystem). In a refinement, one or more components of the transmission subsystem and/or one or more of its components are integral to, or comprised within, the one or more sensors 18. Computing device 20 may also include one or more network connections, such as an internet connection or cellular network connection or local network connection, which may include hardware and software aspects, or pre-loaded hardware and software aspects that do not necessitate an internet connection. In a refinement, one or more sensors 18 or intermediary servers 22 operate as computing device 20. In a variation, the one or more users interact with one or more sensors 18 or intermediary servers 22 in replace of at least a portion of the functionality of computing device 20. In another refinement, one or more sensors 18 or intermediary servers 22 take on one or more functions or features of computing device 20. In another refinement, one or more sources 12 of animal data 14 transmits the animal data to a computing device (e.g., computing device 20, intermediary server 22, cloud 40) via the transmission subsystem. In another refinement, computing device 20 is operable to collect animal data from multiple sensors, which can occur simultaneously. In another refinement, one or more computing devices are operable to collect animal data (e.g., including reference animal data) from one or more other computing devices.

In a refinement, the system can be configured to enable two-way communication between a computing device (e.g., computing device 20) and the one or more sensors via one or more transmission protocols (e.g., the system can be configured to send commands to a sensor and receive information such as animal data from the same sensor). In another refinement, the system can be configured to enable a user or the system to transmit one or more commands to the one or more sensors (e.g., via computing device 20) in order to enable the usage of two or more transmission protocols (e.g., BLE and LoRa) to create a hybrid connectivity. For example, the system may need to provide collected animal data to multiple endpoints, some of which may be short distances away from the computing device and some of which may be long distances away from the computing device. In this scenario, the system and sensor may achieve optimal data transmission performance by combining the usage of two or more transmission protocols (e.g., BLE and LoRa) in order communicate with the system. In this example, BLE can be utilized to send large data files over shorter distances and LoRa can be utilized to send smaller data packets over longer distances. The usage of both transmission protocols by one or more sensors enables optimal data distribution to the computing subsystem in both short and long-distance scenarios. Characteristically, the system can be configured to determine the volume of data being sent, the type of data being sent, change one or more parameters related to the sensor (e.g., sampling rate) based upon the transmission protocol being used, and the like. For example, if the system determines that the sensor is communicating in close range with a computing device, it may utilize BLE-based transmission in order to send more data to the system. If the system determines that the sensor is communicating at a great range with a computing device, the system may change one or more sensor settings in order to reduce the amount of data being collected and/or sent, and change the transmission mechanism (e.g., from BLE to LoRa) in order to provide the data to the computing device. In another refinement, the system automatically selects the transmission protocol being utilized by evaluating at least one of or any combination of: data volume, data type, data requirements (e.g., by the receiving computing device), distance from sensor to the computing device, and the like.

In a variation, the transmission subsystem can communicate electronically with the one or more sensors 18 from the one or more targeted individuals 16 using one or more wired or wireless methods of communication via one or more communication links 34. In a variation, the transmission subsystem enables the one or more source sensors 18 to transmit data wirelessly via one or more transmission (e.g., communication) protocols. In this regard, animal data-based collateral and digital currency consideration system 10 can utilize any number of communication protocols and conventional wireless networks, including any combination thereof (e.g., BLE and LoRa to create hybrid connectivity for combined short and long-range communication), to communicate with one or more sensors 18 including, but not limited to, Bluetooth Low Energy (BLE), ZigBee, cellular networks, LoRa/LPWAN, NFC, ultra-wideband, Ant+, Wi-Fi, and the like. The present invention is not limited to any type of technology or electronic communication links (e.g., radio signals) the one or more sensors 18 or any other computing device utilized to transmit and/or receive signals. Advantageously, the transmission subsystem enables the one or more sensors 18 to transmit data wirelessly for real-time or near real-time communication. In this context, near real-time means that the transmission is not purposely delayed except for necessary processing by the sensor and any other computing device taking one or more actions on, with, or related to the data. In another variation, one or more apparatus with one or more onboarded computing devices (e.g., such as an aerial apparatus like an unmanned aerial vehicle, satellite, or other remote computing devices) may act as a transmission subsystem to collect and distribute biological data from one or more sensors capturing animal data from one or more targeted subjects or groups of targeted subjects. In a refinement, the one or more apparatus may have one or more sensors attached, or integrated, as part of the apparatus to collect animal data (e.g., camera which can initiate optical location tracking data). In another variation, computing device 20 can also gather animal data 14 from one or more source sensors 18 directly via a wired connection. In a refinement, the transmission subsystem can be comprised of multiple transmission subsystems.

Still referring to FIG. 1, computing device 20 (which in some variations can be intermediary server 22) includes an operating system that coordinates interactions between one or more types of hardware and software. Computing device 20 can include a display device that enables the user to take one or more actions within the display (e.g., touch-screen enabling an action; use of a scroll mouse that enables the user to navigate and make selections; voice-controlled action via a virtual assistant or other system that enables voice-controlled functionality; eye-tracking within spatial computing systems that enables an eye-controlled action; a neural control unit that enables one or more controls based upon brain waves; and the like). In a refinement, a gesture controller that enables limb (e.g., hand) or body movements to indicate an action can be utilized to take one or more actions. In another refinement, the display may act as an intermediary to communicate with another one or more computing devices to execute the one or more actions requested by the user.

Typically, a display device communicates information in visual form and allows for two-way communication (e.g., the display device can provide information to a user; the display enables a subject to take one or more actions via the display; the display device can provide an ability for the user to communicate information with the system, such as an ability for a user to provide one or more inputs to operate the program, provide requested information to the system, and the like). In some variations, a display device can communicate information to a user, and receive information from a user, utilizing one or more other mechanisms including via an audio or aural format (e.g., verbal communication of information), via a physical gesture (e.g., a physical vibration which provides information related to the one or more biological readings, a physical vibration which indicates when the data collection period is complete, or a physical gesture to induce a biological-based response from the individual's body can be captured as animal data via one or more sensors), or a combination thereof. In a refinement, the display may not include any visual component in its communication or receipt of information (e.g., as in the case of a smart speaker, hearables, or similar computing device that does not include any visual screen to interact with and is operable via a virtual or audio-based assistant to receive one or more commands and take one or more actions. In this example, the smart speaker or hearables can be in communication with another computing device to visualize information via another display if required). In some variations, the information communicated to a user may be animal data-based information such as the type of animal data (e.g., ability to select what animal data and associated information—e.g., attributes—the targeted individual wants to use as collateral for consideration, which can be based on one or more factors including by metric, by reading, by sensor, by activity, by time, by medical episode, by animal data type, by metadata, and the like), one or more fields for a user to make one or more selections (e.g., provide one or more inputs) related to the use of their animal data as collateral or as a digital currency for consideration, one or more terms and conditions related to the use of their animal data as collateral or as a digital currency for consideration, information related to the one or more evaluations, verifications and validations, information related to the one or more assigned monetary values, and the like. The one or more fields that enable one or more inputs may provide the system with one or more preferences of the targeted individual related to the consideration being received, the assigned monetary value to the animal data, the one or more uses of their animal data, or a combination thereof.

In a variation, a display device may include a plurality of display devices that comprise the display. In addition, a display that is not included as part of computing device 20 may be in communication with computing device 20 (e.g., attached or connected to, from which communication occurs either via wired communication or wirelessly). Furthermore, the display device may take one or more forms. Examples of where one or more types of animal data may be displayed include via one or more monitors (e.g., via a desktop or laptop computer, projector), holography-based computing devices, smartphones, tablet, a smartwatch or other wearables with an attached or associated display, smart speakers (e.g., including earbuds/hearables), smart contact lens, smart clothing, smart accessories (e.g., headband, wristband), or within a head-mountable unit (e.g., smart glasses or other eyewear/headwear including virtual reality/augmented reality headwear) where the animal data (e.g., computed asset, insight, predictive indicator, and the like) or other animal data-related information can be visualized or communicated. In a refinement, the display device can be operating or displaying the output of one or more programs that comprise, or are related to, a loan (e.g. lending, mortgage, credit)-based application system or digital currency-based system that enables one or more targeted individuals to receive consideration based upon using their animal data as collateral or as a form of digital currency for consideration, fitness system (e.g., a home fitness or gym application that enables users to use their animal data as collateral to receive consideration based upon one or more outcomes, with the animal data being at least a portion of the wager. For example, a home fitness application may provide a free class to the targeted individual for achieving a certain number of miles in a certain amount of time if the targeted individual uses at least a portion of their animal data as collateral, meaning if the targeted individual does not achieve the milestone, the application gets to retain a copy or one or more rights to their animal data), video gaming system, simulation system, health monitoring system, health passport system, animal data monetization system (e.g., including animal data marketplaces, systems for providing loans using animal data as collateral, at least in part, or as part of an animal data-based digital currency system or system that utilizes animal data as a form or currency to acquire or provide one or more products or services; auctions for animal data or other types of data; and the like), insurance system, sports wagering system, animal performance system (e.g., human performance optimization system), telehealth system, health analytics system, electronic medical records system, electronic health records system, risk analytics system (e.g., insurance, insurance underwriting, finance, security), pharmaceutical-based system (e.g., drug administration system), banking system, performance analytics system, health and wellness monitoring system (e.g., including systems to monitor viral infections), research system, security system (e.g., subject or sensor identification/verification/authentication for security purposes; system that identifies and/or verifies fraudulent behavior), military system, hospital system, emergency response system, financial system, relationship management system, social media system, simulation/video game system (e.g., virtual world, metaverse), media & entertainment system, and the like. In another refinement, the display may include one or more other media streams (e.g., live-stream video, digital objects). For example, a home fitness machine (e.g., cycling machine) may include an integrated display that enables both the visualization of media (e.g., video of a fitness instructor) along with the real-time animal data, or a computing device may be operating health monitoring program (e.g., telehealth application) which may include an integrated media module (e.g., real-time video of a doctor or medical professional with two-way voice video and communication) within the display alongside the real-time animal data being communicated (e.g., visualized) by the system, or a virtual environment may that includes a variety of digital objects may also incorporate animal data or animal data-based information in the virtual world, and the like. Additional details related to monetization systems and methods for animal data are disclosed in U.S. patent Ser. No. 16/977,454 filed Sep. 1, 2020; the entire disclosure of which are hereby incorporated by reference.

In a refinement, the system may include a data gathering application that enables the one or more targeted individuals to gather and store their animal data via one or more computing devices in a single location or multiple locations, which may be accessible via multiple computing devices. In some variations, the system may provide feedback (e.g., including real-time or near real-time feedback) to the one or more targeted individuals related to the value or estimated monetary value of the data being stored at any given time via the gathering application, which may be further segmented and provided on a time, metric, sensor, or conditional basis (e.g., value of only the heart rate data, or data just collected in the last year, or data collected with only specific sensors, or data collected when the targeted subject was diagnosed with a specific condition, or data with specified terms and conditions attached, or data with the existing associated liens). In another refinement, the targeted individual may select one or more variables to adjust the one or more monetary values, or select one or more preferences to associate with the animal data in order to receive a more accurate value or estimated monetary value. For example, the targeted individual may choose to not allow the system to sell their identifiable information in the event the targeted individual defaults on the loan, thereby potentially decreasing the value of the data if used as collateral for consideration.

In one variation, the system can be operable to automatically select at least a portion of the targeted individual's animal data and one or more terms (e.g., rules, conditions, permissions) based upon a target monetary value that is inputted or pre-determined. In another variation, the targeted individual (or administrator) or system can select the at the least a portion of the animal data and the one or more terms/rules associated with the animal data, upon which the system will create or modify and assign one or more monetary values.

In one embodiment, a system and method for gathering, evaluating, and transforming animal data for use as a digital asset (e.g., digital currency) or collateral in exchange for consideration (which alternatively can be described as a system and method for data structuring, packaging, and pricing) includes a source of animal data which can include one or more biological data sensors that gather animal data from a targeted individual wherein the source of animal data is transmitted electronically. Animal data in this context can include the one or more attributes related to the targeted subject (e.g., information derived from electronic health records, electronic medical records, genetic or genomic data, manually inputted information contextual data, and/or other information related to the targeted individual or their animal data), which may be included as metadata or may be separate data sets. Additionally, the source of animal data can include information derived from one or more computing devices (e.g., information on a computing device such as health records, medical records, manually-inputted information related to the targeted individual, gathered information related to the targeted individual, and other attributes) as well as reference data. The system can include an intermediary server or other computing device that gathers (e.g., receives, collects) at least a portion of the animal data from the source of animal data such that the animal data has metadata associated (e.g., attached) thereto, the metadata including at least one characteristic of the one or more biological data sensors and at least one characteristic of the targeted individual from which the animal data originated. In a refinement, the metadata includes contextual data (e.g., the context in which the animal data was gathered) related to the one or more biological data sensors, the targeted individual, or both. In another refinement, the metadata includes at least a portion of contextual data related to the at least one biological data sensor, the targeted individual from which the animal data originated, one or more outcomes (e.g., event outcomes related directly or indirectly related to the targeted individual), the one or more terms associated with the use of the animal data (e.g., as collateral asset or digital asset), or a combination thereof. In another refinement, the metadata includes at least a portion of contextual data related to the gathered animal data, reference data, or both. In another refinement, the metadata is not attached to the animal data but associated with the animal data. In another refinement, at least a portion of the metadata and animal data are gathered by the system concurrently (e.g., at the same time). In another refinement, at least a portion of the metadata and animal data are gathered at different times (e.g., the contextual data can be gathered by the system at a later time after the animal data is collected, with the system taking one or more actions with the metadata to evaluate, verify, and/or validate the contextual data prior to, or after, associating it with the animal data). In another refinement, the metadata can include animal data, non-animal data, or a combination thereof.

In some variations, the intermediary server can be in direct electronic communication with the source of animal data. It can also be in indirect communication via computing device 20, cloud 40, or another computing device. In a refinement, the source of animal data can include a plurality of sources. In some variations, the intermediary server can also gather at least a portion of non-animal data (e.g., from the source of animal data or from one or more other sources) either directly or indirectly related to the targeted individual or their animal data, as well as reference data (which can include both animal data and non-animal data). Upon gathering at least a portion of the animal data, the intermediary server can take one or more actions with the at least a portion of the animal data and the associated metadata, the one or more actions including one or more evaluations, verifications, validations, or a combination thereof, related to the targeted individual, their animal data being used as collateral asset or digital asset for consideration, and/or associated metadata. “Combination” can include all the elements or a subset of the elements. In a refinement, the intermediary servers gathers reference data and utilizes at least a portion of the reference data related to, derived from, or associated with, either directly or indirectly, the at least a portion of the animal data and the associated metadata to conduct the one or more evaluations, verifications, validations, or a combination thereof. In another refinement, the process of validation can include certify and/or authenticate. In another refinement, the intermediary server can take one or more actions with the at least a portion of the animal data and the associated metadata, the one or more actions including one or more authentications or transformations/conversions (e.g., converting the animal data into a digital asset) related to the targeted individual, their animal data being used as collateral asset or digital asset for consideration, and/or associated metadata.

The intermediary server can be configured to utilize the reference data (e.g., historical animal data, historical pricing information based upon similar or dissimilar data sets previously priced, which may include an evaluation that analyzes the type of animal data, type of sensor, quality of data, completeness of the data set, size of the data set, and the like) to create and assign one or more monetary values, or modify one or more assigned monetary values, for the at least a portion of animal data (e.g., which can incorporate the value of the associated contextual data/metadata) based upon the one or more evaluations, verifications, validations, or a combination thereof. In a refinement, the associated contextual data/metadata can have a separate one or more monetary values created or modified and assigned to it. In another refinement, a plurality of monetary values can be created or modified and assigned for the same data set/asset (e.g. if the data owner or acquirer is interested in seeing the monetary value of a data set with one or more different terms—including other monetary considerations—associated to the data set, the system can generate multiple monetary values based on the different terms for the same data set). In this regard, the system can provide multiple valuation parameters for the same animal data (e.g., or its derivatives such as collateral assets or digital assets) based one or more different variables (e.g., terms), with the one or more variables being a tunable parameter. In some variations, the one or more actions include using reference data gathered by the intermediary server as part of an evaluation asset (e.g., proxy, comparison) to evaluate, verify, validate, or a combination thereof, the at least a portion of the animal data and the associated metadata, or to create or modify one or more monetary values. In other variations, the reference data gathered by the intermediary server is used, at least in part, to evaluate, verify, validate, or a combination thereof, at least a portion of the animal data and the associated metadata. In a refinement, at least a portion of the reference data is utilized by the intermediary server to take the one or more actions with the at least a portion of the animal data and associated metadata, the one or more actions including the one or more evaluations, verifications, validations, or a combination thereof. In another refinement, the one or more actions include one or more steps that transform (e.g., which can include create or modify) the at least a portion of the animal data and associated metadata, or its one or more derivatives, into a collateral asset or digital asset (e.g., digital currency asset). The one or more transformative steps can include the intermediary server creating one or more units of data along with metadata and the one or more associated terms (e.g., permissions, conditions, restrictions, and the like, which can be included as part of the metadata) that can be used for consideration as one or more assets. For example, the system may have data for n period of time (e.g., a day, a week, a month, a year, or more) for an individual based on multiple different sensors or different types of data. In this example, the intermediary server (or computing device in communication with the intermediary server) can transform the data into one or more units of data which comprise the collateral asset or digital asset (e.g., which can be based on user preferences or data acquirer preferences or other established preferences or terms), with each unit having one or more types of data along with different metadata and permissions that can be sold each as unit. For example, an analytics company may only want a targeted individual's blood glucose levels in the morning for a y period of time (which can be one unit of information that comprises the collateral asset or digital asset), while another company may want the individual's medical record and ECG data for a z period of time (which can be another unit and therefore comprise another collateral asset or digital asset). In many variations, the intermediary server utilizes reference data in its one or more steps (e.g., as a baseline, comparison, or reference) to execute the transformation. In another refinement, the intermediary server generates one or more terms (e.g., including terms and conditions) for using the at least a portion of animal data as collateral (e.g., in the form of a collateral asset) or as a digital asset for exchange, at least in part, to enable the targeted individual or their assignees to secure (e.g., acquire) consideration (e.g., a loan, cash, a digital token, a benefit, a product, a service, and the like), the one or more terms including at least the one or more evaluations, verifications, validations, or a combination thereof, and the assigned monetary value to the at least a portion of animal data. Consideration in this context can be in the form of one or more economic units (e.g., that function as a medium of exchange). In a refinement, the one or more economic units include at least one of or any combination of: cash, one or more tokens, tangible property, intangible personal property, one or more benefits, one or more services, one or more goods/products (e.g., including virtual products including products within video games or game-based systems), or a combination thereof. In a refinement, the intermediary server modifies the one or more terms related to the use of the at least a portion of animal data as collateral, at least in part, to enable the targeted individual to secure consideration. For example, the intermediary server may identify one or more terms selected by the data acquirer or targeted individual that need to be adjusted based upon existing terms already associated to the animal data via one or more other collateral or digital assets (e.g., which can be found via the one or more digital records associated with the targeted individual, the animal data, the one or more assets, or a combination thereof). In a refinement, the system then converts the animal data and its associated metadata (e.g., including contextual data that has been incorporated in the valuation of the data set) into a collateral asset or digital asset which is used as the collateral or as the digital currency to acquire consideration. In some variations, the collateral asset can include other information that enables the system to create or modify one or more monetary values, terms, or a combination thereof, for the collateral asset (e.g., the collateral asset can include a summary of the animal data comprising the collateral asset in order to create a monetary value for). In another refinement, the collateral asset or digital asset includes the one or more terms associated with the use of the animal data as collateral or as a digital currency for consideration. The collateral asset can include tangible property, intangible property (e.g., the animal data, other data), or a combination thereof, which may be provided by the targeted individual or other party (e.g., another subject may provide their animal data as collateral in order for the targeted individual to receive consideration; animal data may be combined from multiple individuals to create a collateral asset or digital asset for consideration). In another refinement, the collateral asset or digital asset can be one more digital files that represent the animal data and the one or more terms associated with the animal data that comprise the collateral asset or digital asset. Upon acceptance of the one or more terms by the targeted individual (e.g., which can include their heirs, the one or more assignees to the animal data, other owners of their data, and the like, and can occur via computing device 20 or other computing device accessible by the targeted individual or heirs/assignees/other owners) and/or party providing the collateral or digital asset, the intermediary server provides consideration based upon the assigned monetary value, at least in part, to another computing device in exchange for the collateral or digital asset (e.g., which can be one or more rights to the collateral asset, the rights established by the one or more terms), the collateral including the at least a portion of animal data. In some variations, consideration may be provided to multiple computing devices (e.g., to multiple accounts, multiple people). In a refinement, the collateral asset is used as digital currency to acquire consideration (e.g., goods, services, other forms of currency, and the like). In another refinement, the animal data (e.g. including its one or more derivatives such as the collateral asset or digital asset) is utilized, at least in part, by the targeted individual or animal data rights holder (e.g., collateral asset owner, other rights holder) to acquire or provide one or more products (e.g., goods), services, or benefits (i.e., akin to a currency). In another refinement, the collateral asset includes a plurality of collateral assets. In another refinement, the collateral asset includes at least a portion of non-animal data. In another refinement, the collateral asset is used as a digital asset (e.g., digital currency asset) to acquire consideration. In a refinement, the collateral asset is a digital asset used as a form of digital currency to acquire consideration. In another refinement, the collateral asset is in the form of one or more animal data-based digital tokens, coins, certificates, or cards (e.g., digital trading cards, digital identity cards, and the like). In another refinement, a digital asset includes a collateral asset (and vice versa). In another refinement, a digital asset is a collateral asset (and vice versa). In another refinement, the one or more terms associated with the distribution or acquisition of the collateral asset in exchange for consideration are included as part of the metadata associated with the animal data or its one or more derivatives provided to one or more computing devices.

In another refinement, the collateral asset or digital asset can be encrypted using various encryption techniques such as RSA, PKI, DES, AES, Blowfish or Twofish. The present invention is not limited by the type of encryption technique utilized. Encryption can be applied to the data (e.g., animal data) and/or its one or more derivatives (e.g., the collateral asset, digital asset), the metadata, other contextual data not included as metadata, the one or more terms, or a combination thereof.

In a variation, the assigned monetary value for the collateral asset can be modified based upon the one or more terms generated by the intermediary server (e.g., derived from one or more preferences of the data acquirer or data owner or a combination thereof). For example, in some variations, the system can create a single monetary value for the collateral asset which is associated with (e.g., assigned to) the collateral asset prior to the creation of one or more terms, or after the one or more terms are created and associated with the collateral asset. In other variations, the system can create multiple monetary values for the collateral asset prior to the creation of the one or more terms. After the one or more terms are created (e.g., generated), the system may select a previously assigned monetary value and modify the value based upon the one or more terms, creating a new assigned monetary value for the collateral asset. Characteristically, the order in which the one or more steps occur to execute the invention (e.g., generation of one or more terms, creation or modification and assignment of one or more monetary values, the transformation of the animal data and the associated metadata into a collateral asset, one or more evaluations, verifications, validations, or a combination thereof, and the like) can be a tunable parameter given the plurality of combinations that can exist to execute the invention. In a refinement, the system can create multiple monetary values for the collateral asset after at least a portion of the one or more terms are created and associated with the collateral asset. For example, the collateral asset with one or more terms may have different monetary values based upon another one or more terms that are yet to be agreed upon (e.g., interest rate information, loan repayment information) or based upon other contextual factors (e.g., the system may provide different monetary values based upon the risk profile of the individual which may look at information such as credit history and other personal attributes; one monetary value may be associated with the collateral asset and another may be associated with the collateral asset depending on the region of the world in which the collateral asset is being used; and the like).

In a refinement, at least a portion of the ownership rights related to the collateralized animal data becomes the possession of the stakeholder operating the intermediary server (or other computing device operated by the stakeholder such as a loan company or insurance company) or one or more other assignees until one or more of the terms are met, the one or more terms including repayment (e.g., which may include the consideration provided or other type of consideration contemplated in the one or more terms, or achievement of a milestone such a milestone in a video game or winning a wager) of at least a portion of the consideration to the stakeholder or the one or more assignees.

In another refinement, the consideration is provided for a defined period of time, upon which the individual accepting the consideration (e.g., the targeted individual) repays at least a portion of the consideration to the stakeholder providing the consideration or other assignee, at which time the targeted individual may receive at least a portion of their ownership rights to the collateralized animal data back (e.g., a loan company may provide cash to a targeted individual while using their animal data as collateral for consideration. Upon repayment of the loan, the loan company may retain a copy of the anonymized data and retain one or more rights to monetize the anonymized data with one or more terms attached while the targeted individual re-obtains the ownership rights, at least in part, to their animal data).

In another refinement, the intermediary server provides consideration equivalent in value to the assigned monetary value of the collateral asset or digital asset to another computing device in exchange for the collateral asset or digital asset. “In exchange for the collateral asset” can mean one computing device sending the collateral asset to another computing device. In a variation, it can also mean obtaining the legal right(s) to the collateral asset based upon the one or more terms, which may or may not require sending (or providing access to) the collateral asset from one computing device to another computing device.

In another refinement, interest is required to be provided by the one or more parties receiving the consideration (e.g., the targeted individual) upon acceptance of the consideration. In this regard, the system can be operable to enable a user (e.g., stakeholder, targeted individual) to create or modify one or more interest rates to be associated with the consideration provided to the targeted individual (e.g., cash) in exchange for the targeted individual's collateral asset. In a variation, the one or more terms can include one or more interest payments on the provided consideration. Interest can be in the form of a monetary payment (e.g., currency). It can also be in the form of additional animal data provided by the targeted individual from the one or more biological data sensors. For example, interest on the consideration (e.g., the loan) may be based on future sensor data collected (e.g., a certain amount of animal data being collected monthly by the targeted individual as “interest” on the loan). In some variations, this may convert into one or more penalties (e.g., currency-based penalty, requirement to provide other animal data not initially used as collateral) if the data is not provided. In a variation, the intermediary server collects interest, the interest including a at least a portion of animal data (e.g., future collected sensor data, other types of animal data). In another variation, intermediary server collects additional animal data (e.g., from one or more biological data sensors, from one or more other systems such as medical records or other animal data) as a form of interest (e.g., interest payment) on the consideration provided (e.g., one or more loans in exchange for the collateral asset), and the targeted individual provides additional animal data as a form of interest associated with the provided consideration. In a refinement, the animal data is collected from one or more biosensors assigned by the stakeholder providing the consideration (e.g., loan company, insurance company). In another refinement, the stakeholder providing the consideration may operate one or more applications on the computing device associated with the targeted individual in order to collect animal data as interest on the consideration.

In another refinement, the system creates or modifies one or more debt instruments as one or more collateral or digital assets. A debt instrument can involve the grouping of categorized animal data (e.g., including its one or more derivatives) by assessing one or more characteristics (e.g., quality, type of animal data) and then tranching the data based on the one or more characteristics to provide a return profile. For example, a low quality and high-risk data (e.g., data that is not clean or has a lower-than-expected probability of materializing, as in the case of a future obligation to provide animal data—such as a collateral asset or digital asset—against which a loan is sought) can demand a higher interest rate or more favorable loan repayment schedule (e.g., which may include providing financial consideration, non-financial consideration such as additional animal data, or a combination thereof) as opposed to data deemed “less risky.” In one variation, another individual provides a guarantee for the loan or other consideration on behalf of the targeted individual in the form of at least a portion of the other individual's animal data. which may include an obligation to collect future data (e.g., a spouse may “guarantee” a loan for the targeted individual via one or more rights to their animal data or an obligation to collect future animal data). The mechanics for creation of the one or more debt instruments utilizing animal data can be akin to how Collateralized Debt Obligations are created, structured, and priced. Characteristically, the system can be configured to assess value or quality of data and tranching it in multiple ways. In a refinement, the one or more collateral or digital assets are utilized as one or more financial instruments (e.g., packaged into one or more financial instruments) and segmented into tranches via the evaluation of one or more characteristics associated with the animal data (e.g., data quality, data quantity, activities in which the data has been collected, characteristics of the individual, type of sensor(s), and the like, all of which can create a value and risk profile for the packaged data sets) in order to make the one or more financial instruments that feature at least a portion of animal data investable and appealing to all or a subset of investors.

In another refinement, the system can operate as a data indexing system (e.g., data index), wherein the system evaluates, verifies, and validates animal data and its associated metadata, or its one or more derivatives (e.g., digital asset, collateral asset), to authenticate one or more characteristics related of the data (e.g., the quality of the data set, value of the data set, and the like). The authentication can be, for example, related to the quality of data (e.g., is the data that comprises the digital asset investment-grade data, which can be defined based upon one or more tunable parameters related to the one or more characteristics of the data). In another refinement, the system can operate as an exchange (e.g., data exchange that operates similarly to a stock exchange) which allows individuals to invest in a subset of the one or more data digital assets (e.g., invest in one or more groups of digital assets). In a refinement, the system can tranche and package all or a subset of the digital assets (e.g., including collateral assets) into one or more units to enable individuals to provide consideration to acquire at least a portion of each one or more digital assets across the one or more units (e.g., akin to an index fund). In a refinement, a portion of the digital asset is exchanged for consideration. For example, an individual may acquire one or more fractional shares of or in the digital asset in exchange for consideration.

In another refinement, the collateral or digital asset is authenticated by the system. The verification/authentication can include one or more digital marks (e.g., a unique hash, key, signature, or the like) attached to or associated with the collateral or digital asset that informs receiving systems (e.g., one or more third party computing devices) that the collateral asset has been verified/authenticated by the system (e.g., which can occur via evaluating, verifying, and validating engine 50). In another refinement, the intermediary server authenticates the collateral or digital asset and attaches one or more digital marks to the collateral or digital asset in order to notify the one or more receiving computing devices of the authenticity of the collateral or digital asset and its contents (e.g., the animal data, associated metadata, and the one or more rights associated with its use).

In another refinement, the system utilizes biological data-based authentication (e.g., biometric authentication) to verify that the animal data comprising the collateral asset is, in fact, associated with one or more individuals. For example, the collateral asset may include one or more unique biological signatures such as biological-based identifiers (e.g., unique identifiers; in some variations, non-unique identifiers), patterns (e.g., any type of pattern including time slice, spatial, spatiotemporal, temporospatial, and the like), rhythms, trends, features, measurements, outliers, abnormalities, anomalies, readings, signals, data sets, characteristics/attributes (e.g., unique characteristics), or a combination thereof, derived from one or more calculations, computations, measurements, derivations, extractions, extrapolations, simulations, creations, combinations, modifications, enhancements, estimations, evaluations, inferences, establishments, determinations, conversions, deductions, or observations from (or of) animal data of the targeted individual, at least in part, that enable the identification of the targeted individual or characteristic/trait associated with the individual (e.g., a medical condition that creates value for the collateral asset). Characteristically, the collateral asset can be verified as being associated with the targeted individual comparing/evaluating and matching the one or more biological-based signatures derived from the targeted individual and the one or more the one or more biological-based signatures associated with the collateral asset. Additional details related to an animal data identification and recognition system that identifies individuals and associated characteristics based upon their animal data are disclosed in PCT Application No. PCT/US22/26532 filed Apr. 27, 2022; the entire disclosure of which are hereby incorporated by reference. In another refinement, the system can derive the one or more biological data-based signatures from the animal data comprising the collateral asset or digital asset to verify that the animal data comprising the collateral asset or digital asset is derived from the one or more targeted individuals with the one or more desired characteristics. For example, a particular collateral asset may be derived from a targeted individual with a rare genetic disease, so a receiving system wants to verify that the animal data comprising the collateral asset is derived from that individual. In a variation, the system may collect data from the targeted individual via one or more sensors, at least in part, at any given time and create one or more biological signatures from the collected animal data and the animal data comprising the collateral asset to verify that the animal data comprising the collateral asset has not been manipulated or altered, or to verify that the animal data comprising the collateral asset is, in fact, derived from the targeted individual and not another individual.

The assigned monetary value for the animal data-based collateral or digital currency can take a variety of forms. The one or more assigned monetary values can be in the form of a currency (e.g., physical or digital banknotes, coins, money) which includes at least one of or any combination of: fiat currency, digital currency (e.g., including decentralized digital currency), asset-backed currency, virtual currency, cryptocurrency, or central bank digital currency. In some variations, the currency can be classified as two or more of these descriptors (e.g., a currency can be a cryptocurrency and a digital currency). In a refinement, the one or more monetary values are generated by the system in the form of one or more products, services, goods, benefits, currencies, assets (e.g., physical assets or digital assets), or a combination thereof (e.g., the animal data of the targeted individual may be worth 2 tickets to a sporting event, or n number of spa treatments, or a combination thereof; the digital asset associated with the targeted individual may be worth x tickets to a sporting event and y dollars; and the like).

In a refinement, the collateral asset or digital asset is exchanged for consideration, the consideration being at least one of or any combination of: a currency, (e.g., fiat currency, digital currency including decentralized digital currency, asset-backed currency, virtual currency, cryptocurrency, or central bank digital currency), a loan, a service, a good, a benefit, a product (e.g., physical product/digital product), or an asset (e.g., physical asset/digital asset; another animal data-based collateral or digital asset). In another refinement, consideration is provided by one or more computing devices in exchange for the collateral asset or digital asset, the consideration being in the form of one or more currencies (e.g., including forms of digital currencies, including coins and/or tokens), services, goods, benefits, products, or a combination thereof. In another refinement, upon the intermediary server creating or modifying and assigning one or more monetary values to the animal data, or modifying one or more assigned monetary values, the animal data or its one or more derivatives is utilized as a form of currency to acquire one or more other currencies, goods, services, benefits, assets, or other consideration. In another refinement, the monetary value may be non-monetary in nature. The assigned monetary value can be in the form of one or more products (e.g., both physical and digital products, including physical and digital goods), services, benefits, currencies, assets, or a combination thereof. Characteristically, the animal data-based collateral and consideration system may utilize an animal data-based pricing engine that enables the creation or modification of the one or more monetary or non-monetary values in order to assign the one or more monetary or non-monetary values to the animal data or its one or more derivatives (e.g., animal data-based collateral asset or digital asset). The pricing engine may also assign the one or more monetary or non-monetary values to the animal data. The pricing engine may leverage one or more Artificial Intelligence techniques, at least in part, to create or modify (e.g., change, enhance, reduce) the one or more monetary values (e.g., dynamically). In a refinement, the pricing engine can be configured to create one or more evaluation assets in order to create or modify the one or more monetary values for the animal data, its associated metadata (e.g., which can include contextual data, such as the type of data acquirer, market, and the like), the associated one or more terms, or a combination thereof. In another refinement, the pricing engine triggers the system to create or modify and offer one or more new products for sale to an existing or prospective acquirer (e.g., buyer). In another refinement, the animal data and its associated metadata (e.g., including its more or more terms) are used as an asset (e.g., collateral) to back one or more types of digital currency (e.g., an asset-backed animal data-based digital currency). In a variation, the digital currency may be a type of cryptocurrency (e.g., a digital currency in which transactions are verified and records maintained by a decentralized system using encryption techniques such as cryptography). In another refinement, the pricing engine can be configured to create or modify and assign one or more values for both the underlying data being used to create the one or more collateral or digital assets as well as the one or more collateral or digital assets themselves. This can be advantageous, for example, in scenarios where the targeted individual uses a subset of the underlying data to create the collateral or digital asset, places one or more preferences/restrictions upon the collateral or digital asset, and/or has one or more existing restrictions associated with the collateral or digital asset (e.g., from one or more previous agreements), and wants to understand the potential range of values for all or a subset of the data with and/or without the one or more preferences/restrictions.

In a refinement, a digital asset (e.g., digital coin, digital token) with an assigned value can be used as a form of currency to obtain consideration. For example, a digital asset with an assigned monetary value, contained in a digital wallet, and accessible via a computing device (e.g., mobile computing device) in possession of the targeted individual can be transferred by the targeted individual—via the mobile computing device—to another computing device (e.g., on the fly) in order to obtain other consideration (e.g., groceries) or provide consideration (e.g., pay electricity or phone bill). In another refinement, the assigned value to the digital asset can be a defined indices. For example, a company that provides the sale of goods and services may assign an indices (e.g., such as a number, color, or other symbol) to the digital asset which represents the value of the digital asset to the company or a subset of companies (e.g., the digital asset may be assigned the number 3, which can mean that the digital asset can be exchanged for an equivalent of n number of x type of goods or m number of y type of goods via the company or subset of companies).

In another refinement, the system can be configured to evaluate, verify, and/or validate one or more collateral or digital assets derived from one or more other systems. This can include evaluating and verifying one or more values (e.g., monetary values, non-monetary values) associated with the one or more collateral or digital assets, as well as creating one or more new values based upon the evaluation (e.g., the system may determine that the value of the collateral or digital asset is z when another system has valued the collateral or digital asset at y).

In a refinement, at least a portion of a targeted individual's reference animal data is used as collateral or as a digital currency for consideration. For example, the reference animal data can be utilized to comprise, at least in part, the one or more collateral assets or digital assets that are utilized as collateral or as a digital currency for consideration. In another refinement, at least a portion of a targeted individual's reference animal data can be combined or grouped together with their animal data to create a data set that is used as collateral or as a digital currency (e.g., by the targeted individual) for consideration. In another refinement, at least a portion of a targeted individual's animal data (e.g., which can include their reference animal data) is combined or grouped together with animal data from one or more other individuals (e.g., which can include reference data from one or more other individuals) to create a data set that is used as collateral or as a digital currency (e.g., by the targeted individual) for consideration. In another refinement, at least a portion of reference animal data can be combined or grouped together with other animal data to create a data set that is used as collateral or as a digital currency (e.g., by the targeted individual) for consideration.

In another refinement, the digital asset utilized as a form of currency (e.g., animal data-based digital coin, animal data-based digital token) is backed by one or more assets that represent the value of the digital currency, the one or more assets including at least a portion of an individual's animal data and its corresponding metadata (e.g., the terms and conditions associated with the use of the data), or animal data from a group of individuals and its corresponding metadata. In one variation, the one or more units of information that comprise the digital asset used as a form of currency can include information related to the one or more terms (e.g., rules, conditions, permissions, and the like), ownership information (e.g., including ownership history, transaction history, and the like), associated monetary value(s) (e.g., including both current, previous, and future/projected values), and the like associated with the animal data. Characteristically, this information can support, at least in part, the value of the digital asset created or modified and assigned to it by pricing engine, or the value evaluated by the pricing engine. In some variations, the digital form of the asset-backed currency (e.g., as a coin, token, or other type of digital object) can include at least a portion of the animal data and information associated with the animal data as metadata upon the digital object representing the currency (e.g., the digital coin, token, trading card, or the like) being sent from one computing device to another computing device, or upon accessing the digital object via one or more computing devices (e.g., to verify or validate the one or more characteristics related to the animal data).

In another refinement, a digital asset such as a digital coin, token, or trading card is comprised of a plurality of digital assets such as a plurality of digital coins, tokens, or trading cards. For example, a single digital coin that is backed by the animal data as the underlying asset may be comprised of multiple digital coins that include at least a portion of the same animal data in multiple coins, with at least one of the differences being the terms, conditions, rules, or permissions associated with the animal data (e.g., one digital coin may allow one use case for the gathered animal data, which has one assigned monetary value, and another coin may allow for another use case for the gathered animal data, which has another assigned monetary value). Characteristically, the system can be operable to enable one or more targeted individuals to create multiple coins or tokens for their animal data based on creating one or more different rules (e.g., permissions, terms, conditions) for the same animal data. Using technologies such as distributed ledger technologies, the system can be operable to ensure that digital coins created with specific rules (e.g., terms, conditions, permissions, conditions, rights) are unique, creating unique ownership for each coin with a different set of rules even if based on the same animal data. In a variation, the system can enable the creation of multiple coins with the same animal data and the same one or more terms/rules associated with it (e.g., enabling multiple coins to be created and distributed by the individual to acquire consideration). This may be advantageous in a scenario where an individual, such as an athlete, wants to provide their animal data information (e.g., real-time heart rate information) in a live sporting event with the same rules to multiple data acquirers (e.g., sports betting platforms). In another refinement, the animal data and associated metadata comprising each digital coin or token—or groups of coins or tokens that comprise a digital coin or token—can be a tunable parameter. For example, a digital animal data token or digital animal data coin can be created for each type of data, for data over a defined period of time, for data related to a defined event, for a subset of data from one or more data types, for each individual data value or group of values from a given data set, for data from each sensor across one or more sensors, for data from each individual across one or more individuals, and the like. For example, the digital asset may be comprised of animal data from one or more sensors and its associated metadata over a defined period of time (e.g., a digital token that consists of an individual athlete's physiological data, location data, biomechanical data, and contextual data such as statistical data only for the 4^{th} quarter of a game or a subset of games), or for a specific type of animal data from multiple individuals from one or more sensors (e.g., the data acquirer only wants location-based sensor data and contextual statistical data for the 4^{th} quarter of a game for all players on the court), and the like. In another refinement, the digital asset consists of a plurality of digital assets. For example, each animal data set for each individual athlete in a game can have its own digital data token to be sold to data acquirers, with the aggregate digital data tokens—or a subset of the aggregate tokens—being provided to a data acquirer as a single digital asset (e.g., single digital data token).

In a refinement, the intermediary server is in electronic communication with another one or more computing devices that provide a display and an application (e.g., native application, web browser-based application, hybrid) or other program for the targeted individual or other user to provide (e.g., input, make accessible, upload, send) at least a portion of the animal data, one or more preferences related either directly or indirectly to the use of the animal data as a digital currency or collateral for consideration, or a combination thereof. In a refinement, at least one of the one or more preferences (or derivatives thereof) are included as part of the one or more terms generated by the intermediary server. In some variations, the application is a loan-based application for the targeted individual to provide one or more inputs, the one or more inputs including at least a portion of animal data, that enable the targeted individual to receive the consideration in exchange for the collateral (e.g., their collateral asset). A loan can be in the form of cash or equivalent physical or digital currency, a loan of goods or products, and the like. In other variations, the application can be a program operable for an individual (or groups of individuals) to acquire one or more goods, services, currencies (e.g., including forms of currency or assets being utilized as a currency), or other consideration in exchange for one or more digital assets (e.g., collateral assets, digital currency assets) that incorporate at least a portion of their animal data (e.g., with the animal data being utilized as a form of digital currency to acquire consideration). The application can be, for example, a marketplace to acquire or exchange animal data for consideration. In another variation, the intermediary server includes a display and an application (or program) for the targeted individual to provide at least a portion of the animal data, one or more preferences, or a combination thereof. In another refinement, the intermediary server generates one or more agreements (e.g., contracts, licenses, smart contracts including self-executing contracts, or other legally-binding agreements, at least a portion of which may be digital in nature) or a legally-binding framework executable (e.g., via signature or one or more other forms of consent) by the targeted individual and/or their one or more assignees (e.g., heirs, other owners or legal rights holders to the data) and at least one stakeholder (e.g., data acquirer or the party providing the consideration in exchange for the collateral such as the company providing the loan, fitness company, video game company, insurance company, and the like) based upon one or more terms to enable the acceptance of the one or more terms. The one or more terms can be generated automatically and acceptance can occur electronically via one or more computing devices. In another refinement, the one or more terms include at least one of or any combination of: length of the term, principal consideration (e.g., currency/loan, virtual product, service, benefit) amount, repayment schedule, interest terms related to the collateral, one or more uses of the animal data, advertisement and privacy rights, representations & warranties, intellectual property rights, governing law, rights, default provisions, remedies, substitution of consideration, or method of consideration repayment. It should be appreciated that this is not an exhaustive list of the possible terms and conditions related to use of animal data as collateral or a digital currency for consideration, as other terms and conditions may apply (e.g., depending on the type of animal data and/or digital asset being distributed for consideration and the use case, which can include—but are not limited to—terms related to uses of the data or its derivative(s), re-selling of digital assets, sponsorship/advertisement/revenue sharing if applicable, and the like). The intermediary server can be operable to summarize the one or more terms and provide the summarized one or more terms to the targeted individual prior to providing the one or more agreements to, and enabling the execution of the one or more agreements, between the targeted individual (e.g., or other party with rights to the data, such as their assignees) and the stakeholder. In a refinement, the one or more terms are inclusive of the one or more contacts from which the one or more terms are derived. In another refinement, the one or more terms include any language (e.g., including contractual language, code, and the like) required to enable the exchange of consideration, with at least a portion of the consideration including data (e.g., animal data) or its one or more derivatives.

In another refinement, the intermediary server is in communication with another one or more computing devices (e.g., electronic communication) that take at least one action on behalf of the intermediary server. For example, computing device 25 or other computing device can be operable to take one or more actions on behalf of the intermediary server, the one or more actions including at least one of or any combination of: gathering at least a portion of the animal data from the source of animal data such that the animal data has metadata associated thereto; gathering reference data; performing one or more evaluations, verifications, validations, or a combination thereof with the at least a portion of the animal data and associated metadata; using the reference data and information derived from the one or more evaluations, verifications, validations, or a combination thereof, to create or modify, and assign, one or more monetary values, or modify one or more assigned monetary values, for the at least a portion of animal data based upon the one or more evaluations, verifications, validations, or a combination thereof; generating one or more terms related to the use of the at least a portion of animal data as a form of digital currency or collateral, at least in part, to enable the targeted individual to acquire consideration, the one or more terms including information derived from or related to, either directly or indirectly, the one or more evaluations, verifications, validations, or a combination thereof, the one or more assigned monetary values to the at least a portion of animal data, one or more preferences related to the use of the animal data created either directly or indirectly from the targeted individual or a data acquirer, one or more terms previously associated with at least a portion of the animal data, or combinations thereof; upon acceptance of the one or more terms electronically by the targeted individual, including the one or more terms as part of the metadata associated with the animal data and transforms the at least a portion of the animal data and the associated metadata, or its one or more derivatives, into a digital asset (e.g., collateral asset, digital currency asset); providing access to the consideration based upon an assigned monetary value derived from the one or more assigned monetary values, at least in part, of the digital asset, at least in part, to another computing device (e.g., accessible by the targeted individual or their assignees) in exchange for the digital asset; or a combination thereof.

In a variation, the intermediary server can automatically generate one or more agreements (e.g., licenses, contracts, terms upon which individuals can legally consent to, other types of agreements) based upon the one or more terms between a user (e.g., targeted individual) and the stakeholder (e.g., acquirer of the one or more digital assets or collateral assets such as a loan entity, video game company, wagering system, products company, goods or services company, other digital asset or collateral asset acquirer) related to the use of the user's animal data as collateral or as a digital currency for consideration. The agreement can include terms (e.g., rights, permissions, restrictions, conditions) related to the use of the animal data as collateral or as a digital currency for consideration. In some variations, the one or more terms can be established by one or more selected preferences of the user, the stakeholder (e.g., acquirer), the one or more computing devices (e.g., preferences selected and inputted by the computing device based upon the one or more selections by the user, the stakeholder, and/or previous terms in the reference data), or a combination thereof. Based upon the one or more terms associated with the use of the animal data as collateral or as a digital currency in exchange for consideration by the intermediary server, the system can automatically generate the one or more agreements that the user and stakeholder can execute (e.g., via a selection mechanism such as selecting a box to check, verbal authentication, digital signature, manual signature, system-to-system certification, and the like) to enable the user to access the consideration based upon the agreed-upon terms related to the use of the animal data as collateral or as a form of digital currency.

In another variation, the system enables the targeted individual to receive consideration based upon the use of their (or other individual's) animal data as collateral (e.g., as part of a loan system whereby the targeted individual receives a consideration-based loan while using the animal data as collateral for the loan) or as a digital currency. In this variation, the system can be operable to automatically generate the one or more agreements (e.g., digital agreements) that the user and stakeholder can execute based upon either the user or the stakeholder (or both) selecting at least one or more terms that are associated with the animal data (e.g., permissions and conditions related to the stakeholder's use of the animal data and user's terms for receiving consideration). In some variations, system may automatically generate the one or more agreements that the user and stakeholder can execute based upon both the user and stakeholder selecting at least one or more terms that are associated with the use of the animal data as collateral or as a form of digital currency for consideration, as well as one or more terms related to the consideration (e.g., repayment schedule of the consideration received as a loan based upon the use of the animal data as collateral, which may include a form of currency, additional animal data, or a combination thereof; interest rate information; scope of rights related to use of the data; and the like). In a refinement, the system can automatically generate the one or more agreements that the user and stakeholder can execute based upon at least one previously established preference of the user, stakeholder, or a combination thereof. The system may utilize one or more Artificial Intelligence techniques to identify the at least one preference. In another refinement, the system may automatically generate the one or more agreements that the user and stakeholder can execute based upon the system automatically selecting one or more terms to incorporate in the one or more agreements. The selection of one of the one or more terms may be derived by the system from the one or more digital records associated with the targeted individual, the metadata associated with the animal data being utilized as part of the collateral or digital asset, the metadata associated with reference data, the reference data, or a combination thereof (e.g., which—along with any boilerplate terms associated with the use of animal data as collateral or as a digital currency for consideration—can be part of the reference database via computing device 25). In another refinement, the one or more agreements include one or more terms related to the animal data from one or more previous agreements, which may have been executed by the targeted individual or the stakeholder, or based upon one or more similar characteristics related to the animal data (e.g., the one or more terms for an ECG-based animal data set are based upon previous and similar agreements for other ECG-based animal data sets), preferences established by the targeted individual or the stakeholder, or a combination thereof. In this refinement, the system can access the one or more terms via the reference database via computing device 25. In another refinement, the one or more agreements are created or modified (e.g., updated, nullified) based upon one or more new agreements gathered or created by the system (e.g., included as part of the reference data via the reference database). In another refinement, the one or more terms associated with the at least a portion of animal data being utilized as collateral or a form of currency are included, at least in part, as part of the packet of information that forms the collateral asset or digital asset.

In some variations, animal data used as collateral or as a digital currency may have multiple owners and multiple agreements associated with the same animal data, or multiple collateral assets and/or digital assets may exist which incorporates at least a portion of the same animal data, and one or more terms associated with the animal data in each agreement may overlap depending on the agreement. In this regard, the animal data provided by a targeted individual as collateral or as a digital asset may have not only an owner or multiple owners but also a hierarchy that the targeted individual and future stakeholders are bound to. For example, a user may enter into an agreement to provide their animal data to a stakeholder as a collateral asset for consideration. Such data may have one or more terms associated with that data via one or more previous agreements with previous data acquirers (e.g., previous stakeholders). The system may be operable to automatically generate, at least in part, one or more agreements that incorporate the one or more terms that have been previously associated with the animal data being used as a collateral asset (which may be animal data already collected or future animal data not yet collected). In a variation, the system can be operable to automatically generate, at least in part, one or more agreements that incorporate one or more terms associated with the contemplated animal data from any previous one or more agreements into the new one or more agreements in order to ensure that previously agreed-upon terms have been contemplated in future agreements. In this regard, a digital record for the animal data can be created or modified, the digital record including the one or more terms/rules associated with the animal data. The digital record can include a chain of ownership that is created or modified based upon one or more ownerships or one or more periods of ownership. The digital record can also be the reference data upon which the one or more monetary values are created or modified and the one or more terms are generated. For example, in the event a targeted individual selects one or more preferences related to the use of their animal data as collateral or as a digital currency, the system can check the one or more preferences against the digital record of the animal data or the targeted individual, or the asset itself (e.g., the collateral asset or digital asset may have its own record separate from the animal data that comprises it, at least in part) to ensure that the user is able to use the animal data as a collateral asset or digital asset with the desired terms attached. The digital record can be stored locally or on another computing device (e.g., cloud server) or may be attached to (or associated with) the data. In some variations, the system can identify the one or more targeted individuals, one or more animal data sets associated with the targeted individual, or a combination thereof, from one or more digital records associated with the one or more targeted individuals, one or more animal data sets associated with the targeted individual, the one or more collateral or digital assets that are comprised of the animal data (at least in part), or a combination thereof. In a refinement, the one or more digital records associated with the targeted individual, the data acquirer, the animal data or its one or more derivatives, or a combination thereof, are updated as new information is gathered by the system or as new information is created or modified by the system. In one variation, the one or more digital records can be accessible via one or more accounting systems associated with the one or more data acquirers or targeted individuals for accounting reconciliation associated with the exchange of consideration which includes animal data.

In a refinement, the system is operable to (i.e., configured to) take one or more actions to authorize and enable the conversion of the animal data (e.g., the digital file) into one or more digital assets. In this regard, the system accesses the one or more digital records for each individual or data set (or collection of data sets) to verify information related to the animal data (e.g., verify the chain of ownership; verify that the terms being established for any particular digital asset being created or minted do not infringe on the one or more rights of other digital assets that feature at least a portion of the same animal data; verify that the animal data being created or minted does not have any liens or restrictions on the data based upon previous agreements established by the data rights holder for at least a portion of the same animal data; and the like). In one variation, the system may act as a central authority (e.g., akin to a virtual bank) that stores the one or more digital records and provides the one or more verifications, authorizations, or a combination thereof (e.g., enabling the regulation of digital asset production such as a digital coin backed by at least a portion of animal data). In another variation, the system may be part of a decentralized ecosystem (e.g., distributed ledger technology-based ecosystem). In another refinement, the one or more digital assets being created or minted (e.g., coin, token) may include one or more other assets to increase the value of the coin or token (e.g., other hard assets or digital assets of the individual or contributed to the digital asset to increase its value).

In a refinement, the system is operable to identify animal data and one or more terms associated with the animal data from an individual's (or group of individuals') animal data based on a predetermined or preestablished monetary value created by the data owner. In this refinement, the system is operable to identify and select at least a portion of the animal data and the one or more terms associated with the animal data based on one or more preferences established by the data owner to enable one or more monetary values to be created or modified for the data (e.g., create one or more customized digital assets based upon an input of one or more desired target monetary values). For example, if a data owner wants to create a digital asset based on their animal data with a monetary value of x, the system can identify one or more combinations of animal data via the individual's digital record that would equal (or be approximate to) the value of the desired monetary target. In this example, the individual can customize their one or more inputs related to their animal data while generating a collateral or digital asset with a pre-determined value (e.g., monetary and/or non-monetary value). For example, the data owner can input one or more restrictions related to the type of animal data the system utilizes to create the digital asset (e.g., an individual may not want certain data included as part of any given digital asset) or input one or more terms associated with the use of their animal data in the creation of the digital asset. In light of the one or more restrictions, the system can create a digital asset based on the rest of their animal data and/or with the one or more terms contemplated with the preestablished value (e.g., preestablished monetary value of x as determined by the data owner). In some variations, the preestablished value can be set by the data acquirer.

In another refinement, the system automatically creates or modifies one or more terms (e.g., rules) associated with the animal data based upon a predetermined monetary value target. In another refinement, the system automatically creates or modifies one or more terms based upon the implementation of one or more rules associated the evaluation, verification, validation, or a combination thereof, of animal data that enable the identification of one or more characteristics associated with the animal data that are related to the creation or modification one or more monetary or non-monetary values (e.g., if data is collected in one environment vs. another, it is worth more; when 3 consecutive heart rate values exhibit a pattern, such as if value 1 is less than value 2 but value 2 is greater than value 3 [v1<v2>v3] with a difference greater or equal to n number of beats per minute (with n being a tunable parameter) between each value, then the one or more of the values, or a subset of the one or more values, can be determined to be invalid by the system and the animal data set that includes the invalid data set may be worth less than heart rate data that does not exhibit this pattern).

In a refinement, upon the targeted individual and stakeholder agreeing to the one or more terms related to the use of the animal data as a collateral or digital asset (e.g., which can occur via one or more actions taken by each party via one or more computing devices) and executing an agreement (e.g., which can include a self-executing or smart contract), the system can be configured to generate and attach (e.g., as metadata) to the animal data and its one or more derivatives (e.g., the collateral or digital asset) the one or more terms as one or more rules, the one or more rules providing the one or more permissions, restrictions, conditions, preferences, rights, and/or approved uses of the animal data (e.g., via the collateral or digital asset) based upon the agreement. In another refinement, the system can attach one or more lines of executable code to the animal data once it is received as collateral or as a form of digital currency based upon the one or more terms (e.g., terms, conditions, permissions, rules) in the one or more agreements that allow for at least one computing device to monitor the use of the animal data on the receiving computing device (e.g., the computing device that receives the collateral or digital asset) to ensure the animal data is being utilized in a way that is in compliance with the terms and conditions of the agreement. For example, if the animal data being used as collateral is sent by the intermediary server to another computing device, the one or more lines of executable code may be operable to send information back related to the one or more uses of the data on the receiving system (e.g., who is accessing the animal data, what computing devices are accessing it, are terms being complied with, and the like). The reporting may be in the form of one or more alerts or notifications that can be received by the intermediary server, the targeted individual via a computing device (e.g., computing device 20), or other party. Additional details related to an animal data compliance system and method that generates terms and agreements for animal data are disclosed in PCT Application No. PCT/US22/11452 filed Jan. 6, 2022; the entire disclosure of which are hereby incorporated by reference.

In a refinement, the intermediary server takes one or more actions with the at least a portion of animal data contemplated as being used as the collateral asset or digital asset upon receiving the animal data from the targeted individual, the one or more actions including at least one of or any combination of: normalize, timestamp, aggregate, clean, analyze, tag, store, manipulate, denoise, process, enhance, organize, visualize, simulate, de-identify (e.g., anonymize), pseudonymize, synthesize, summarize, replicate, productize, sell, store, assign, transfer, transform, provide (e.g., distribute, send), assign one or more terms to, or synchronize the animal data, or a combination thereof. In another refinement, the one or more actions taken by the intermediary server to transform the at least a portion of the animal data and associated metadata, or its one or more derivatives, into a collateral asset include at least one of or any combination of: normalize, timestamp, aggregate, clean, analyze, tag, store, manipulate, denoise, process, enhance, organize, visualize, simulate, de-identify, pseudonymize, synthesize, summarize, replicate, productize, sell, store, assign, transfer, provide, assign the one or more terms to, or synchronize the animal data, or a combination thereof. In another refinement, the intermediary server takes one or more actions with the at least a portion of animal data received as the collateral (e.g., the collateral asset or digital asset) upon providing consideration to the targeted individual, the one or more actions including at least one of or any combination of: normalize, timestamp, aggregate, clean, analyze, tag, store, manipulate, denoise, process, enhance, organize, visualize, simulate, de-identify (e.g., anonymize), pseudonymize, synthesize, summarize, replicate, productize, sell, store, assign, transfer, transform, provide (e.g., distribute, send), assign one or more terms to, or synchronize the animal data, or a combination thereof. As one example, the loan agreement executed between the targeted individual and the stakeholder operating the intermediary server may enable the stakeholder to provide (e.g., sell) the anonymized data to one or more third parties for consideration, or use the data as training data for Artificial Intelligence-based models to derive one or more products or services. In another refinement, at least a portion of the animal data-based collateral asset or digital asset (e.g., including derivatives of the animal data, such as simulated data) is used by one or more computing devices to at least one of or any combination of: (1) create, modify, enhance, or evaluate one or more predictions, probabilities, or possibilities; (2) create, modify, enhance, or evaluate one or more wagers; (3) as a market upon which one or more wagers are placed or accepted; (4) formulate one or more strategies; (5) to create, modify, enhance, acquire, offer, or distribute one or more products; (6) mitigate, prevent, or take one or more risks; (7) create, modify, enhance, or provide one or more targeted advertisements or promotions; or a combination thereof. In another refinement, the system enables the targeted individual (or their assignee to the animal data) to use at least a portion of their animal data—either identifiable, de-identifiable, or pseudonymized—as collateral or as a digital currency to at least one of or any combination of: (1) place one or more wagers, (2) acquire one or more products, services, benefits; (3) mitigate or prevent one or more risks, (4) create, modify, enhance, or evaluate one or more predictions, probabilities, or possibilities; or a combination thereof. In another refinement, the system enables the stakeholder/acquirer to use at least a portion of collateralized asset or digitized asset—either identifiable, de-identifiable, or pseudonymized—to at least one of or any combination of: (1) offer or place one or more wagers (e.g., sports betting wagers, other types of bets), (2) create one or more products, services, or benefits; (3) mitigate or prevent one or more risks, (4) create, modify, enhance, or evaluate one or more predictions, probabilities, or possibilities; or a combination thereof. In another refinement, the intermediary server provides (e.g., makes available, distributes) at least a portion of the animal data-based collateral asset or digital asset to another one or more computing devices.

In some variations, the targeted individual may be multiple targeted individuals, and the animal data may be derived from multiple targeted individuals (e.g., group of individuals combining their animal data to get a loan). In other variations, the targeted individual receiving the consideration may be a different individual or entity than the individual from whom the data was derived from (e.g., in the event the animal data has been assigned to another data owner or assignee).

In a refinement, the intermediary server takes one or more actions (e.g., assigns one or more terms or metadata to the animal data, stores the animal data, transfers the animal data, de-identifies the animal data, sells the animal data, cleans the animal data, and the like) with the at least a portion of animal data received as the collateral asset or digital asset and provides at least a portion of the collateral asset or digital asset to one or more computing devices for consideration. The one or more actions can include at least one of or any combination of: normalize, timestamp, aggregate, clean, analyze, tag, store, manipulate, denoise, process, enhance, organize, visualize, simulate, de-identify, pseudonymize, synthesize, summarize, replicate, productize, sell, store, assign, transfer, transform, provide, assign one or more terms to, or synchronize the animal data, or a combination thereof. In another refinement, at least a portion of the collateral asset or digital asset is used by the one or more computing devices to at least one of or any combination of: (1) create, modify, enhance, or evaluate one or more predictions, probabilities, or possibilities; (2) create, modify, enhance, or evaluate one or more wagers; (3) as a market upon which one or more wager are placed or accepted; (4) formulate one or more strategies; (5) create, modify, enhance, acquire, offer, recommend, or distribute one or more products, services, or benefits; (6) mitigate, prevent, or take one or more risks; (7) create, modify, enhance, or provide one or more targeted advertisements or promotions; or a combination thereof. In another refinement, intermediary server 22 includes one or more digital wallets for one or more stakeholders that enables the secure collection, storage, and transfer of one or more collateral assets, digital assets, or a combination thereof. The one or more targeted individuals may also have one or more digital wallets which can be accessed via computing device 20 (e.g., with storage occurring via cloud server 40) which can securely collect, store, and transfer one or more collateral assets, digital assets, or a combination thereof. In a refinement, the digital wallet can also securely collect, store, and transfer one or more other forms of consideration (e.g., other currencies) in addition to the one or more collateral assets, digital assets, or a combination thereof.

In some variations, the intermediary server removes at least a portion of identifiable information of the targeted individual from the animal data or its one or more derivatives (e.g., the animal data-based collateral asset or digital asset) and the animal data or its one or more derivatives (e.g., the collateral asset, digital asset) is provided to another one or more computing devices for consideration (e.g., the collateral asset or digital asset can be transformed to be anonymous or non-identifiable in nature). In other variations, the intermediary server provides the identifiable animal data via the collateral asset or digital asset related to the targeted individual to another one or more computing devices for consideration. In other variations, the intermediary server provides animal data or its one or more derivatives (e.g., at least one collateral asset or digital asset) that includes a combination of identifiable and de-identifiable animal data related to the targeted individual to another one or more computing devices for consideration. In a refinement, the collateral asset or digital asset is provided to another one or more computing devices for consideration.

In a refinement, at least a portion of the consideration provided by the stakeholder is repaid to the at least one stakeholder (e.g., data acquirer such as a loan company operating the intermediary server which has provided a loan using animal data as collateral) or associated stakeholder (e.g., group that acquires the rights to the loan from the stakeholder), the consideration being repaid either by the targeted individual (e.g., or their heirs, data assignees, data owner) or from at least a portion of the consideration received from the sale or distribution of the animal data-based collateral (e.g., including its one or more derivatives), or a combination thereof. In another refinement, repayment includes transferring at least a portion of the ownership rights of the animal data-based collateral asset to at least one stakeholder (e.g., data acquirer such as a loan company, video game company, fitness company, sports wagering company, healthcare company, insurance company, digital health company, and the like). In some cases, the intermediary server may retain at least a portion of the animal data (e.g., a copy of the animal data or de-identified animal data or a combination thereof; derivatives from the animal data such as the collateral asset or digital asset, or other derivative data) upon at least partial repayment of the consideration. In these cases, the retained animal data can be distributed (e.g., provided, made available) to another one or more computing devices for consideration. In another refinement, the retained animal data (e.g., de-identified animal data) is used by one or more computing devices to at least one of or any combination of: (1) create, modify, enhance, or evaluate one or more predictions, probabilities, or possibilities; (2) create, modify, enhance, or evaluate one or more wagers; (3) as a market upon which one or more wager are placed or accepted; (4) formulate one or more strategies; (5) create, modify, enhance, acquire, offer, recommend, or distribute one or more products, services, or benefits; (6) mitigate, prevent, or take one or more risks; (7) create, modify, enhance, or provide one or more targeted advertisements or promotions; or a combination thereof.

In one implementation of the invention, an insurance company can provide one or more insurance policies, quotes, or benefits in exchange for the one or more collateral or digital assets. The data provider (e.g., the targeted individual from whom the animal data is derived) can also use the animal data or its one or more derivatives as collateral for an insurance company to provide a more favorable insurance policy, quote, or benefit. In this example, the insurance company may require the individual to provide specified animal data (e.g., specified type, quantity, quality and the like from a specific source) as collateral to receive a favorable insurance policy, quote, or benefit. The insurance company may further require additional animal data for the duration of the policy or benefit (e.g., monthly animal data with specified characteristics provided in exchange for the favorable policy or benefit). If the insurance policy increases in price, the insurance company may require additional animal data from the individual in lieu of an increase in cash paid for the policy.

In some variations, the animal data-based collateral and consideration system operates utilizing distributed ledger technology such as a blockchain-based system or an IOTA Tangle-based system, or other ledger system. In one variation, the system can be configured to take the following steps to transform the animal data into a collateral or digital asset: (1) create a custom blockchain (or leverage an existing blockchain foundation and build on top of that); (2) create a sub-system for consensus mechanism to confirm and validate transactions; (3) optionally support permissions related to who can read, write in addition to being open to public; and (4) use animal data after evaluation, verification, and/or validation to create or mint one or more digital assets (e.g., coins, tokens) based on one or more preferences (e.g., user preferences, acquirer preferences, or a combination thereof) and/or previously granted rights. Characteristically, additional digital assets can be created based on future data contracts (e.g., digital assets that create an obligation to collect and provide future animal data in exchange for consideration). Note that there are many ways to create a digital asset using distributed ledger technologies and many variations of distributed ledger technologies can be used, and the invention is not limited to any particular type of distributed ledger technology used. The invention can be operable in both centralized and decentralized systems.

In a refinement, at least a portion of the one or more digital assets can be in a tokenized format created, modified, and/or distributed (e.g., sold) by the system. In some variations, it may be represented, distributed, acquired, and/or sold in the form of one or more non-fungible tokens (NFTs), which are one or more representations of the animal data in a digital tokenized format. The token has metadata that provides the information related to the animal data that verifies one or more parameters related to the authenticity of the animal data and the one or more rights granted as part of the token (e.g., ownership, license with one or more terms associated) and associated with the animal data (e.g., via the digital record) which creates its monetary value. Characteristically, each type of animal data associated with each targeted individual, each animal data set within each type of animal data, each animal data value within each data set, and the like (e.g., including derivatives) can be individually or collectively represented by one or more NFTs. In a variation, animal data in the form of one or more NFTs has associated metadata (e.g., attached metadata) that include one or more terms related to the acquisition, distribution, and/or use of the NFT-represented animal data. The metadata may also include information associated with one or more digital records related to the animal data (e.g., including chain of ownership information). In another variation, one or more digital records associated with the animal data may include information related to the acquisition or distribution of one or more NFTs that represent at least a portion of the animal data (e.g., information related to one or more transactions for the sale of NFTs that incorporate at least a portion of the animal data).

Advantageously, the one or more terms created for each animal data-based NFT, or group of animal data-based NFTs, may create unique value for each of the animal data-based NFTs (or group of NFTs). For example, there may be multiple NFTs featuring the same animal data with one or more different terms, such that one NFT may have a set of rules associated based on one or more terms (e.g., set by the one or more previous owners or users) that make the NFT more valuable than another NFT featuring the same animal data with another set of one or more terms (e.g., set by the one or more previous owners or users) that are more restrictive in their distribution or use. In a refinement, the uniqueness of the NFT (and therefore the value assigned to it) may be derived from animal data, the one or more rights associated with the animal data, or a combination thereof. Therefore, a targeted can create multiple NFTs featuring the same animal data but with one or more different terms attached (i.e., providing one or more different rules related to its acquisition, distribution, and/or use). The one or more different terms can create unique value for each NFT and enable the user to distribute (e.g., sell) the same animal data value(s), type(s), or set(s) multiple times. In another refinement, metadata (e.g., including contextual data) associated with the animal data can be represented, distributed, acquired, and/or sold in the form of one or more NFTs. Characteristically, the system via pricing engine 52 can be utilized to create or modify and assign one or more values (e.g., monetary values, non-monetary values) to the NFT-based digital asset. Additional details related to animal data-based NFTs are disclosed in PCT Application No. PCT/US22/11452 filed Jan. 6, 2022; the entire disclosure of which is hereby incorporated by reference.

In a refinement, the one or more tokens are at least one of or any combination of: a security token, an asset-backed token, a non-fungible token, or tokenized money. In another refinement, the system is operable to perform or enable asset tokenization to convert at least a portion of the animal data (e.g., including its associated metadata) into one or more digital assets. In another refinement, the system is operable to transform the at least a portion of animal data into one or more digital assets via asset tokenization. In another refinement, the system is operable to enable tokenized equity amongst one or more digital assets. In another refinement, the system is operable to perform detokenization to enable the token holder to exchange the token for the original data or assets comprising the token, at least in part.

In a refinement, the one or more tokens are fungible. For example, the system can create n number of tokens (1s, 10s, hundreds, thousands, millions, or more) that can provide access to a specific type of animal data with the same one or more terms (e.g., the same real-time data feed to sportsbooks). The system can be operable to enable the creation, modification, and/or sale of the one or more fungible tokens to one or more acquirers who desire the tokens in order to access the animal data. Pricing engine 52 can be operable to create one or more monetary values for the one or more tokens (e.g., fungible tokens), which can be dynamic in nature based upon demand (e.g., particularly in an auction scenario where individuals are bidding on access to the one or more tokens which provide them access to the desired data set(s). In another refinement, the one or more digital assets is a re-fungible token.

In a refinement, as new animal data (e.g., which includes additional animal data that was previously collected but not provided to the intermediary server) is gathered (e.g., collected, received), the one or more assigned monetary values can be modified. For example, new animal data gathered by the intermediary server can increase (or in some cases decrease) the associated monetary value of the animal data.

In some variations, the animal data-based collateral and consideration system enables the targeted individual to provide one or more preferences, the one or more preferences being utilized by the intermediary server, at least in part, to generate the one or more terms. The one or more terms may be provided to the intermediary server via computing device 20 (e.g., the targeted individual may provide one or more inputs via one or more programs or applications operating on the computing device), cloud server 40 (e.g., if the one or more preferences for the individual are stored in the cloud server associated with computing device 20), computing device 25 (e.g., if the preferences for the individual are included in their digital record), or a combination thereof. In a refinement, the one or more preferences include at least one of or any combination of: length of the term period (e.g., length of the loan term period), target consideration (e.g., loan) amount, repayment schedule, interest collateral, uses of the animal data (how the animal data can be used while being utilized as collateral or upon repayment of the loan), privacy preferences (e.g., use of anonymized vs identifiable animal data) interested services (e.g., potential services the individual would be interested in for targeted advertisements or promotions, which enabling such advertisements or promotions could increase the monetary value of their animal data and/or the consideration provided), interested products, interested benefits, habits, default provisions remedies, substitution of property, or method of consideration (e.g., loan) repayment. For example, a targeted individual with diabetes and one or more other attributes desirable to a pharmaceutical company may have a premium placed on their animal data by the intermediary server (e.g., via the pricing engine) if the targeted individual consents to enabling the pharmaceutical company to advertise to the targeted individual with specific products or services that may be suitable for the targeted individual based upon one or more characteristics or features of the targeted individual's animal data. In a refinement, in the event the targeted individual defaults on repayment of the consideration to the stakeholder (e.g., loan company), the stakeholder—via the intermediary server or other computing device in communication with the intermediary server—can sell the targeted individual's animal data (e.g., including at least a portion of personal identifiable information in some cases) to one or more third parties that can target one or more products, services, benefits, advertisements, or promotions to the targeted individual based upon their animal data. In a refinement, at least a portion of the ownership rights may transfer to the stakeholder based upon a default on repayment of the consideration.

In a refinement, the intermediary server provides consideration based upon animal data not yet received by the intermediary server. For example, in most cases, in the event the consideration is being provided as part of a loan, the one or more loans are secured with animal data already gathered. However, in some cases, the intermediary server may provide a loan based upon a targeted subject's agreement to provide future animal data. The intermediary server may take one or more actions to make one or more evaluations in order to generate the one or more terms (e.g., the system may create or have access to a data collection score related to the targeted individual or similar indices—this score may be based on the targeted individual's data collection history, their one or more attributes, the projected value of their future animal data, and the like—similar to how a company would look at a subject's credit score.). In another refinement, the stakeholder providing the consideration may operate one or more applications on the computing device associated with the targeted individual (e.g., computing device 20) in order to collect animal data to be used as the collateral.

In a refinement, the system is operable to broker one or more transactions for the exchange of consideration, at least a portion of the consideration being the distribution (e.g., sale, license) of future (i.e., not yet collected or not yet available for sale) animal data for one or more individuals (e.g., including groups of individuals) via one or more digital assets. For example, the system can be configured to enable an organization such as a sports organization to contract with another organization (e.g., a sports betting operator or media company), including the creation of one or more terms, for the collection and distribution of future animal data from a targeted individual or group of targeted individual in exchange for consideration. Characteristically, the system can be operable to create or modify and assign, or assign based on one or more inputs from the one or more users, one or more values (e.g., monetary values) for at least a portion of the future animal data via the pricing engine. In a refinement, the digital asset can include a license agreement which includes one or more obligations for one or more individuals to provide specified animal data in the future in exchange for consideration. Characteristically, at least a portion of the consideration can be received by the system or another computing device in communication with the system prior to the collection of the future animal data. In a variation, the system can be operable to create and assign one or more interest rates or default terms associated with the future animal data, wherein at least one of the one or more interest rates or default terms are in the form of additional animal data or its one or more derivatives being provided by the targeted individual to the data acquirer, a return of at least a portion of the consideration, an additional form of consideration (e.g., monetary interest payment), or a combination thereof. In a refinement, the at least one of the one or more interest rates or default terms includes a modification of the at least one of the terms associated with the acquisition of the digital asset by a data acquirer (e.g., volume of data owed, type of animal data or derivative owed, period of time in which the animal data is collected, and the like) to fulfill the interest or default obligation(s). In this variation, the system can notify any defaulting party (or administrator) of the one or more new obligations to collect or provide additional animal data based on the one or more terms associated with the interest or default. The system can be configured to enable at least one of the parties to consent to the new one or more terms generated by the system associated with the interest or default. In a refinement, the one or more new terms, the one or more value of the animal data or associated metadata being used as interest or as consideration for a default, or a combination thereof, can be derived (e.g., generated on the fly), at least in part, from the reference data.

In a refinement, the pricing engine creates or modifies one or more values based upon one or more risks (e.g., risk-based pricing). In this refinement, the system is configured to identify one or more risks, which can occur via one or more Artificial Intelligence techniques. For example, in the event there are one or more risks identified by the system related to the acquisition of future data (e.g., the system identifies that the type of data, volume of data, quality of data, or a combination thereof, to be acquired by a data acquirer in the future and paid for via consideration today may be challenging to acquire in light of the reference data and evaluation of one or more variables; an example may be an identification by the system that the individual collecting data during a specific activity from a specific sensor with specific sensor parameters will likely yield noisy data and therefore the individual will not be able to fulfill the one or more obligations based on the consideration provided), the system can dynamically adjust the current pricing for the acquisition of future data to account for the one or more risks. In this example, the system can be configured to offer one or more override functions that enable the data provider (e.g., digital asset owner) to maintain their desired level of pricing for the data. In another example, the system may identify that the individual collecting data during a specific activity from a specific sensor with specific sensor parameters will likely be a risk to the individual (e.g., a health risk to the individual or injury risk). Therefore, the system may present the one or more risks to the individual and provide one or more recommendations to the individual (e.g., a recommendation to increase the current pricing based on the evaluation of the one or more risks). In some variations, the system may present the risk to the individual (e.g., including their representatives, administrators, virtual representations, and the like) and the individual may have the ability to create or adjust the one or more values. In another example, a data acquirer may want to acquire a new data set from the data acquirer after it has acquired one or more data sets from the data provider. From the time the data acquirer acquired the data to the time the acquirer wants the new data set, the system may have identified one or more risks. In this scenario, the system can be configured to automatically adjust the price of the new data set to reflect the one or more risks (e.g., the system is triggered based upon the identification of risk to adjust the price dynamically). In some variations, such information related to the identification and evaluation of the one or more risks and how to price the data based upon the one or more risks can be derived, at least in part, from the reference data. In a refinement, the system can dynamically adjust the pricing/values (e.g., current pricing) for the acquisition of future data to account for the one or more risks.

In another refinement, the system is configured to create or modify one or more values (e.g., monetary values, non-monetary values) via the pricing engine based upon the future potential of one or more individuals (e.g., including one or more groups of individuals). For example, in the context of sports, the system can be configured to enable a data acquirer to acquire animal data from an individual athlete or group of athletes (e.g., a team or league of athletes). The system can be configured to allow for the one or more athletes or other users (e.g., their representatives, administrators, and the like) to create or modify a price for their data, or allow the system to create or modify a price for their data from which the system assigns one or more values or enables the athlete or other user to select the one or more created or modified values (or a combination thereof). In a variation, the system can be configured to allow for modifications related to the distribution of future consideration based upon one or more one or more milestones, with the system configured to enable the input (e.g., selection, manual input, automated selection, and the like) of one or more milestones by the one or more athletes/users, data acquirers, or a combination thereof. For example, the system may create and provide one or more values (e.g., price) for an athlete's animal data and associated metadata for an entire season and provide an additional one or more values to be paid by the data acquirer for the same animal data based upon achievement of a milestone (e.g., the player finishes the season ranked #1 in the world or wins a certain number of matches or the like). In another example, the system may create and provide one or more values (e.g., price) for an athlete's animal data and associated metadata for an entire season and provide an additional one or more values to be paid by the data acquirer for a different set of animal data based upon achievement of a milestone (e.g., the system assigns one or more values to future animal data captured during the playoffs and not regular season in the event a team of athletes makes the playoffs. The one or more associated values related to the future animal data can be tunable based upon one or more variables associated with the data or metadata, including type of data, volume of data, quality of data, and the like). In a refinement, the one or more milestones are monetary-based (e.g., revenue) milestones, upon which the system can enable one or more configurable revenue sharing models (e.g., modules) for a plurality of individuals or groups of individuals based upon the achieved milestone. For example, an athlete may sell their data (e.g., animal data, contextual data, digital asset, collateral asset, and the like) via the system to a data acquirer for a price of x value with a condition attached to the data that they receive an additional percentage of revenue from the data acquirer greater than a tunable threshold if the data acquirer sells their data for above the tunable threshold (e.g., above y value). In another refinement, the one or more milestones are animal data-based milestones (e.g., achieving a certain max heart rate, running a certain distance, burning a certain number of calories, and the like), meaning the system can be configured to enable an individual to receive additional consideration for their existing data upon achievement of a future animal data-based milestone. The additional consideration can be a tunable parameter that can be inputted (e.g., by the data acquirer, data provider, or a combination thereof) and agreed upon (e.g., via a smart contract or other agreement) via the system. In a variation, the system can be configured to enable the one or more values associated with an existing or future a data set (or derivative thereof) to by dynamically adjusted based upon achievement of an animal data-based milestone. In this variation, the system can enable the data provider, data acquirer, or a combination thereof, to input the one or more milestones, or the system can automatically create or modify and recommend the one or more milestones. In some variations, the system can automatically assign the one or more milestones to the data acquisition agreement between the data provider and data acquirer, which can be changed via an override function by the data acquirer, data provider, or both. In another refinement, the system utilizes one or more Artificial Intelligence techniques to evaluate the risk or “potential” associated with one or more individuals (or groups of individuals). For example, the system can be configured to evaluate whether an athlete has the potential to achieve a milestone (e.g., become top 10 in the world; scores more than 40 points in a game; throws for over 300 yards in a game; achieve a heart rate over 200 during a competition; and the like) and can create or modify one or more values based upon the one or more evaluations.

Still referring to FIG. 1, the system can be configured to create or modify and assign one or more possible values (e.g., monetary values such as prices based on any given currency; non-monetary values such as one or more goods or services—or combinations thereof—for exchange) for any given data set (e.g., including unit(s) of data and derivatives such as collateral assets and/or digital assets) for the purposes of exchanging the one or more data sets (or its one or more derivatives) for consideration via pricing engine 52. In a refinement, the system can be configured to recommend one or more possible values for any given data set for the purposes of exchanging the one or more data sets (or derivatives) for consideration via pricing engine 52. In another refinement, the pricing engine is configured to create and assign, or modify and assign, one or more monetary values for a subset of data (e.g., each data type, a data set within a larger data set; an animal data set without its metadata; the metadata without its animal data) amongst a plurality of data that comprise the collateral asset or digital asset. In a refinement, the term “plurality of data” includes data that can be derived from a single animal or multiple animals and from a single period of time or multiple periods of time during a single event or multiple events. For example, the pricing engine can create and assign a monetary value for each type of data that comprise a collateral asset. This can include a monetary value for the one or more types of animal data, a separate monetary value for the metadata, a separate monetary value for the contextual data (if not considered part of the metadata), a separate monetary value for one or more other assets included as part of the collateral asset or digital asset, and the like. Characteristically, the pricing engine can be configured to create or modify multiple monetary values for the same subset of data based upon other data associated with it. For example, the pricing engine may generate one monetary value for a subset of data with one type of contextual data associated with it, and generate another monetary value for the same subset of data with another type of contextual data associated with it. This may be advantageous for an individual to understand the value of the one or more animal data sets in the context of other data sets or individually.

In another refinement, the system is configured to generate and present (e.g., via one or more display devices) one or more possible, recommended, or best values (e.g., monetary values such as prices; non-monetary values such as goods or services) based on the historical sale of similar or dissimilar data and data trends. The data owner (and in some variations, the data acquirer, or both) then can either accept the one or more possible, recommended, or best values or input one or more changes to suggest one or more alternative values (e.g., function that rejects the one or more prices and enables a user to input one or more new prices to then be accepted or rejected by the other party). This back- and forth-between data owners and data acquirers can be facilitated by the system. Characteristically, the creation of one or more new values by the system can occur dynamically as new data or information is gathered or derived by the system (e.g., an event occurs which is recorded or observed by the system).

Still referring to FIG. 1, the system can be configured to generate optimal values (e.g., optimal pricing or best/recommended pricing) for an asset via the pricing engine based on analysis of previously gathered data (e.g., reference data). In a refinement, the analysis includes at least one variable (e.g., one or more data owner preferences, one or more data acquirer preferences, previously established terms associated with the asset, and the like). In another refinement, the pricing engine is configured to create and assign, or modify and assign, one or more values (e.g., monetary values, prices, goods or services for exchange) for a subset of one or more assets amongst a plurality of assets that comprise the collateral asset or digital asset. In one variation, the one or more assets include at least a portion of animal data. In another variation, the one or more assets include at least a portion of non-animal data. In another variation, the one or more assets include at least a portion of animal data and non-animal data. In some variations, the pricing engine (e.g., via the intermediary server or computing device in communication with the intermediary server) can select an assigned monetary value from a plurality of assigned monetary values associated with the asset (e.g., the collateral asset, digital asset). Selection can occur based upon the system using at least a portion of the reference data as reference information to determine the optimal monetary value to select (e.g., if multiple monetary values exist, with “optimal” meaning the monetary value that enables the data acquirer to receive the most consideration, or the monetary value that the individual is most likely to accept, and the like). In a refinement, selection can occur via one or more AI-based techniques. In another refinement, selection can occur based upon one or more inputs from the data acquirer. In another refinement, selection can occur based upon one or more inputs from the targeted individual (e.g., establishing a range or minimum threshold related to the value of their data).

In another refinement, the pricing engine can be configured to automatically modify one or more values (e.g., monetary values; non-monetary values or consideration equivalents) for one or more data sets (e.g., animal data, its associated contextual data, other data) based upon the occurrence of one or more events. The one or more events can be, for example, a condition (e.g., medical condition) or change occurring to the individual (e.g., a person may develop diabetes). In a variation, the pricing engine can be configured to create dynamic values (e.g., pricing or consideration equivalents) for the at least a portion of the animal data and associated metadata, or its one or more derivatives (e.g., computed asset, digital asset). Characteristically, the value (e.g., pricing) for any given data set can be static initially but can fluctuate based on one or more tunable parameters (e.g., such as the type of metadata/contextual data being gathered with subsequent animal data). For example, if an individual has high blood pressure, their animal data may have a value of x but over time if the individual develops diabetes, the monetary value of their animal data may change. In this scenario, the pricing engine can maintain, or have access to, the relevant information required to make the one or more modifications in pricing. In a refinement, the pricing engine can also be configured to generate one or more monetary values related to the value of any given data set (e.g., including units of data) based upon one or more tunable parameters that can be inputted by the individual, the data acquirer, or automatically generated by the system. For example, in some variations the system can be operable to generate one or more monetary values for any existing data set (e.g., including units of data) or derivatives, future data set to be collected by the individual, or a combination thereof, based on one or more future changes to the individual's health (e.g., if the individual develops diabetes, has a heart attack before the age of x, has a stroke after the age of y, and the like), one or more parameters related to the sensor and/or the data (e.g., what type of sensor is being used, the settings associated with the sensor), the type of data being collected (e.g., animal and non-animal data), duration of the data collection period, activity, one or more sensors, one or more sensor parameters, environmental conditions, achievement of a threshold or milestone within the data collection period, placement of one or more sensors, body composition of the targeted subject, data quality, frequency (e.g. how often data is collected), size of data set, or a combination thereof. The one or more tunable parameters can be selected via one or more inputs via one or more display devices or selected automatically by the system (e.g., based upon the one or more characteristics of the individual, such as their health traits which inform the system of their likelihood to have a health condition in the future), which can be communicated to the targeted individual or data acquirer. In a refinement, one or more external systems (e.g., electronic medical record system or another hospital/clinic/individual health record system) that has one or more editing permissions and is a single source of truth (SSOT) for an individual may select, edit and/or tune one or more of the tunable parameters automatically.

In a refinement, the system can be configured to automatically initiate one or more actions (e.g., an invoice or request for payment automated by the system; automatic charging of payment by the system on behalf of the data owner; creation of one or more agreements) for the individual to receive additional consideration from the one or more data acquirers based upon the occurrence of the one or more events (e.g., prior to having diabetes, a person's animal data value was x; now that the person has developed diabetes, the value of their data set is y). Characteristically, the one or more agreements (e.g., smart contracts) implemented by the system can enable the data owner to automatically receive more consideration based upon one or more future occurrences of one or more events and obligate the data acquirer to provide more consideration for a data set they have already acquired. In this scenario, the system can be operable to predict one or more future monetary values based upon the possibility of one or more future occurrences in order to provide a range of monetary value(s) for the animal data and its associated contextual data to the data acquirer based upon the one or more future events. For example, a data acquirer may agree to acquire an individual's data set for x price; however, the agreement may contemplate scenarios where the individual develops one or more medical conditions or experiences one or more changes, which would make the existing value of the data set y. In that scenario, the system can be configured to predict—via one or more Artificial Intelligence techniques—what the future y monetary value of the one or more data sets can be based upon any given condition or change in any given scenario, enable the data acquirer to pay x but automatically pay y if the individual develops the condition in that given scenario. In a refinement, the system can be configured to verify the individuals' one or more conditions or changes prior to initiating the y payment for the additional consideration, or predict the likelihood of the individual developing the one or more conditions based upon their previously collected animal data and their one or more associated characteristics (e.g., age, weight, height, medical history, and the like).

In a refinement, the pricing engine is configured to predict one or more values for existing data (e.g., data that has been collected or generated) for one or more use cases based upon one more tunable parameters. The one or more tunable parameters can include, but are not limited to, industry (e.g., healthcare vs insurance vs sports vs medial research and the like); territory/geography (e.g., the counties or territories the animal data will be used in); the use cases for the data (e.g., how the data will be used; uses of data); exclusivity (e.g., exclusive vs non-exclusive), length of use (e.g., the data may be acquired for a defined period of time with one or more rights related to the data terminating at the expiry of the time period rather than acquired for an indefinite period of time); and the like. In another refinement, the pricing engine is configured to predict one or more values for data that has not yet been collected or generated for one or more use cases based upon one or more tunable parameters.

In some variations, the system is operable to enable alternative revenue models related to each of the collateral assets or digital assets, subset of assets, or all assets. For example, the system can offer one or more subscriptions to one or more data acquirers for one or more addendums (e.g., additions, changes) related to the data (e.g., updates to the animal data, such as new contextual data being offered with the existing animal data, or new data being collected to provide a richer data set). In this example, the system enables the targeted individual to receive additional consideration based on the terms of the one or more subscriptions.

Still referring to FIG. 1, the system can be configured to automate the creation, modification, and execution of one or more agreements between the data acquirer and data owner and facilitate the exchange of consideration. In a refinement, the system can act as an intermediary payments system (e.g., consideration system) which brokers the exchange of consideration between the one or more data owners (e.g., targeted individuals if they own their data) and the one or more data acquirers. In this scenario, the system can be configured to automate the creation or modification of one or more contracts, automate the one or more monetary or non-monetary based transactions (e.g., for consideration), validate that the data acquirer has the required consideration to acquire the data sets now and in the future in the event the value increases based upon the one or more changes or conditions, validate the one or more assets being acquired (e.g., digital assets), and the like. In some variations, the system can be configured to enable the data acquirer to customize their acquisition of data so that any future increase in consideration required for a data set being acquired in the present is based upon the data acquirer selecting the one or more conditions or changes in which the acquirer will agree to pay additional consideration in the future.

In this scenario, the system can be configured to support user preferences and the individual can agree or not agree to provide their one or more data sets based upon the one or more selections by the data acquirer. In a variation, the system can be operable to enable a data acquirer or data owner (or both) to set one or more parameters (e.g., pricing limits, pricing floors) related to the current and future acquisition cost of the one or more assets. In another variation, the system can automatically agree or not agree to broker the exchange of consideration based upon the one or more selections by the data acquirer. In this scenario, the operator of the system may retain at least a portion of the consideration of any future consideration received.

In a refinement, the system can be configured to accept one or more thresholds or ranges of acceptable values (e.g., pricing) based on which system can engage with data acquirers for straight sale or auction (e.g., enable one or more actions from data acquirers such as bidding) for any given data set. In another refinement, the system can be configured to accept one or more thresholds or ranges of acceptable values (e.g., pricing) based on data usage or type of entity acquiring (e.g., buying) the data. For example, an individual may accept selling their data to one party (e.g., research institution) at a lower value (e.g., price) than a for-profit commercial entity. In another refinement, the system can be configured to accept one or more discounted rates for data or bulk pricing for data, with the one or more discounts being determined based upon one or more inputs from the data acquirer or based upon previously-sold data and associated trends as determined by the system based upon the reference data.

In a refinement, the system can be configured to offer for sale one or more subscription packages for data that provides all or a subset (e.g., subscribed subset) of updates, changes or adjustments to any contextual data related to the original data set purchased. In another refinement, the system can be configured to offer for sale one or more subscription packages for data that provide all future data collected by the individual or plurality of individual. In another refinement, the system can be configured to offer for sale a subscription package for all contextual changes and future data collected by the individual or plurality of individuals.

In some variations, the animal data or its one or more derivatives are acquired for a defined period of time, with one or more rights (e.g., the one or more rights associated with the data and granted to the data acquirer as part of the acquisition of data for consideration) being terminated based upon the expiry of the time period. In a refinement, the acquired data or its derivative (e.g., digital asset) may be acquired by the data acquirer based upon one or more milestones (e.g., the digital asset comprised of the animal data is purchased by the acquirer from the data provider and is exclusively the possession of the data acquirer until the data acquirer is able to achieve a revenue-related milestone, upon which the animal data or its derivative can be distributed to other acquirers for consideration. In this example, the original digital asset may be replicated or one or more new digital assets may be created after achieving the milestone, with the one or more new digital assets being verified and authenticated by the system based upon the one or more rights associated with the data).

Still referring to FIG. 1, the system can be configured with one or more notification tools that automate one or more notifications related to both the individual and data acquirer (e.g., the data acquirer may be notified that the individual has developed a condition and therefore the value of the existing data set they have already acquired has increased; the individual may or may not be notified that the value of their data has increased depending on the configuration of the system). The system can also be configured to enable auditing capabilities for the data acquirer, revenue reconciliation mechanisms, reporting, and other features and tools common with data and digital currency-based marketplaces and other monetization platforms.

In a refinement, the system is operable to notify one or more data acquirers (e.g., via one or more computing devices) based on one or more changes to the value (e.g., monetary) associated with the collateral or digital asset. For example, an acquired digital asset may change in value (e.g., increase) if there is a change associated with the targeted individual or group of targeted individuals, or their associated animal data, from whom (or which) the animal data associated with the digital asset is derived from. For example, the targeted individual may have developed a rare medical condition which may increase the value of the digital asset; the system may have gathered new contextual data associated with the animal data that comprises the digital asset which can increase the value of the digital asset; and the like. In this example, the system can modify the digital asset that enables the digital asset to be exchanged for new consideration in its modified form, such as setting the price for the additional contextual data and the associated one or more terms. In a refinement, one or more new digital assets are created based upon the new data collected or derived (e.g., animal data, metadata, derived insights) and included as part of the original digital asset. In this refinement, the system can create a price for the one or more new digital assets, enabling an aggregate price to be offered for the digital asset or prices for each or a subset of assets within the digital asset. In this refinement, a data acquirer can purchase at least one of the digital assets that comprise the original digital asset (e.g., leading to fractional ownership of the original digital asset and whole or partial ownership of the original digital asset subset(s)).

In a refinement, the system can be configured to track one or more terminations, expirations, or definable time periods related to the distribution of data as established by the data owner, the data acquirer, the system, or a combination thereof. For example, the system can be configured to enable the data owner to establish one or more preferences related to a future distribution of their data (e.g., a data owner may determine that the value of their animal data or its derivatives changes after certain type of future data is collected, or they put more restrictions on the data sale or stops the system from selling their data upon the occurrence of an event; a data owner may specify a time period where they do not want any sale of their data; a data owner may specify a time period where his data is on sale; a data acquirer may provide a defined time period when they'll pay a specific price for a given data set; and the like).

In a refinement, the reference data can be utilized by the intermediary server to create or modify and assign one or more pricing models via the pricing engine, or modify one or more assigned pricing models via the pricing engine, for the collateral asset based upon the one or more evaluations, verifications, validations, or a combination thereof. In another refinement, the one or more pricing models recommend (e.g., via the pricing engine) one or more static prices, variable prices, or dynamic prices for the collateral asset. In many variations, the one or more recommendations become the assigned value for the collateral or digital asset (e.g., price) based on one or more variables (e.g., a user has a preference set or has agreed to accept a price above a certain threshold or in a range [x,y]; the system assigns a value based upon an evaluation of similar and dissimilar data sets and terms based on the reference data, and the like). In another refinement, the one or more static prices, variable prices, or dynamic prices change (e.g., for the animal data, its associated metadata, its one or more derivatives, or a combination thereof) as new data or information is gathered or derived by the system.

Characteristically, the intermediary server can utilize one or more Artificial Intelligence techniques (e.g., machine learning, deep learning, statistical learning) to take one or more actions, the one or more techniques including one or more models, methods, and the like. In a refinement, the one or more actions include: (1) the one or more evaluations, verifications, validations, or a combination thereof; (2) the creation and assignment one or more monetary values, or the modification of the one or more assigned monetary values, for the at least a portion of animal data; (3) the generation of the one or more terms; (4) the providing of consideration in exchange for the collateral (e.g., including one or more rights associated with or related to the collateral); (5) the monitoring and use of animal data based upon the one or more terms; or (6) a combination thereof. For definition purposes, Artificial Intelligence includes machine learning, deep learning, and the like. For example, by utilizing one or more Artificial Intelligence techniques such as machine learning techniques, the system can take one or more actions, the one or more actions including at least one of or any combination of: normalize, timestamp, aggregate, clean, analyze, tag, store, manipulate, denoise, process, enhance, organize, visualize, simulate, de-identify, pseudonymize, synthesize, summarize, replicate, productize, sell, store, assign, transfer, transform, provide (e.g., distribute, send), assign (e.g., one or more terms to), or synchronize (e.g., the reference data), the animal data-based collateral (including its associated metadata) or other animal data being evaluated, verified, and/or validated as a collateral asset or digital asset, or a combination thereof, from the one or more sources of animal data to (1) evaluate, verify, validate, or a combination thereof at least a portion of the animal data, associated metadata, reference data, or a combination thereof; (2) create and assign one or more monetary values, or modify one or more assigned monetary values, for the at least a portion of animal data; (3) generate one or more terms; (4) provide consideration in exchange for one or more collateral assets or digital assets, (5) distribute the animal data; (6) monitor the animal data, or (7) a combination thereof. In a refinement, the one or more Artificial Intelligence techniques can be utilized to create, modify, or enhance one or more evaluation assets which enable, enhance, or are utilized as part of, the one or more actions. Characteristically, the one or more creations, modifications, or enhancements may occur (e.g., dynamically) in real-time or near real-time. For definition purposes, “near real-time” means any one of the steps or output is not purposely delayed except for necessary processing by the sensor and/or any computing device (e.g., including associated models, algorithms, and other computing processes) associated with any embodiments of the invention.

In the case of machine learning-based techniques (e.g., including deep learning), given that machine learning-based systems are set up to learn from collected data rather than require explicitly programmed instructions, its ability to search for and recognize patterns in and across one or more data sets (e.g., cross-reference animal data with reference data and find patterns that enable the system to identify similar characteristics), some of which may be hidden within the one or more data sets, enable machine learning and other AI-based systems to uncover insights from the animal data that allow for the one or more actions to occur. This approach also enables each targeted individual and their animal data to be evaluated, verified, and/or validated as collateral or as a digital asset based upon the one or more unique characteristics of the individual and/or their animal data, as well as allows for customized monetary values and terms. Advantageously, because machine learning-based systems use data to learn, it oftentimes takes an iterative approach to improve model prediction and accuracy as new data or preferences enter the system (e.g., preferences established by the user for how the data can be used or preferences related to the one or more terms), as well as improvements to model prediction and accuracy derived from feedback provided from previous computations or observations made by the system (which also enables production of reliable results). In such a scenario, new animal data from the one or more sources, as well as new reference data entering the system at any given time, enables a new, deeper understanding of the user and potential outcomes based upon a broader set of data.

In a refinement, the one or more actions taken by the system utilize at least a portion of artificial data. Artificial data (e.g., artificial data values) can be derived from one or more simulated events, concepts, objects, or systems, and can be generated using one or more statistical models or Artificial Intelligence techniques. Advantageously, artificial data can be used to predict future biological outcomes for any given targeted individual based upon one or more characteristics related to the targeted individual, the one or more sensors, or the animal data (e.g., the activity in which the animal data was collected). In this regard, the artificial data can be utilized to predict the likely outcome of any given individual, which can impact the one or more monetary values placed on an individual's animal data (e.g., an individual who may experience more medical issues in the future may have data that is worth more monetarily), the likelihood of the targeted subject's ability to collect data in the future (e.g., if the collateral is based on future data collection. For example, if it is predicted that the individual is likely to die in the near term, the system may not offer an option to pay back a future loan with animal data based upon the subject's predicted inability to collect future data), and the like. In a refinement, the system may utilize at least a portion of the animal data-based collateral as training data for one or more Artificial Intelligence-based techniques in order to generate artificial data sets. In another refinement, the system may run one or more simulations utilizing at least a portion of the animal data-based collateral to generate simulated data that enable the creation or modification one or more predictions, probabilities, or possibilities.

In another refinement, the system can be operable to generate artificial data values to replace missing or outlier values in any given data set to create a more complete or accurate data set, or increase the quality of the data set. The system may factor in its ability to create one or more values to replace missing or outlier values to make a data set more valuable in its creation or modification of the one or more monetary values. For example, the system may determine that it is able to add value to any given animal data set in order to make it a more complete (and/or more accurate) set of data, thereby increasing its value as a collateral or digital asset, its resale value, and/or utility, which may be factored into the one or more monetary values created or modified by the system. In many cases, the one or more sensors produce measurements that are provided to a computing device, with the sensor or server applying methods or techniques to transform the data (e.g., filter the data, manipulate the data, and the like) and generate one or more animal data values (e.g., ECG values, HRV values, respiration rate values, glucose values, mobility values, biomechanical data-based values, and the like). However, in cases where data has an extremely low signal-to-noise ratio, or in some cases when one or more values are missing or outlier values exist, pre-filter logic may be required to generate artificial data values. In one aspect, a pre-filter method whereby the system takes a number of steps to “fix” the data generated from the sensor to ensure that the one or more data values generated are clean and fit within a predetermined range is proposed. The pre-filter logic would ingest the data from the sensor, detect any outlier or “bad” values, replace these values with expected or “good” artificial values and pass along the “good” artificial values as its computation of the one or more animal data values (e.g., heart rate values). The creation or modification of the one or more values may occur via one or more simulations which generate the artificial data (e.g., the simulation may predict what the individual's animal data “should do” or “will do” in modeled scenarios in order to determine the one or more values). The term “fix” refers to an ability to create one or more alternative data values (i.e., “good” values derived from artificial data) to replace values that may fall out of a preestablished threshold, with the one or more “good” data values aligning in the time series of generated values and fitting within a preestablished threshold. These steps would occur prior to any logic taking action upon the received animal data to calculate the one or more animal data values (e.g., heart rate values). Advantageously, the pre-filter logic and methodology for identification and replacement of one or more data values can be applied to any type of sensor data collected, including both raw and processed outputs. Such a method is advantageous if the system is evaluating animal data to be used as collateral or as a digital asset for consideration and is able to create one or more artificial data values to create a more complete or accurate data set, or increase the quality of the data set, thereby increasing the value and utility of the data set. One or more Artificial Intelligence techniques may be utilized to identify one or more trends or outlier/missing values in the data, generate artificial data values, and include artificial data in one or more animal data sets. In a refinement, the system can create a monetary value for animal data (e.g., including its one or more derivatives which can include its derived one or more collateral or digital assets) that includes at least a portion of artificial data. In another refinement, the system may create or modify different monetary values for the same animal data with one or more new variables introduced in at least one of the creations or modifications that lead to the difference (e.g., one monetary value assigned to an animal data set includes artificial data to complete the data set and another monetary value assigned to the same animal data set does not). Advantageously, the system can create the one or more alternative monetary values which introduces one or more new variables to derive the one or more alternative monetary values without providing the information to the user (e.g., targeted individual).

In another refinement, the one or more Artificial Intelligence techniques includes the use of one or more trained neural networks. In general, a neural network generates simulated animal data after being trained with real animal data and other contextual data (e.g., metadata, reference data, outcome data). Animal data is collected from one or more sensors or other computing devices that enable procurement of animal data-based information (e.g., health records, medical records) from one or more target individuals typically as a time series of observations. Sequence prediction machine learning algorithms can be applied to predict possible animal data values based on collected data. The collected animal data values and associated contextual data will be passed on to one or more models during the training phase of the neural network. The neural network utilized to model this non-linear data set will train itself based on established principles of the one or more neural networks. In another refinement, the one or more trained neural networks utilized consist of one or more of the following types of neural networks: Feedforward, Perceptron, Deep Feedforward, Radial Basis Network, Gated Recurrent Unit, Autoencoder (AE), Variational AE, Denoising AE, Sparse AE, Markov Chain, Hopfield Network, Boltzmann Machine, Restricted BM, Deep Belief Network, Deep Convolutional Network, Deconvolutional Network, Deep Convolutional Inverse Graphics Network, Liquid State Machine, Extreme Learning Machine, Echo State Network, Deep Residual Network, Kohenen Network, Support Vector Machine, Neural Turing Machine, Group Method of Data Handling, Probabilistic, Time delay, Convolutional, Deep Stacking Network, General Regression Neural Network, Self-Organizing Map, Learning Vector Quantization, Simple Recurrent, Reservoir Computing, Echo State, Bi-Directional, Hierarchal, Stochastic, Genetic Scale, Modular, Committee of Machines, Associative, Physical, Instantaneously Trained, Spiking, Regulatory Feedback, Neocognitron, Compound Hierarchical-Deep Models, Deep Predictive Coding Network, Multilayer Kernel Machine, Dynamic, Cascading, Neuro-Fuzzy, Compositional Pattern-Producing, Memory Networks, One-shot Associative Memory, Hierarchical Temporal Memory, Holographic Associative Memory, Semantic Hashing, Pointer Networks, Encoder-Decoder Network, Recurrent Neural Network, Long Short-Term Memory Recurrent Neural Network, or Generative Adversarial Network.

In a refinement, consideration for the animal data-based asset (e.g., collateral asset, digital asset) is provided in the form of one or more economic units (e.g., that function as a medium of exchange). In another refinement, consideration for the animal data-based collateral is provided in the form of one or more economic units (e.g., that function as a medium of exchange) that enable the targeted individual or their assignees to place one or more wagers using their animal data as collateral or acquire one or more assets (e.g., digital assets), products, services, or benefits using their animal data as a form of digital currency. In a variation, the system enables the targeted individual or their assignees to (1) place one or more wagers (e.g., sports bets or wagers) using their animal data-based digital asset as collateral or to acquire other consideration (e.g., the digital asset can act as a digital token or coin with an associated monetary value to place a bet to win other consideration, which may be one or more digital assets), or (2) acquire one or more assets (e.g., other digital assets, fiat currency), goods/products, services, or benefits using their animal data-based digital asset as collateral or as a digital asset to acquire such consideration. In a refinement, such wagers or acquisition of one or more assets, products, services, or benefits can occur as part of a sports wagering system (e.g., sports betting) or in a video game or game-based system (e.g., mixed reality system, augmented reality system, virtual reality system). For example, one or more targeted individuals can utilize at least a portion of their animal data as a collateral asset or digital asset in exchange for an opportunity to acquire consideration, such as an ability to obtain virtual items within a video game or virtual environment in exchange for their animal data-based digital asset (e.g., coin, token, trading card), or leverage their one or more assets (e.g., collateral asset) to place bets to win additional consideration (e.g., win cash, more tokens, more lives, a benefit in the game if the individual wins the bet; lose the collateral asset or at least a portion of the rights if they lose the bet). In this example, the system may provide one or more digital assets associated with the game or wager (e.g., token, coin) in exchange for the individual's one or more digital assets in order for the individual to place the bet or participate to win the chance to receive additional consideration. In some variations, the consideration may be provided based upon the collateral, with the collateral available to be utilized by the animal data-based collateral and consideration system based upon one or more outcomes (e.g., the system may provide tokens or a benefit within a video game in exchange for one or more rights to at least a portion of the individual's animal data or derivatives based upon one or more outcomes. In a variation, the animal data may only be utilized by the system—e.g., commercialization purposes—or the system may obtain a right such as ownership in the data if a certain outcome occurs—e.g., the individual loses the game or doesn't achieve a specific milestone).

In a refinement, the collateral asset or digital asset can include rights to or access to a targeted individual's one or more social media accounts (e.g., the loan can be against the social media account and/or the targeted individual's one or more attributes whereby rights to the targeted individual's one or more attributes—e.g., image, likeness, activities—are used as collateral against the loan). In this example, the social media account would include animal data (e.g., image, likeness), and the one or more evaluations would include popularity (e.g., number of followers or engagements), current revenue based, future revenue potential based upon the one or more accounts, and the like.

In a variation, the intermediary server can access one or more computing devices that make the animal data of the targeted individual available or accessible, the intermediary server conducting one or more evaluations, verifications, or validations of the animal data, the result of the one or more evaluations, verifications, or validations of the animal data being an offer to acquire at least a portion of the animal data as collateral in exchange for consideration. The consideration can be in the form of one or more economic units (e.g., cash, one or more tokens, tangible property, intangible personal property, services, goods, products, benefits and the like). For example, the animal-data based collateral and consideration system can access an individual's animal data, conduct one or more evaluations, verifications, and/or validations, assign one or more monetary values to the animal data, and provide consideration (e.g., one or more economic units such as tokens or credits within a video game; products, services, or other benefits) in exchange for access to the individual's animal data as collateral for the consideration distributed (e.g., heart rate data doing a specific activity for the last 120 days). Characteristically, the system can offer a product, service, or benefit (e.g., monetary or non-monetary) as consideration for access to at least a portion of the data. In a refinement, the one or more rights related to the collateral may be provided to the stakeholder-based upon one or more outcomes related to the one or more economic units, products, services, or benefits provided.

The animal data-based collateral and consideration system enables a user—via one or more instructions provided by the user via one or more computing devices such as computing device 20 to another computing device such as intermediary server 22 or cloud 40 (which then communicates with intermediary server 22)—to provide (e.g., submit, upload, send, make available) their animal data for evaluation, verification, validation, or a combination thereof. The providing of animal data may occur immediately (e.g., provided via a single transfer) or over time (e.g., the user grants permission for the system to access various data repositories to access and evaluate the data). Upon gathering the data, the system can provide feedback related to the animal data as well as the associated monetary value (via the pricing engine, which will utilize the information gathered from the one or more evaluations, verifications, or validations to create/determine one or more monetary values). In a refinement, the system can also provide feedback related to at least one characteristic of the animal data (e.g., data quality, completeness, the value of one metric vs another, and the like) to improve the at least one characteristic of the animal data in order to increase the value of the animal data set. For example, if the system identifies a deficiency in one of the animal data characteristics (e.g., the data is low quality or an insufficient amount of data has been provided), the system can provide information to the user to improve the one or more characteristics to increase the monetary value. The system may also recommend one or more types of contextual data to the user such as sensors, animal data types or inputs, data collection duration, activities in which to collect animal data, sensor parameters (e.g., sensor type, sensing type, sensor model, firmware information, sensor positioning on or related to a subject, operating parameters, sensor properties, sampling rate, mode of operation, data range, gain, etc.), frequency (e.g., of the data collection period), and the like, in order to establish or increase the value of any given data set.

In a refinement, the one or more monetary values are created and assigned, or modified and assigned, for one or more animal data sets not yet gathered by the intermediary server or the targeted individual based upon the one or more evaluations, verifications, validations, or a combination thereof. For example, the system may be aware of the value of any given data set form an individual with any given set or combination of characteristics and any given contextual data based upon previously gathered information. In a variation, the intermediary server provides one or more instructions to the targeted individual (e.g., via computing device 20), the one or more sensors, or a combination thereof, either directly or indirectly (e.g., via one or more computing devices), to gather the one or more animal data sets to be used as collateral or as a digital asset for consideration (i.e., future data sets), the one or more instructions include at least one of or any combination of: type of data (e.g., animal and non-animal data; raw or processed data), duration of the data collection period, activity in which the data is collected, one or more sensors or computing devices used to collect data, one or more sensor or computing device parameters, environmental conditions, time (e.g., time of day, duration), bodily condition (e.g., tired vs rested; pre-treatment vs post-treatment), context (e.g., achievement of a threshold or milestone within the data collection period), placement of one or more sensors, body composition of the targeted subject, data quality, frequency (e.g. how often data is collected), volume/size of data set, rating or other indices (e.g., how other acquirers rate the data set(s) or the individual; completeness of a data set; noise levels within a data set), or a combination thereof.

In some variations, upon the user providing the animal data as collateral for consideration or as consideration for other consideration, the data (e.g., the collateral asset, digital asset) can be stored or transferred to another computing device (e.g., cloud server) to be stored. In some cases, the data may be utilized by the animal data-based collateral and digital currency consideration system as training data for one or more Artificial Intelligence-based models to create one or more products, prediction models, and the like, or utilized to create one or more products, services, or benefits.

In a refinement, the targeted individual utilizes at least a portion of the animal data as collateral or as a form of digital currency to acquire other consideration, the system providing consideration to the targeted individual to acquire the at least a portion of animal data (e.g., which includes its one or more derivatives, such as a collateral or digital asset) and distributes (e.g., sells, provides) the at least a portion of animal data to one or more computing devices (e.g., one or more third parties). In many variations, the one or more monetary values provided to the targeted individual in exchange for the collateral asset (e.g., collateral animal data) or digital asset are different from the actual monetary value generated or derived from the animal data based upon its distribution or use by the system. Characteristically, the system (e.g., or the one or more stakeholders) can create one or more arbitrage opportunities by creating one or more monetary values for the animal data that may be different (e.g., less) than the true monetary value of the animal data, thereby providing consideration to the targeted individual while enabling the system to distribute the animal data any number of times to one or more computing devices for consideration (i.e., at a profit or markup). Such opportunities may occur simultaneously, concurrently, in succession, or over time. For example, an individual may utilize one or more future rights related to their animal data to receive a loan or other immediate consideration (e.g., cash) from the system (e.g., the individual is selling future revenue from their animal data for immediate revenue from their animal data, whereby the system values the animal data as n, and the system provides consideration to the individual as n minus tunable percentage of n in order to generate a profit). In this case, the system can acquire the animal data and conduct one or more evaluations, verifications, and/or validations related to the targeted individual and animal data, the one or more evaluations, verifications, and/or validations being utilized by the pricing engine to generate one or more monetary values for the animal data (e.g., a monetary value in terms of the price it will pay the individual for their data, and a monetary value in terms of what the data is worth, a monetary value in terms of what the data could sell for, and the like. Note that these monetary values may be different). Characteristically, given the system's access to monetary values associated with other animal data and other evaluations, verifications, and validations for reference data, the system can in some cases quantify the full monetary value potential of the animal data given that it can be operable to quantify the animal data's monetary value as an individual data set, as part of a group of other data from the same individual or group of individuals, in raw or processed format, based upon its one or more derivative values, incorporation of simulated data, potential use cases and uses of data, and the like, all in the context of the one or more terms which could be associated with the use of the animal data (e.g., either via the acquirer or the one or more targeted individuals), which the system can identify and value (monetarily) on a per-term of multi-term basis (e.g., the system can derive a plurality of monetary terms based upon a plurality of scenarios featuring different data sets and different terms associated with each data set). This enables the system to quantify all potential distributions of the animal data to one or computing devices, the animal data's use in one or more products (e.g., used as training data to create products), and the like prior to generating or distributing the one or more monetary values that the system would provide as consideration to the individual. In a refinement, the system can create one or more evaluation assets to evaluate, verify, and/or validate the one or more arbitrage opportunities with the individual's animal data. In another refinement, one or more Artificial Intelligence techniques are utilized to create the one or more arbitrage opportunities with the animal data.

In another refinement, a stakeholder can create or modify one or more parameters related to the one or more arbitrage opportunities. For example, a stakeholder may want to ensure that the system operates while generating a minimum profit margin threshold for each acquisition and distribution of animal data. Therefore, the system may enable the stakeholder to create or modify (e.g., set) the one or more thresholds (e.g., which may be a monetary threshold or percentage) that would create or adjust (1) the one or more monetary values provided to the individual as consideration, (2) one or more terms related to the acquisition and/or distribution of the animal data, and the like. The one or more actions taken by the system may occur automatically based upon the one or more tunable parameters using one or more Artificial Intelligence techniques.

Additional information related to the use of animal data as a collateral asset or digital asset that can be utilized as consideration to acquire other consideration is provided in attached Exhibit A which is part of the Specification.

In a refinement, the system is operable to verify that the one or more collateral assets or digital assets have not been manipulated. For example, a copy of the collateral asset or digital asset can be included as part of the digital record associated either directly or indirectly with the individual, their animal data (e.g., the digital record may be for a type of digital coin or collateral asset which may be based, at least in part, on the animal data), or a combination thereof. The system may check (e.g., verify) that the collateral asset or digital asset matches, at least in part, the collateral asset or digital asset located as part of the digital record (e.g., including the one or more terms associated with the asset, the allowed uses, and the like). This will ensure that the collateral asset or digital asset have not been manipulated.

In another refinement, the system utilizes one or more hashes to validate the data (e.g., animal data) or its one or more derivatives. For example, the one or more digital records may include one or more hashes related to any given data (e.g., including associated metadata) and/or its one or more derivatives (e.g., collateral asset, digital asset). A hash is a mathematical function that converts an input of a tunable length into an encrypted output of a fixed length. The system can convert the data, its associated metadata, and/or its one or more derivatives into one or more hashes utilizing one or more hashing algorithms which can uniquely be associated with the data or its one or more derivatives and provide a form of data integrity and security related to the data or derivatives associated with it.

In another refinement, as new data enters the system, a targeted individual's total animal data set can increase or decrease in value. In this scenario, the targeted individual may have already committed at least a portion of their existing animal data to one or more collateral assets or digital assets (e.g., the targeted individual may transfer ownership to their digital asset permanently to another party for an entire data set, for specific use cases, for a specific period of time, for specific rights, and the like). As such, the system can be operable to assign and manage terms and conditions to each data value, each data type, groups of data, and the like in order to identify one or more combinations of animal data to create one or more collateral assets or digital assets. Characteristically, the system can be operable to place a monetary value on each of the derived collateral assets or digital assets—with each asset having one or more terms associated with it—in order for the targeted individual to get a better understanding of potential monetary value.

In many variations, the intermediary server is operating on behalf of the data acquirer. However, in some variations, the intermediary server is operating on behalf of the targeted individual. In other variations, the intermediary server is operating on behalf of both the data acquirer and targeted individual. In a refinement, the intermediary server or one or more computing devices in communication with the intermediary server are operable to create or modify the one or more collateral assets derived from the targeted individual's animal data. In another refinement, the intermediary server or one or more computing devices in communication with the intermediary server are operable to create or modify the one or more digital assets (e.g., coin, token) derived from the targeted individual's animal data.

In a refinement, the intermediary server communicates one or more instructions to another one or more computing devices (e.g., accessible by the data acquirer) to provide consideration to the intermediary server based upon the assigned monetary value in exchange for the collateral asset or digital asset, the intermediary server being operable to send the collateral asset or digital asset and receive the consideration (either directly or indirectly), and the one or more computing devices being operable to receive the collateral asset or digital asset (either directly or indirectly). In another refinement, the intermediary server communicates one or more instructions to another one or more computing devices (e.g., accessible by the targeted individual) to provide the animal data or its one or more derivatives to the intermediary server based upon the assigned monetary value in exchange for consideration, the intermediary server being operable to send the consideration (either directly or indirectly via instructions to another one or more computing devices) and receive the animal data or its one or more derivatives, and the one or more computing devices being operable to receive the consideration (either directly or indirectly).

In the variations where the intermediary server is operating on behalf of the targeted individual, the data acquirer is accepting the one or more terms related to the use of animal data as an asset in exchange for consideration. In this scenario, the intermediary server can be operable to provide the animal data to another one or more computing devices. The intermediary server can be operable to receive at least a portion of the consideration in exchange for the at least a portion of animal data (e.g., or its one or more derivatives). In a refinement, the system includes one or more other computing devices operable to receive at least a portion of the consideration, the one or more other computing further operable to communicate with the intermediary server (and vice versa).

In a refinement, at least a portion of the information related to the collateral or digital asset is provided by the intermediary server or computing device in communication with the intermediary server to a third-party computing device (e.g., a bank), the at least portion of information including the one or more assigned monetary values, wherein the third-party computing device uses the one or more assigned monetary values to provide consideration to the targeted individual (or assignee) in exchange for the collateral or digital asset. In another refinement, the consideration provided by the third-party computing device is an amount that is equal or less to the one more assigned monetary values. In another refinement, the consideration provided by the third-party computing device is an amount different from the one or more assigned monetary values. For example, the intermediary server may provide the verified collateral asset and its associated monetary value to a bank. The intermediary server may have associated a monetary value of x for the collateral asset (e.g., $20,000), but the bank decides to provide a cash loan or other consideration in the amount of y (e.g., $10,000).

In a refinement, the pricing engine creates or modifies and assigns one or more values for one or more animal data sets or its one or more derivatives, the one or more data animal data sets or its one or more derivatives including at least a portion of audio and/or video data (e.g., live or non-live video feeds or combinations thereof derived from one or more optical sensors such as video cameras that feature imagery for one or more individuals participating in one or more events such as sporting events or subsets of the one or more events). Characteristically, the one or more animal data sets or its one or more derivatives including the at least a portion of audio and/or video data may be data sets that have not yet been collected. For example, the system can be configured to assign a value to a future, not-yet-collected animal data set that includes one or more future, not-yet-collected audio and/or video feeds of a sporting event featuring the individual along with one or more other types of data and associated contextual data (e.g., timing & scoring data, physiological data, location-based data, biomechanical-based data, and the like). In a refinement, the system can be configured to assign one or more values to one or more subsets of the one or more animal data sets or its one or more derivatives. For example, the system can assign one or more values to one or more segments of video clips along with other animal data within a given data set (e.g., assign a value to the one or more video feeds and other animal data and statistical data collected for a subset of a competition such as each quarter of a basketball game). In another refinement, the system includes a pricing engine for animal data such as live or non-live video feeds (or combinations thereof) that feature imagery for one or more individuals (including groups of individuals) participating in one or more sporting events. The pricing engine can be configured to automate the creation or modification of one or more monetary or non-monetary values for such information.

In another refinement, the one or more animal data sets or its one or more derivatives are packaged as one or more digital assets, the one or more digital assets comprised of one or more digital trading cards. For example, in the context of sports, animal data-based trading cards may feature a collection of highlight videos featuring an individual or groups of individuals coupled with in-game statistical data and other animal data (e.g., physiological data, biomechanical data, location-based data) associated with the individual or groups of individuals. In this example, the data including audio/video may be synced so that the animal data included as part of the digital asset is also associated with the one or more video clips (e.g., the physiological data featured is synced and shares the same time stamps as the audio/video). In some variations, at least a portion of the animal data may be graphically overlayed on the video. This can also be applied to areas like healthcare, insurance, fitness, pharmaceutical research, medical research, and other industries where video data synced with other animal data (e.g., rehabilitation video clips synced with animal data; pharma study videos featuring patients and their physiological and visual reactions to a variety of drugs; amateur athletes combining their video and their other animal data for recruiting purposes) has value when sold or distributed as a packaged digital asset. In some variations, the system can anonymize the one or more individuals featured in the video (e.g., remove facial or voice features). In a refinement, the system can create a digital avatar of the individual featured in the video and mirror the actions of the individual in the video without revealing the entirety of the facial features or other unique characteristics of the individual. The system can alter the one or more characteristics of the individual via the digital asset (e.g., avatar) in order to protect their identity while enabling one or more digital assets to be created and distributed for consideration.

In a refinement, the system can be configured to enable one or more digital assets to be exchanged for another one or more other digital assets. In another refinement, a digital asset (e.g., digital trading card) can be modified, whereby the pricing engine creates or modifies and assigns one or more values based upon the one or more modifications to the modified digital asset. In another refinement, the system can be configured to enable one or more digital asset owners to create or modify one or more values for the one or more digital assets, or enable the data acquirer to create one or more values for the one or more digital assets for which the digital asset owner can accept or reject (or propose a new value or make modifications to the digital asset in order to exchange the digital asset for the price proposed by the acquirer, which can then be accepted or rejected by the acquirer or the system can enable further back-and-forth on both the acquirer and asset owner sides in terms of proposing new values or making modifications to the digital asset).

In another refinement, the digital asset can be modified to include new animal data. For example, a digital asset owner may want to include new data (e.g., additional video content, physiological data, other statistical data) into their digital asset (e.g., digital trading card), thereby increasing the price and value of the digital asset. In another refinement, the system can be configured to recommend one or more modifications to each of the digital assets to enable an agreeable exchange between the acquirer and provider (e.g., the system can provide terms or recommend one or more types of data to include as part of the digital asset in order to make a “fair” trade of digital assets based upon the system's evaluation and determination of the value of each digital asset, or to enable a “fair” trade of the digital asset for other consideration based upon the system's evaluation and determination of value).

In a refinement, at least a portion of the digital asset includes one or more rights to one or more physical assets (e.g., digital trading card with a physical asset such as a real trading card associated with). In another refinement, at least a portion of a physical asset includes one or more rights to one or more digital assets (e.g., physical trading card with a digital asset associated with it; a house with the owner's animal data also attached as collateral for a mortgage or loan).

In a refinement, the digital asset can be a digital identity card or trading card for an individual (e.g., everyday citizen, athlete, patient, and the like) that features their animal data (e.g., including associated metadata), other contextual data associated with the animal data (e.g., which can include video data), and one or more terms associated with the data (e.g., including one or more allowed uses and terms of use based upon the one or more granted rights) packaged into a digital asset that can be distributed for consideration. In a variation, the digital asset can include a summary of the information contained in the digital asset that can inform a receiving system of the contents of the digital asset. In a refinement, the information contained in the summary can be a tunable parameter (e.g., in some variations, the summary may include information that makes the digital asset unique or valuable; in other variations, the summary may include information that makes the digital asset sharable and informative, such as personal “bests” for an individual that may be promoted by an individual on social media or other mediums). In some variations, the digital identity or trading card can be a sports trading card featuring one or more athletes. The system can enable users to select (e.g., customize) the animal data featured in their one or more digital assets (e.g., trading card) featuring another one or more individuals (e.g., athletes). For example, the system can be configured to enable individuals to create their own sports trading card with their selected animal data that they acquire for consideration (e.g., which can occur via another one or more digital assets), allowing the user to select video clips, statistics, animal data, and other information that the user can combine to create their own customized trading card. The system can then create or modify and assign one or more values, or enable the user to create or modify and assign one or more values to the digital asset. In a refinement, the digital identity card can be anonymized or de-identified, at least in part, so that the digital asset contains the information of the individual but does not personally identify them (e.g., via name of facial imagery).

In a refinement, a user can create their own digital asset (e.g., digital trading card) that features one or more videos with animal data captured via a computing device (e.g., phone) that the individual can share or exchange for consideration (e.g., “likes” on a social media platform; sponsorship or advertisement revenue). In another refinement, the system can use one or more Artificial Intelligence techniques to create or modify audio and/or visual commentary for each of the one or more videos. In a refinement, the AI can create or modify commentary that mimics the voice and/or likeness of another one or more individuals (e.g., a famous commentator such as John Madden or Simon Cowell or other commentator) based upon the reference data. In another refinement, the system can be configured to enable a revenue share for each creation or modification of commentary for each of the one or more videos, which can include revenue being distributed to the commentator (or their estate) and one or more other rights holders or data creators based upon acquisition of the digital asset, sponsorship of—or advertisement related to—the digital asset, and the like.

In a refinement, at least a subset of the targeted individual's animal data is included in one or more digital avatars that are utilized as one or more digital assets to acquire consideration. In another refinement, the digital asset is a digital avatar that enables access to all or a subset of a targeted individual's animal data and its associated metadata (e.g., including contextual data), one or more of their characteristics, one or more terms associated with the acquisition of the digital asset, one or more values associated with the acquisition of the digital asset, or a combination thereof. In another refinement, an individual can create a single digital avatar or a plurality of digital avatars featuring at least a portion of the targeted individual's animal data (e.g., which includes its associated metadata), and one or more selected characteristics that mirror real-world characteristics of the targeted individual featured as part of the one or more avatars or which comprise the one or more avatars. In a variation, the one or more characteristics associated with the digital avatar are selected automatically by the system based upon one or more inputs of the data provider or data acquirer (e.g., the data acquirer may provide a desired use case, from which the system generates an avatar that features rights and access to all or a subset of a targeted individual's sensor-based animal data, one or more characteristics associated with the targeted individual that are required for the use case, one or more terms associated with the acquisition of the avatar, one or more values associated with the acquisition of the avatar, and the like) or a combination thereof. The one or more digital avatars can also have one or more terms associated with it based upon the one or more preferences established by the animal data owner (e.g., targeted individual) as well as one or more previously established rights based upon previously granted rights associated with the animal data. The system—via the pricing engine—can be configured to create or modify and assign one or more values (e.g., monetary values, non-monetary values), or evaluate one or more monetary values associated with the one or more avatars. In this variation, the system can be configured to compare the one or more values (e.g., pricing) of each asset being utilized as consideration to ensure that the exchange of consideration is equitable for all transacting parties. Characteristically, the system can be configured to modify—or recommend one or more modifications to—the digital asset (e.g., recommend what animal data to include or remove, what terms to change, and the like) to increase or decrease its value in order to enable an equitable exchange of consideration.

In another embodiment, a system for collecting, evaluating, and transforming animal data for use as a digital currency or collateral to acquire consideration is described. The system includes a source of animal data which includes information derived from at least one biological data sensor that gathers animal data from a targeted individual wherein the source of animal data is transmitted electronically. An intermediary server gathers at least a portion of the animal data from the source of animal data such that the animal data has metadata associated thereto. The metadata includes at least one characteristic of the at least one biological data sensor and at least one characteristic of the targeted individual from which the animal data originated. In a refinement, the metadata includes information providing context for the animal data (i.e., contextual data). In another refinement, the metadata includes information related to one or more outcomes associated with the gathered animal data and associated metadata. The intermediary server is further configured to gather reference data. In a refinement, the targeted individual's animal data includes at least a portion of the targeted individual's reference data (e.g., which includes their previously collected animal data and associated metadata). In another refinement, the targeted individual's animal data includes their historical animal data (e.g., which can be classified as reference data) and accessed via one or more digital records associated with the targeted individual (e.g., via the reference database). The intermediary server takes one or more actions with the at least a portion of the animal data and the associated metadata, the one or more actions including one or more evaluations, verifications, validations, or a combination thereof. The intermediary server further gathers one or more terms from the targeted individual or data acquirer (or both) related to the use of the animal data (either directly or indirectly) as an asset in exchange for consideration via one or more inputs provided by the targeted individual, the data acquirer, or both to one or more computing devices in communication with the intermediary server (e.g., either directly or indirectly) that operate one or more programs to gather such information, the one or more terms including at least one permission, right, preference, condition, or restriction. The intermediary server uses the reference data, information derived from the one or more evaluations, verifications, validations, or a combination thereof, and information related to or derived from the one or more terms to create or modify, and assign, one or more monetary values, or modify one or more assigned monetary values, for the at least a portion of animal data based upon the one or more evaluations, verifications, validations, or a combination thereof. The intermediary server further generates another one or more terms (e.g., legal language to enable an exchange of consideration within a legal framework; one or more lines of code to enable the exchange of consideration) related to the use of the at least a portion of animal data as a digital asset (e.g., digital currency asset, collateral asset) to enable the targeted individual to acquire consideration, the one or more terms including (1) information derived from or related to, either directly or indirectly, the one or more evaluations, verifications, validations, or a combination thereof, (2) the one or more assigned monetary values to the at least a portion of animal data, (3) the at least one permission, right, preference, condition, or restriction, (4) one or more terms (e.g., rights, restrictions, conditions, permissions) previously associated with (e.g., attached to) the animal data based upon information derived from one or more digital records associated with animal data or its one or more derivatives, or combinations thereof. Upon acceptance of the one or more terms electronically by the targeted individual, data acquirer, or both (e.g., depending on the use case and system set up), the intermediary server includes at least a portion of the one or more terms as part of the metadata associated with the animal data and transforms the at least a portion of the animal data and the associated metadata into a digital asset, the digital asset including the at least a portion of animal data (e.g., which can include the associated metadata) or its one or more derivatives (e.g., a summary of the animal data and metadata comprising the digital asset which represents the legal rights to the animal data based upon the one or more terms). In a refinement, the digital asset includes at least one of the one or more associated terms. In some variations, the intermediary serve may include at least a portion of the one or more terms as part of the metadata prior to acceptance of the one or more terms electronically by the targeted individual, data acquirer, or both. The intermediary server then provides access to the consideration based upon an assigned monetary value derived from the one or more assigned monetary values of the digital asset, at least in part, to another computing device (e.g., accessible by the targeted individual, their assignees, and the like) in exchange for the digital asset, and records the transaction as part of one or more digital records. In a refinement, the one or more terms are accepted electronically by the data acquirer prior to the intermediary server providing access to the consideration to another computing device in exchange for the digital asset. In another refinement, the digital asset (e.g., collateral asset, digital currency asset, other digital asset) can include both one or more terms which include one or more preferences established by the data owner, data acquirer, or both, and one or more terms generated by the intermediary server which can serve as a legal basis to secure the consideration (e.g., legal language such as boilerplate legal language related to the specific use). In another refinement, depending on the one or more configurations of the system, the sequential series in which the intermediary server or one or more other computing device(s) perform one or more actions in one or more embodiments can be a tunable parameter (i.e., the order of steps taken by the system can vary while still producing the same or similar output).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1.-75. (canceled)

76. A system for collecting, evaluating, and transforming animal data for use as a digital currency or collateral to acquire consideration comprising:
a source of animal data which includes information derived from at least one biological data sensor that gathers animal data from a targeted individual, the source of animal data being transmitted electronically;
an intermediary server that gathers at least a portion of the animal data from the source of animal data such that the animal data has metadata associated thereto, the metadata including at least one characteristic of the at least one biological data sensor and at least one characteristic of the targeted individual from which the animal data originated wherein:
the intermediary server is configured to take one or more actions with the at least a portion of the animal data and associated metadata, the one or more actions including (1) one or more evaluations, verifications, validations, or a combination thereof, and (2) a transformation of the at least a portion of the animal data and associated metadata, or its one or more derivatives, into a collateral asset;
the intermediary server is configured to gather reference data, the reference data being utilized by the intermediary server to create or modify and assign one or more monetary values, or modify one or more assigned monetary values, for the collateral asset based upon the one or more evaluations, verifications, validations, or a combination thereof;
the intermediary server is configured to generate one or more terms related to the use of the at least a portion of animal data as a collateral asset, at least in part, to enable the targeted individual to secure consideration, the one or more terms including information derived from, related to, or associated with, either directly or indirectly, the one or more evaluations, verifications, validations, or a combination thereof, and an assigned monetary value selected by the intermediary server for the collateral asset derived from the one or more assigned monetary values, at least in part, associated with the collateral asset;
upon acceptance of the one or more terms by the targeted individual electronically, the intermediary server is configured to provide consideration based upon the assigned monetary value for the collateral asset, at least in part, to another computing device in exchange for the collateral asset.
the intermediary server is in electronic communication with another one or more computing devices that provide a display and an application for the targeted individual to provide at least a portion of the animal data, one or more preferences, or a combination thereof;
at least one of the one or more preferences are included as part of the one or more terms generated by the intermediary server; and
the application is a program operable for the targeted individual or groups of targeted individuals to acquire one or more goods, services, currencies, other consideration in exchange for the collateral asset.

77. The system of claim 76 wherein at least a portion of the reference data is utilized by the intermediary server to take the one or more actions with the at least a portion of the animal data and associated metadata, the one or more actions including the one or more evaluations, verifications, validations, or a combination thereof.

78. The system of claim 76 wherein the collateral asset includes non-animal data.

79. The system of claim 76 wherein the one or more terms associated with distribution or acquisition of the collateral asset in exchange for consideration are included as part of the metadata associated with the animal data or its one or more derivatives.

80. The system of claim 76 wherein the intermediary server generates one or more agreements executable by the targeted individual and at least one stakeholder based upon one or more terms to enable the acceptance of the one or more terms, and wherein acceptance occurs electronically via one or more computing devices.

81. The system of claim 76 wherein the intermediary server takes one or more actions with the at least a portion of the collateral asset upon providing consideration to the targeted individual, the one or more actions including at least one of or any combination of: normalize, timestamp, aggregate, clean, analyze, tag, store, manipulate, denoise, process, enhance, organize, visualize, simulate, de-identify, pseudonymize, synthesize, summarize, replicate, productize, sell, store, assign, transfer, transform, provide, assign the one or more terms to, or synchronize the animal data, or a combination thereof and wherein at least a portion of the collateral asset is used by one or more computing devices to at least one of or any combination of: (1) create, modify, enhance, or evaluate one or more predictions, probabilities, or possibilities; (2) create, modify, enhance, or evaluate one or more wagers; (3) as a market upon which one or more wager are placed or accepted; (4) formulate one or more strategies; (5) create, modify, enhance, acquire, offer, recommend, or distribute one or more products or services; (6) mitigate, prevent, or take one or more risks; or (7) create, modify, enhance, or provide one or more targeted advertisements or promotions.

82. The system of claim 76 wherein the one or more actions taken by the intermediary server to transform the at least a portion of the animal data and associated metadata, or its one or more derivatives, into a collateral asset include at least one of or any combination of: normalize, timestamp, aggregate, clean, analyze, tag, store, manipulate, denoise, process, enhance, organize, visualize, simulate, de-identify, pseudonymize, synthesize, summarize, replicate, productize, sell, store, assign, transfer, provide, assign the one or more terms to, or synchronize the animal data, or a combination thereof and wherein at least a portion of the collateral asset is used by one or more computing devices for at least one of or any combination of: (1) create, modify, enhance, or evaluate one or more predictions, probabilities, or possibilities; (2) create, modify, enhance, or evaluate one or more wagers; (3) as a market upon which one or more wagers are placed or accepted; (4) formulate one or more strategies; (5) create, modify, enhance, acquire, offer, recommend, or distribute one or more products, services, or benefits; (6) mitigate, prevent, or take one or more risks; or (7) create, modify, enhance, or provide one or more targeted advertisements or promotions.

83. The system of claim 76 wherein the reference data gathered by the intermediary server is used, at least in part, to evaluate, verify, validate, or a combination thereof, the at least a portion of the animal data and associated metadata.

84. The system of claim 76 wherein the intermediary server removes at least a portion of identifiable information of the targeted individual from the collateral asset and wherein the collateral asset is provided to another one or more computing devices for consideration.

85. The system of claim 76 wherein the system operates utilizing distributed ledger technology or another ledger system.

86. The system of claim 76 wherein the one or more assigned monetary values are in the form of a currency which includes at least one of or any combination of: fiat currency, digital currency, asset-backed currency, virtual currency, cryptocurrency, or central bank digital currency.

87. The system of claim 76 wherein the one or more assigned monetary values are in the form of one or more products, services, benefits, currencies, assets, or a combination thereof.

88. The system of claim 76 wherein the intermediary server is in direct electronic communication with the source of animal data.

89. The system of claim 76 wherein as new animal data or information is gathered, the one or more assigned monetary values are modified.

90. The system of claim 76 wherein the targeted individual provides one or more preferences, the one or more preferences being utilized by the intermediary server, at least in part, to generate the one or more terms and wherein the one or more preferences include at least one of or any combination of: length of loan, target loan amount, repayment schedule, interest collateral, uses of the animal data, privacy preferences, interested services, interested products, interested benefits, habits, default provisions remedies, substitution of property, or method of loan repayment.

91. The system of claim 76 wherein the intermediary server provides consideration based upon animal data not yet received by the intermediary server.

92. The system of claim 76 wherein the collateral asset is a digital asset used as a form of digital currency to acquire consideration.

93. The system of claim 76 wherein the system is configured to operate as a pricing engine which creates or modifies and assigns the one or more monetary values, or modifies the one or more assigned monetary values, for the collateral asset; the intermediary server is configured to utilize the reference data to create or modify and assign one or more pricing models via the pricing engine, or modify one or more assigned pricing models via the pricing engine, for the collateral asset based upon the one or more evaluations, verifications, validations, or a combination thereof; the one or more pricing models are configured to recommend one or more static prices, variable prices, or dynamic prices for the collateral asset; and the one or more static prices, variable prices, or dynamic prices change as new data or information is gathered or derived by the system.

94. The system of claim 76 wherein the intermediary server is configured to authenticate the collateral asset and attaches one or more digital marks to the collateral asset in order to notify one or more third-party computing devices of authenticity of the collateral asset and its contents.

95. A method for collecting, evaluating, and transforming animal data for use as a digital currency or collateral for consideration comprising:
transmitting electronically information from a source of animal data and a source of reference data to an intermediary server, the source of animal data including at least one biological data sensor that gathers animal data from a targeted individual;
gathering, via an intermediary server in electronic communication with the source of animal data, at least a portion of the animal data such that the animal data has metadata associated thereto, the metadata including at least one characteristic of the at least one biological data sensor and at least one characteristic of the targeted individual from which the animal data originated;
taking, via the intermediary server, one or more actions with the at least a portion of the animal data and associated metadata, the one or more actions including one or more evaluations, verifications, validations, or a combination thereof, as well as one or more steps that transform the at least a portion of the animal data and associated metadata, or its one or more derivatives, into a collateral asset;
communicating, via the intermediary server, with the source of reference data to gather at least a portion of reference data either directly or indirectly related to gathered animal data and associated metadata;
creating or modifying, via the intermediary server, one or more monetary values for the at least a portion of animal data based upon the one or more evaluations, verifications, validations, or a combination thereof, utilizing at least a portion of the reference data;
assigning, via the intermediary server, a monetary value from the one or more created or modified monetary values to the at least a portion of animal data;
generating, via the intermediary server, one or more terms for using the at least a portion of animal data as collateral, at least in part, to enable the targeted individual to secure consideration, the one or more terms including information derived from or related to, either directly or indirectly, the one or more evaluations, verifications, validations, or a combination thereof, and the assigned monetary value to the at least a portion of animal data; and
providing, via the intermediary server, consideration based upon the assigned monetary value, at least in part, to another computing device upon acceptance of the one or more terms electronically by the targeted individual in exchange for the collateral asset, the collateral asset including the at least a portion of animal data.

96. A system for collecting, evaluating, and transforming animal data use as a digital currency or collateral to acquire consideration comprising:
a source of animal data which includes information derived from at least one biological data sensor that gathers animal data from a targeted individual, the source of animal data being transmitted electronically;
an intermediary server that gathers at least a portion of the animal data from the source of animal data such that the animal data has metadata associated thereto, the metadata including at least one characteristic of the at least one biological data sensor and at least one characteristic of the targeted individual from which the animal data originated wherein:
the intermediary server is configured to gather reference data;
the intermediary server takes one or more actions with the at least a portion of the animal data and associated metadata, the one or more actions including one or more evaluations, verifications, validations, or a combination thereof;
the intermediary server uses the reference data and information derived from the one or more evaluations, verifications, validations, or a combination thereof, to create or modify, and assign, one or more monetary values, or modify one or more assigned monetary values, for the at least a portion of animal data based upon the one or more evaluations, verifications, validations, or a combination thereof;
the intermediary server generates one or more terms related to use of the at least a portion of animal data as a form of digital currency or collateral, at least in part, to enable the targeted individual to acquire consideration, the one or more terms including information derived from or related to, either directly or indirectly, the one or more evaluations, verifications, validations, or a combination thereof, the one or more assigned monetary values to the at least a portion of animal data, one or more preferences related to use of the animal data created either directly or indirectly from the targeted individual or a data acquirer, one or more terms previously associated with at least a portion of the animal data, or combinations thereof;
upon acceptance of the one or more terms electronically by the targeted individual, the intermediary server includes the one or more terms as part of the metadata associated with the animal data and transforms the at least a portion of the animal data and the associated metadata, or its one or more derivatives, into a digital asset; and
the intermediary server provides access to the consideration based upon an assigned monetary value derived from the one or more assigned monetary values, at least in part, of the digital asset, at least in part, to another computing device (e.g., accessible by the targeted individual or their assignees) in exchange for the digital asset.
